(19) United States
(12) Patent Application Publication
(10) Pub. No.: US 2020/0197894 A1
(43) Pub. Date: Jun. 25, 2020

(54) POLY(ACID) MICROCAPSULES AND RELATED METHODS

(71) Applicant: President and Fellow of Harvard College, Cambridge, MA (US)

(72) Inventors: David A. Weitz, Cambridge, MA (US); Joerg G. Werner, Cambridge, MA (US); Sara Nawar, Cambridge, MA (US); Brendon Deverney, Cambridge, MA (US)

(73) Assignee: President and Fellow of Harvard College, Cambridge, MA (US)

(21) Appl. No.: 16/640,598

(22) PCT Filed: Aug. 20, 2018
(86) PCT No.: PCT/US2018/047053

§ 371 Date: Feb. 20, 2020

Related U.S. Application Data
(60) Provisional application No. 62/547,904, filed on Aug. 21, 2017.

(51) Int. Cl. B01J 13/18; B01F 3/08; B01F 13/00

(52) U.S. Cl. CPC B01J 13/185; B01F 2005/0034; B01F 13/0062; B01F 3/0807

(57) ABSTRACT

Microcapsules and techniques for the formation of microcapsules are generally described. In some embodiments, the microcapsules are formed in an emulsion (e.g., a multiple emulsion). In some embodiments, the microcapsule may be suspended in a carrying fluid containing the microcapsule that, in turn, contain the smaller droplets. In some embodiments, the microcapsules comprise a shell and a droplet at least partially contained within the shell (e.g., encapsulated within the shell), and may be suspended in a carrier fluid. In certain embodiments, the shell is a hydrogel comprising a poly(acid). In some cases, the poly(acid) is a polyanion. In some cases, the shell does not comprise a poly(base) or polycation (e.g., a polycationic poly electrolyte). In some embodiments, the microcapsules comprise a shell comprising a poly(acid) and a poly(anhydride).

### RELATED APPLICATIONS

This application claims the benefit of U.S. Provisional Patent Application Ser. No. 62/547,904, filed Aug. 21, 2017, by Weitz, et al., incorporated herein by reference in its entirety.

### TECHNICAL FIELD

Poly(acid) microcapsules and related methods (e.g., formation of poly(acid) microcapsules) are generally described.

### BACKGROUND

An emulsion is a fluidic state which exists when a first fluid is dispersed in a second fluid that is typically immiscible or substantially immiscible with the first fluid. Examples of common emulsions are oil in water and water in oil emulsions. Multiple emulsions are emulsions that are formed with more than two fluids, or two or more fluids arranged in a more complex manner than a typical two-fluid emulsion. For example, a multiple emulsion may be oil-in-water-in-oil, or water-in-oil-in-water. Multiple emulsions are of particular interest because of current and potential applications in fields such as pharmaceutical delivery, paints and coatings, food and beverage, and health and beauty aids.

### SUMMARY

Systems, articles, and methods related to poly(acid) microcapsules are provided. The subject matter of the present invention involves, in some cases, interrelated products, alternative solutions to a particular problem, and/or a plurality of different uses of one or more systems and/or articles.

In one aspect, methods of forming and/or using microcapsules are provided. In some embodiments, the method comprises expelling a first fluid from an exit opening of a first conduit into a second fluid in a second conduit, the first fluid comprising an aqueous solution and the second fluid comprising a monomer comprising an anhydride, expelling the first fluid and the second fluid from an exit opening of the second conduit into a third fluid to form the microcapsule comprising a shell of the second fluid surrounding droplets of the first fluid, and polymerizing the monomer.

In another set of embodiments, the method comprises increasing pH of a microcapsule encapsulating an agent to increase release at least some of the agent from the microcapsule, and decreasing the pH of the microcapsule to decrease release of the agent from the microcapsule. In some embodiments, the microcapsule comprises a shell comprising a poly(acid) and a poly(anhydride).

In yet another set of embodiments, the method comprises forming a microfluidic droplet comprising a first fluid contained within a carrying fluid, the first fluid comprising an anhydride, polymerizing some of the anhydride within the microfluidic droplet to form a poly(anhydride) to cause the droplet to form a microcapsule, cross-linking the poly(anhydride) within the microcapsule, and hydrolyzing some of the anhydride within the microcapsule to form carboxylic acid.

The method, in still another set of embodiments, includes increasing pH of a microcapsule encapsulating an agent to increase permeability of the agent, and decreasing the pH of the microcapsule to decrease the permeability of the agent. In some cases, the microcapsule comprises a shell comprising a poly(acid) and a poly(anhydride).

In another aspect, articles are provided. In some embodiments, the article comprises a microcapsule having a shell comprising a poly(acid), the shell at least partially encapsulating an aqueous solution, wherein the shell does not comprise a polybase and/or a polycation.

In yet another set of embodiments, the microcapsule comprises a shell comprising a poly(acid). In still another set of embodiments, the microcapsule comprises a shell comprising a poly(acid), where the shell does not comprise a polybase.

In another set of embodiments, the article comprises a microcapsule comprising a shell comprising a poly(acid) and a poly(anhydride). In some instances, the microcapsule encapsulates an agent.

The article, in yet another set of embodiments, comprises a microcapsule comprising a shell comprising a poly(acid) and encapsulating an agent. In some cases, the microcapsule exhibits a first permeability to the agent at a first pH and a second permeability to the agent at a second pH.

According to still another set of embodiments, the article comprises a microcapsule comprising a shell comprising a poly(acid) and encapsulating an agent. In some embodiments, the microcapsule exhibits a first permeability to the agent at a first temperature and a second permeability to the agent at a second temperature.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures. For purposes of clarity, not every component is labeled in every figure, nor is every component of each embodiment of the invention shown where illustration is not necessary to allow those of ordinary skill in the art to understand the invention. In the figures:

FIG. 1 shows an exemplary cross-sectional schematic diagram of a system that can be used to form multiple emulsions, according to some embodiments;

FIG. 2 shows an exemplary cross-sectional schematic diagram of a system that can be used to form multiple emulsions, according to some embodiments;

FIGS. 3A-3B show a schematic representation of glass capillary devices for the formation of double emulsion drops in thick-shell (FIG. 3A) and thin-shell mode (FIG. 3B), according to some embodiments;

FIG. 4 shows a schematic representation of an exemplary conversion of water-in-oil-in-water double emulsion drops with monomeric oil shell to poly(anhydride) microcapsules, subsequent hydrolysis to cross-linked poly(acid) microcapsules and reversibly responsive swelling, according to some embodiments;

FIGS. 5A-5C show, according to some embodiments, light microscopy images of thiol-ene double emulsion drop formation with thick shells (FIG. 5A) and thin shells (FIG. 5B) in glass capillary devices, and resulting cross-linked poly(pentenoic anhydride) microcapsules (FIG. 5C) after UV-initiated polymerization labeled with their respective entry number from Table 1. All scale bars are 200 micrometers;

FIGS. 6A-6C show, according to some embodiments, light microscopy images of methacrylic double emulsion drop formation with thick shells (FIG. 6A) and resulting cross-linked poly(methacrylic anhydride-co-ethylene glycol dimethacrylate) (P(MAAn-EGDMA)) microcapsules with MAAn-to-EGDMA ratios of 24.5 (FIG. 6B) and 4.5 (FIG. 6C) after UV-initiated polymerization. All scale bars are 200 micrometers;

FIGS. 7A-7F show, according to some embodiments, (FIGS. 7A-7C) fluorescent confocal laser microscopy images of thin-shelled thiol-ene poly(anhydride) microcapsules at different time points of the shell hydrolysis at pH=7 for different anhydride-to-cross-linker ratios (FIG. 7A), of thin-shelled thiol-ene poly(anhydride) microcapsules at different pH values for the same shell composition (FIG. 7B), and of thick-shelled thiol-ene poly(anhydride) microcapsules at pH=11 (FIG. 7C) with the same composition as in (FIG. 7B). The capsules were challenged with the fluorescent probe sulforhodamine B from the inside (FIGS. 7A-7B) or outside (FIG. 7C). The furthest right images are bright field microscopy image of the hydrolyzed poly(acid) microcapsules. (FIG. 7D) ATR-FT-IR spectra of selected thick-shelled thiol-ene poly(anhydride) microcapsules before (as-made) and after hydrolysis in PBS buffer. (FIGS. 7E-7F) Scanning electron micrographs of hydrolyzed poly(acid) microcapsules obtained from the hydrolysis of thin-shelled (FIG. 7E) and thick-shelled (FIG. 7F) thiol-ene poly(anhydride) microcapsules with 33.3 mol % anhydride monomer. Insets show cut cross-sections of the hydrogel shells. All scale bars are 200 micrometers;

FIGS. 8A-8C show, according to some embodiments, (FIGS. 8A-8B) fluorescent confocal laser microscopy images at different time points during hydrolysis of poly(methacrylic anhydride-co-ethylene glycol dimethacrylate) (P(MAAn-EGDMA)) microcapsules with MAAn-to-EGDMA ratios of 24.5 (FIG. 8A) and 4.5 (FIG. 8B) in various pH environments. The capsules were challenged with the fluorescent probe sulforhodamine B. The furthest right images are bright field microscopy image of the hydrolyzed poly(methacrylic acid-co-ethylene glycol dimethacrylate) microcapsules (FIG. 8C) ATR-FT-IR spectra of P(MAAn-EGDMA) microcapsules with MAAn-to-EGDMA ratios of 24.5 microcapsules before (as-made) and after hydrolysis in various pH environments. All images are the same magnifications and scale bars are 200 micrometers;

FIGS. 9A-9D show, according to some embodiments, (FIG. 9A) diameters of thiol-ene poly(anhydride) microcapsules before (as-made) and after hydrolysis exposed to various pH conditions indicated at the bottom of each bar. Entry numbers correspond to respective entries in Table 1. The values and the error bars represent the geometric average and the standard deviation of at least 3 capsules, respectively. (FIGS. 9B-9D) Fluorescent confocal laser micrographs of thiol-ene poly(acid) microcapsules with (FIG. 9B) medium cross-link density (entry B-3 in Table 1), (FIGS. 9C-9D) low cross-link density (FIG. 9C: entry C-2; FIG. 9D: entry C-3 in Table 1) challenged with fluorescently labeled dextran with indicated molecular weights in indicated pH environments. All scale bars are 200 micrometers;

FIGS. 10A-10B show, according to some embodiments, (FIG. 10A) diameters of poly(methacrylic anhydride-co-ethylene glycol dimethacrylate) (P(MAAn-EGDMA)) microcapsules with MAAn-to-EGDMA ratios of 24.5 (entry D) and 4.5 (entry E) before (as-made) and after hydrolysis exposed to various pH conditions indicated at the bottom of each bar. Entry numbers correspond to respective entries in Table 2. The values and the error bars represent the geometric average and the standard deviation of at least 18 capsules, respectively. (FIG. 10B) Fluorescent confocal laser micrographs of (P(MAAn-EGDMA)) microcapsules with MAAn-to-EGDMA ratios of 24.5 (entry D in Table 2) challenged with fluorescently labeled dextran molecules with the indicated molecular weight at the indicated pH (same pH in same column). All scale bars are 200 micrometers;

FIGS. 11A-11D show, according to some embodiments, (FIG. 11A) a schematic representation of triggered, reversible permeability change enabling dynamic on-off or self-adjusting release (top) and capturing, trapping, and release of cargo (bottom). (FIG. 11B) Dynamic pH-triggered on-off release of trimethylrhodamine labeled dextran (4.4 kDa) from thin-shelled thiol-ene poly(pentenoic acid) capsules with medium cross-link density (entry B-2 in Table 1). Bright-field (top) and fluorescent confocal laser micrographs (bottom) of a capsule prior to the release experiment. Peak absorption of tetramethylrhodamine at 515 nm during release under alkaline conditions (NaOH). The pH of the solution was switched between 3 and 9 every 20 mins using hydrochloric acid (HCl) and sodium hydroxide (NaOH) solutions, respectively, as indicated. (FIG. 11C) pH-triggered capture-trap-release cycle of a trimethylrhodamine labeled dextran (4.4 kDa) in thin-shelled thiol-ene poly(pentenoic acid) capsules with medium cross-link density (entry B-1 in Table 1). The conditions and subsequent changes are indicated in and between the images, respectively. The images were taken at the indicated time after the respective change has been made. (FIG. 11D) Calcium-triggered capture-trap-release cycle of a trimethylrhodamine labeled dextran (4.4 kDa) in thick-shelled thiol-ene poly(pentenoic acid) capsules with medium cross-link density (entry B-3 in Table 1). The conditions and subsequent changes are indicated in and between the images, respectively. The images were taken at the indicated time after the respective change has been made. The bar graph shows the size of the capsules at the respective stages. The values and the error bars represent the geometric average and the standard deviation of at least 9 capsules, respectively. All scale bars are 200 micrometers;

FIGS. 12A-12B show, according to some embodiments, (FIG. 12A) bright-field microscopy images of hydrolyzed thiol-ene poly(pentenoic acid) hydrogel microcapsules (B-2 in Table 1) after drying in vacuum (1st left), redispersion in DI-water (2nd left), and swelling in pH=11 buffer (3rd left). Fluorescent confocal laser micrographs of the redispersed thiol-ene hydrogel microcapsules at pH=11 challenged with FITC-labeled dextran (3-5 kDa) after 7 mins (4th left) and 15 hours (5th left) of dye-conjugate addition. (FIG. 12B) Bright-field and fluorescent confocal laser micrographs of unhydrolyzed thiol-ene poly(pentenoic anhydride) microcapsules (B-2 in Table 1) after redispersion in water, hydrolysis at pH=9.5, after washing and sonication, loading with TRITC-dextran-4.4 kDa at elevated pH, and trapping of the dye inside the hydrogel capsules at low pH. Times indicated under arrows represent the time passed under indicated conditions before next shown image was acquired. The first, third and last image in (FIG. 12B) are bright field images of the adjacent fluorescent confocal laser microscopy images. All scale bars are 200 micrometers; and

FIGS. 13A-13B show, according to some embodiments, (FIG. 13A) bright-field (top row) and fluorescent confocal laser microscopy images (bottom row) of double-cored thiol-ene poly(pentenoic anhydride) microcapsules before (left) and after hydrolysis at indicated conditions and times. The double-cored capsules were obtained as a side product of the capsule fabrication labeled C-3 in Table 1. All capsules were challenged with sulforhodamine B to indicate hydrolysis of the shell. All scale bars are 50 micrometers. (FIG. 13B) Bright-field (1st and 3rd) and fluorescent confocal laser microscopy (2nd and 4th) images of thiol-ene poly(pentenoic anhydride) microfibers with aqueous cores before (left) and after (right) hydrolysis at pH=11. The fibers were challenged with sulforhodamine B to indicate hydrolysis of the shell. All scale bars are 200 micrometers.

FIG. 14 shows the conversion of water-in-oil-in-water double emulsion drop with monomer shell to poly(anhydride) microcapsules, and subsequent hydrolysis to cross-linked poly(acid) microcapsules.

FIGS. 15A-15B show osmotic shock experiments to characterize the shell's permeability to small molecular solutes (FIG. 15A, top row) and brightfield microscopy images of P(MAA-EGDMA) microcapsules with 90 mol % acid content before (left) and after (middle, right) being challenged with sucrose (FIG. 15A) or γ-cyclodextrin (γ-CD) (FIG. 15B) solution at indicated pH. All scale bars are 200 micrometers.

FIGS. 16A-16B show time resolved size distribution (projected area) of the cyclic swelling (pH=7) and deswelling (pH=4) of P(MAA-EGDMA) hydrogel microcapsules with 98 mol % acid content. Droplines represent time of pH change.

FIG. 17 shows fluorescent confocal laser microscopy images during hydrolysis of poly(methacrylic anhydride-co-ethylene glycol dimethacrylate) microcapsules with 81.8 mol % methacrylic anhydride in various pH environments. The capsules were challenged with the fluorescent probe sulforhodamine B. Bright field microscopy image of the hydrolyzed poly(methacrylic acid-co-ethylene glycol dimethacrylate) microcapsules as the last image of each row. Image width is 1551.5 micrometers. The fluorescent confocal micrograph in the bottom right is of alkaline-hydrolyzed microcapsules after transfer to pH 4 buffer and subsequent addition of sulforhodamine B, demonstrating the permeability of the hydrolyzed microcapsules to the fluorescent probe in acidic conditions.

FIGS. 18A-18B show optical micrographs of poly(methacrylic acid-co-ethylene glycol methacrylate) (P(MAA-EGDMA)) microcapsules with 2 mol % (FIG. 18A) and 10 mol % EGDMA cross-linker (FIG. 18B) under indicated conditions and time. Scale bars are 100 nm.

FIG. 19 shows platinum nanoparticles (Pt-NP) encapsulated in P(MAA-EGDMA) microcapsules with 98 mol % acid content upon exposure to aqueous hydrogen peroxide (H₂O₂) solution.

FIG. 20A shows fluorescence confocal (column 1-3) and optical (column 4) micrographs of poly(anhydride) microcapsules during hydrolysis in PBS buffer at pH=7.4 for different anhydride content (entries A-1, B-1, C-1 in Table 4). Scale bars are 200 micrometers. FIG. 20B shows ATR-FTIR spectra of poly(anhydride) microcapsules before (anhydride) and after hydrolysis in PBS buffer. FIGS. 20C-20E show scanning electron micrographs of thin-shelled (FIG. 20C) and thick-shelled poly(acid) (FIGS. 20D-20E) microcapsules. Insets show cross-sections of the shells. Labels correspond to entries in Table 4.

FIG. 21 shows size distribution of microcapsules with high (A-1), medium (B-3), and low (C-3) cross-link density before (as-made) and after hydrolysis at indicated pH values. Values and error bars represent geometric average and standard deviation, respectively, of three to 30 microcapsules.

FIG. 22 shows an illustration of dynamic on-off release (top) and time-resolved peak absorption (bottom) of the supernatant over microcapsules (B-2) loaded with FITC-labeled dextran (10 kDa) during pH-triggered on-off release, demonstrating the repeated change of permeability of the microcapsules upon switching between acidic and alkaline conditions. The inset (top right) shows an overlay of the bright field and fluorescence confocal micrograph of a loaded microcapsule before dynamic release.

### DETAILED DESCRIPTION

Microcapsules and techniques for the formation of microcapsules are generally described. In some embodiments, the microcapsules are formed in an emulsion (e.g., a multiple emulsion). In some embodiments, the microcapsule may be suspended in a carrying fluid containing the microcapsule that, in turn, contain the smaller droplets. In some embodiments, the microcapsules comprise a shell and a droplet at least partially contained within the shell (e.g., encapsulated within the shell), and may be suspended in a carrier fluid. In certain embodiments, the shell is a hydrogel comprising a poly(acid). In some cases, the poly(acid) is a polyanion. In some cases, the shell does not comprise a poly(base) or polycation (e.g., a polycationic polyelectrolyte). In some embodiments, the microcapsules comprise a shell comprising a poly(acid) and a poly(anhydride).

A multiple emulsion, as used herein, describes one or more larger microcapsules in a carrier fluid that contain one or more smaller droplets therein. For instance, the microcapsule may be suspended in a carrying fluid containing the microcapsule that, in turn, contain the smaller droplets. As described below, multiple emulsions can be formed in one step in certain embodiments, with generally precise repeatability, and can be tailored in some embodiments to include a relatively thin layer of fluid separating two other fluids.

In some embodiments, the microcapsules comprise a shell and a droplet at least partially contained within the shell (e.g., encapsulated within the shell), and may be suspended in a carrier fluid. In certain embodiments, the shell is a hydrogel comprising a poly(acid). In some cases, the poly(acid) is a polyanion. In some cases, the shell does not comprise a poly(base) or polycation (e.g., a polycationic polyelectrolyte). The term “poly(acid)” as used herein refers to a polymer having one or more acid groups (e.g., hydroxyl, carboxyl, amine) present on the backbone of the polymer (e.g., an acid group on a side chain and/or a pendant side group of the polymer backbone). The term “acid group” is given its ordinary meaning in the art and generally refers to a compound that forms hydrogen ions when dissolved in water and/or whose aqueous solutions react with bases and/or certain metals to form salts. In some cases, the poly(acid) is a polyanionic polyelectrolyte. The term “poly(base)” as used herein refers to a polymer having one or more base groups (e.g., ammonium) present on the backbone of the polymer.

Advantageously, in certain embodiments, microcapsules comprising a shell comprising a poly(acid) (e.g., and not comprising a poly(base) or polycation) may be formed using one or two steps (e.g., flowing two or more fluids in a microfluidic device such that the microcapsules are formed and, optionally, exposing the microcapsules to electromagnetic radiation such as ultraviolet light) as compared to traditional methods for forming such microcapsules including the use of sacrificial template materials and/or polyelectrolyte multilayers (e.g., layers alternating polymers comprising polyanions and polycations). In certain embodiments, the microcapsules described herein are formed in substantially aqueous environments. In some cases, the droplet at least partially contained within the shell (e.g., encapsulated within the shell) may comprise an aqueous solution.

In some cases, the microcapsules described herein may be advantageously loaded with (e.g., may encapsulate) relatively large particles (e.g., having an average cross-sectional diameter greater than or equal to 15 nm), or other suitable cargo or agents. For example, microcapsules having a poly(acid) shell made by traditional methods such as sacrificial templating and/or polyelectrolyte multilayered microcapsules may generally be formed in such a manner that such relatively large particles may not be encapsulated and, in particular, using only one or two steps. For example, in some embodiments, the microcapsules described herein comprising a poly(acid) shell and a droplet contained within the shell, may be fabricated such that the microcapsule comprises (e.g., in the droplet) a relatively large particle having an average cross-sectional diameter of greater than or equal to 15 nm, greater than or equal to 20 nm, greater than or equal to 25 nm, greater than or equal to 30 nm, greater than or equal to 40 nm, greater than or equal to 50 nm, greater than or equal to 75 nm, greater than or equal to 100 nm, greater than or equal to 200 nm, or greater than or equal to 400 nm. In some cases, the relatively large particle may have an average cross-sectional diameter of less than or equal to 500 nm, less than or equal to 400 nm, less than or equal to 200 nm, less than or equal to 100 nm, less than or equal to 75 nm, less than or equal to 50 nm, less than or equal to 40 nm, less than or equal to 30 nm, less than or equal to 25 nm, or less than or equal to 20 nm. Combinations of the above-referenced ranges are also possible (e.g., greater than or equal to 15 nm and less than or equal to 500 nm). Other ranges are also possible.

Non-limiting examples of suitable particles that may be encapsulated within the droplet of the microcapsule include cells, proteins, polymers (e.g., globular polymers), micelles, or the like. Other agents or cargo may also be encapsulated within the microcapsule, e.g., as discussed herein.

In some embodiments, the microcapsules described herein may be suitable for aqueous applications. In some cases, the microcapsules may be loaded with a cargo (e.g., molecules, particles) or other agent having a relatively low average cross-sectional diameter (e.g., less than 15 nm), e.g., the microcapsules may encapsulate such cargo or agents. Advantageously, the microcapsules described herein may reversibly and/or controllably release (or uptake) the cargo (or another suitable agent, such as is described herein) in the presence of a particular set of conditions (e.g., pH, ionic strength and/or composition). For example, in some cases, a plurality of particles or molecules (e.g., having an average cross-sectional diameter of less than 15 nm) may be released from the microcapsule by exposing the microcapsule to alkaline conditions (e.g., in the presence of NaOH). For instance, in some embodiments, the microcapsule may have a permeability allowing release and/or uptake of agents or cargo such as those described herein, e.g., particles or agents having an average cross-sectional diameter of less than 15 nm, or the like.

In certain embodiments, the plurality of particles or molecules may be captured/encapsulated by the microcapsule by exposing the microcapsule to acidic conditions (e.g., in the presence of HCl). In some cases, the cargo or other agent may diffuse through the shell of the microcapsule. That is to say, in some embodiments, the microcapsule may be configured to exhibit reversible permeability under the presence of a particular set of conditions.

In some embodiments, the cargo or agent may have a particular average cross-sectional diameter. In certain embodiments, the average cross-sectional diameter of the cargo or agent may be less than 15 nm, less than or equal to 10 nm, less than or equal to 5 nm, less than or equal to 3 nm, less than or equal to 2 nm, or less than or equal to 1 nm. In some embodiments, the average cross-sectional diameter of the cargo or agent may be greater than or equal to 0.1 nm, greater than or equal to 1 nm, greater than or equal to 2 nm, greater than or equal to 3 nm, greater than or equal to 5 nm, or greater than or equal to 10 nm. Combinations of the above-referenced ranges are also possible (e.g., less than 15 nm and greater than or equal to 0.1 nm). Other ranges are also possible. In addition, it should be understood that the cargo or agent may be a molecule. Non-limiting examples of suitable agents are discussed in more detail herein.

In certain embodiments, the poly(acid) shell is formed by the hydrolysis of a poly(anhydride) shell. For example, in some embodiments, the microcapsules are formed using a monomer comprising e.g., a poly(anhydride), polymerizing the monomer (e.g., using a suitable photoinitiator and ultraviolet light), and/or cross-linking the poly(anhydride) such that the shell comprises a cross-linked poly(anhydride), e.g., forming a poly(anhydride) network. Non-limiting examples of anhydrides include 4-pentenoic anhydride (PA), pentenoic anhydride, methacrylic anhydride, or the like. Other examples of anhydrides (and/or other monomers) are discussed in detail herein. In some cases, cross-linking may be controlled, e.g., upon exposure to a suitable cross-linking agent. Non-limiting examples include methacrylate, ethylene glycol dimethacrylate, triethylenglycol divinylether, or the like. In some cases, such cross-linking may occur through mechanisms such as free-radical polymerization.

In some embodiments, the cross-linked poly(anhydride) shell may be hydrolyzed such that the poly(anhydride) converts to a poly(acid), e.g., at least some of the anhydride may be hydrolyzed to form a carboxylic acid. Hydrolysis of the anhydride may decrease the amount of cross-linking, and increase the porosity or permeability of the shell, which may facilitate release of an agent.

In some cases, the amount of hydrolysis may be controlled by controlling the pH and/or the temperature of the anhydride. For example, the pH may be increased to a pH that is greater than the pKa of the corresponding acid to increase hydrolysis of the anhydride. In some cases, the pH may be raised to at least 5, at least 7, at least 9, at least 11, or at least 13. In certain embodiments, the pH may be raised by at least 2 pH units, at least 3 pH units, at least 5 pH units, or at least 7 pH units.

In addition, this reaction may be reversible in some cases. For example, in some embodiments, the poly(acid) may be induced to form a poly(anhydride) by lowering the pH to a pH that is less than the pH of the pKa of the acid. In some cases, the pH may be lowered to less than 9, less than 7, less than 5, or less than 3. In certain embodiments, the pH may be lowered by at least 2 pH units, at least 3 pH units, at least 5 pH units, or at least 7 pH units.

As another example, the temperature may be raised to increase hydrolysis and/or lowered to decrease hydrolysis, e.g., in addition to and/or instead of altering the pH. For example, the temperature may be increased to at least 20° C., at least 25° C., at least 30° C., at least 35° C., at least 40° C., at least 45° C., at least 50° C., at least 60° C., at least 70° C., at least 80° C., at least 90° C., etc.

In one set of embodiments, altering the hydrolysis of the shell may be useful for facilitating transport of cargo or agent into and/or out of the microcapsule. For example, in one set of embodiments, control of the amount of polymeric content of the shell may be used to control the permeability of the shell to an agent, or to the surrounding medium, and/or the ability of the shell to swell or contract when exposed to different pHs.

For example, in some embodiments, increasing the permeability of the shell may allow water (or another solvent) to enter the shell and/or the interior, thereby causing the microcapsule to swell. Conversely, decreasing the permeability of the shell may cause the microcapsule to shrink.

In another set of embodiments, the shell may swell in an environment that is more basic, e.g., with pHs higher than the poly(acid)'s pKa value, and/or shrink under acidic conditions, e.g., with pHs higher than the poly(acid)'s pKa value. Without wishing to be bound by any theory, it is believed that deprotonation of the poly(acids) at relatively higher pHs may lead to charged polymers and thus swelling, while protonation at relatively low pHs leading to less changed polymers and a corresponding decrease in water content in the polymer network, thus leading to shrinkage.

In yet another set of embodiments, the shell may swell in response to an increase in temperature, and shrink in response to a decrease in temperature. Without wishing to be bound by any theory, it is believed that an increase in temperature may increase the amount of hydrolysis that occur, similar to pH as discussed herein.

For example, the permeability of a microcapsule may be controlled such that the microcapsule is relatively impermeable to particles having an average cross-sectional diameter of less than 20 nm, less than 15 nm, or less than 10 nm at a first condition (e.g., pH, temperature, etc.,) while being relatively permeable to such particles at a second condition. For instance, the degree of permeability may increase by at least 10%, at least 25%, at least 50%, at least 75%, at least 100%, at least 150%, or at least 200% or more, relative to the impermeable condition.

In another set of embodiments, the permeability of a microcapsule may be controlled such that the molecular weight cut-off (MWCO) for the permeability of an agent decreases with increasing permeability, i.e., smaller molecules or other agents are able to transport across the microcapsule at higher permeability states than lower permeability states.

In addition in some embodiments, a fair amount of swelling may occur. For instance, the average cross-sectional diameter of the microcapsule may increase by at least 25%, at least 50%, at least 75%, or at least 100% between a first condition (e.g., pH, temperature, etc.) and a second condition.

In some cases, some of the conditions described herein may be partially or completely reversible, e.g., at a first condition (e.g., pH, temperature, etc.), a microcapsule may exhibit a first permeability and/or size, then if the condition is changed to a second condition, the microcapsule may exhibit a second permeability and/or size, and upon changing the condition to the first condition, the microcapsule may again exhibit the first permeability and/or size.

In some embodiments, the monomers are water immiscible and/or hydrophobic. Examples of suitable monomers include, but are not limited to, multifunctional thiol and vinyl monomers for thiol-ene step-growth polymerization, or methacrylates for free radical polymerization. Non-limiting examples of suitable monomers include pentaerythritol tetrakis(3-mercaptopropionate) (PETMP), tri(ethylene glycol) divinyl ether (TEGDVE), 4-pentenoic anhydride (PA), methacrylic anhydride, ethylene glycol dimethacrylate (EGDMA), or the like.

In some cases, multifunctional thiol may be used. For example, in one set of embodiments, multifunctional thiols such as tetrakis(mercapto propionate) may be used with triethyleneglycol divinyl ether and pentenoic anhydride to polymerize or cross-link an anhydride.

In some embodiments, the microcapsules described herein may be formed using one or more conduits.

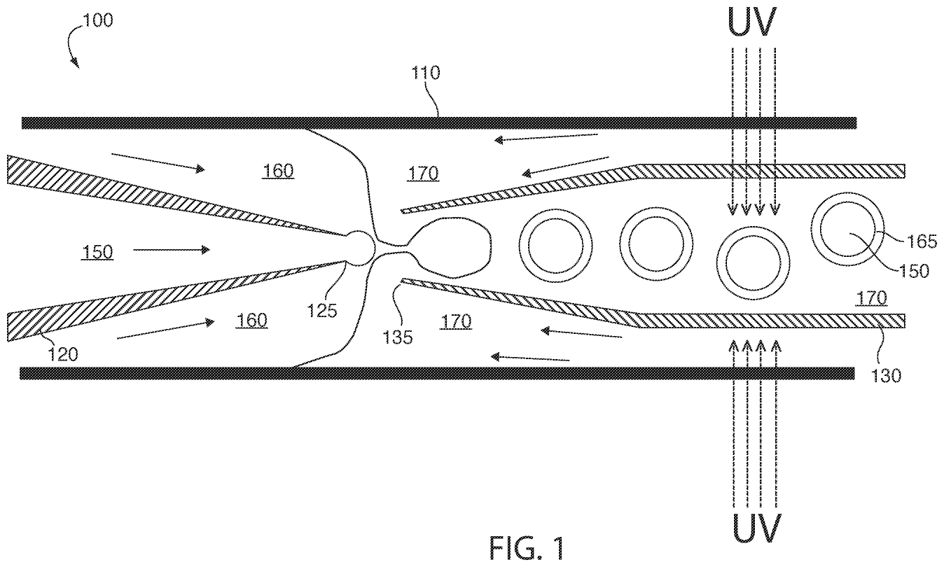

For example, FIG. 1 includes an exemplary schematic illustration of system 100 in which triple emulsions are formed. In FIG. 1, system 100 includes outer conduit 110, a first inner conduit (or injection tube) 120, and a second inner conduit (or collection tube) 110. First inner conduit 120 includes an exit opening 125 that opens into the outer conduit 110, and second inner conduit 110 includes an entrance opening 115 that opens within the outer conduit 110.

As shown in FIG. 1, inner fluid 150 flows through conduit 120 and out of exit opening 125 into conduit 110, in a left to right direction. In addition, fluid 160 is illustrated flowing through conduit 110 in a left to right direction, outside inner fluid 150 and conduit 120. Near entrance opening 115 of conduit 130, fluid 160 surrounds fluid 150 to form the first nesting of the triple emulsion. Fluid 170 is illustrated entering conduit 110 from the right side and flowing in a right to left direction. Upon contacting fluid 160, fluid 170 reverses direction, and surrounds fluids 150 and 160 near entrance opening 115 of conduit 110 to form the second nesting of the triple emulsion.

In some embodiments, inner fluid 150 comprises an aqueous solution and, optionally, cargo (or other suitable agent) and/or relatively large particles.

In certain embodiments, fluid 160 comprises a monomer (e.g., an anhydride monomer) and, optionally, one or more photoinitiators.

In some cases, fluid 170 comprises an aqueous solution and one or more surfactants.

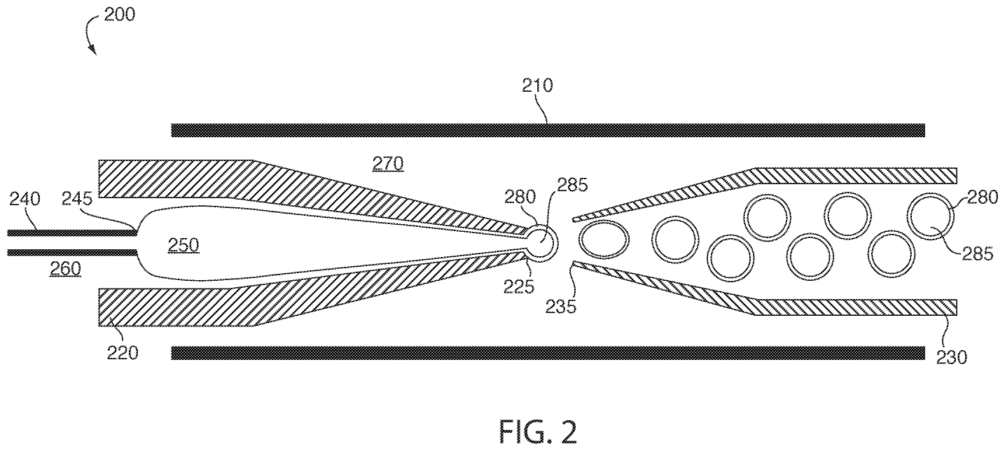

FIG. 2 includes another exemplary schematic diagram of a system 200 to form multiple emulsions, which may be used to form microcapsules, according to some embodiments. In FIG. 2, system 200 includes outer conduit 210, a first inner conduit (or injection tube) 220, and a second inner conduit (or collection tube) 230. First inner conduit 220 includes an exit opening 225 that opens into the outer conduit 210, and second inner conduit 230 includes an entrance opening 235 that opens within the outer conduit 210. System 200 also includes a third inner conduit 240 disposed within first inner conduit 220. Inner conduit 240 includes an exit opening 245 that opens into conduit 220. As illustrated in FIG. 2, conduits 210, 220, 230, and 240 are illustrated as being concentric relative to each other. However, it should be noted that “concentric,” as used herein, does not necessarily refer to tubes that are strictly coaxial, but also includes nested or “off-center” tubes that do not share a common center line. In some embodiments, however, the tubes may all be strictly coaxial with each other.

The inner diameter of conduit 220 generally decreases in a direction from left to right, as shown in FIG. 2, and the inner diameter of conduit 230 generally increases from the entrance opening in a direction from left to right as exhibited in FIG. 2. These constrictions, or tapers, provide geometries that aid in producing consistent emulsions, at least in some cases. While the rate of constriction is illustrated as being linear in FIG. 2, in other embodiments, the rate of constriction may be non-linear.

As shown in FIG. 2, inner droplet fluid 250 flows through third inner conduit 240 and out of exit opening 245 into conduit 220, in a left to right direction. In addition, outer droplet fluid 260 is illustrated flowing through conduit 220 in a left to right direction, outside inner droplet fluid 250 and conduit 240. Carrying fluid 270 is illustrated flowing in a left to right direction in the pathway provided between outer conduit 210 and conduit 220.

As illustrated in FIG. 2, inner droplet fluid 250 exits from exit opening 225 and is restrained from contacting the inner surface of conduit 220 by outer droplet fluid 260. As shown in the example of FIG. 2, no portion of inner fluid 250 contacts the inner surface of conduit 220 after its exit from conduit 240. In some embodiments, various system parameters can be chosen such that droplets of the first fluid are not formed at the exit opening of the first conduit. For example, in some embodiments, the flow rates of inner droplet fluid 250 and outer droplet fluid 260 can be chosen such that inner droplet fluid 250 forms the inner fluid (or core) and outer droplet fluid 260 forms the outer fluid (or sheath) in a core-sheath flow arrangement. As illustrated in FIG. 2, outer droplet fluid 260 does not completely surround inner droplet fluid 250 to form a droplet, but rather, outer droplet fluid 260 forms a sheath that surrounds inner droplet fluid 250 about its longitudinal axis. In some embodiments, conduit 240 has a capillary number such that no droplets are produced at the exit opening of conduit 240. As another example, inner droplet fluid 250 and/or outer droplet fluid 260 can be selected to have viscosities such that no droplets are produced at the exit opening of conduit 240.

In some embodiments, inner droplet fluid 250 comprises an aqueous solution and, optionally cargo (or other suitable agent) and/or relatively large particles.

In certain embodiments, outer droplet fluid 260 comprises a monomer such as an anhydride monomer and, optionally, one or more photoinitiators.

In some cases, carrying fluid 270 may comprise an aqueous solution and one or more surfactants.

Additionally, in some embodiments, outer droplet fluid 260 may not come into contact with the surface of conduit 230, at least until after a multiple emulsion droplet has been formed, because outer droplet fluid 260 is surrounded by carrying fluid 270 as the droplet enters collection tube 230.

As inner droplet fluid 250 and outer droplet fluid 260 are transported out of exit opening 225 of conduit 220, two droplets may be formed: an outer droplet 280 (including outer droplet fluid 260) and an inner droplet 285 (including inner droplet fluid 250) positioned within the outer droplet 280. As illustrated in FIG. 2, outer droplet 280 may form a relatively thin shell around inner droplet 285. Droplets 280 and 285 may be formed sequentially, or substantially simultaneously. For example, in FIG. 2, as fluids 250 and 260 are transported out of the exit opening 225 of conduit 220, the boundary between fluids 250 and 260 can be closed (e.g., by forming a substantially enclosed interface between the two fluids) at substantially the same time as the boundary between fluids 260 and 270 is formed. The droplets formed from the fluids exiting conduit 220 may be transported away from exit opening 225 and through opening 235 of conduit 230 by carrying fluid 270 as the droplets are transported through conduit 210.

While inner droplet fluid 250 is illustrated as forming a continuous jet extending from conduit 240 to exit opening 225 of conduit 220 in FIG. 2, in some embodiments, inner droplet fluid 250 may form one or more droplets prior to reaching exit opening 225. The droplets produced within conduit 220 may be further broken up upon exiting exit opening 225 of conduit 220 in certain cases. In some embodiments, the flow rates of inner droplet fluid 250 and/or outer droplet fluid 260 and/or other parameters within the system (e.g., fluid viscosities, channel dimensions, channel wall properties, etc.) can be selected such that jetting flow of inner droplet fluid 250 within outer droplet fluid occurs 260 within conduit 220. As used herein, a “jetting flow” regime refers to a condition in which a continuous stream of a first fluid (e.g., inner droplet fluid 250) extends longitudinally through a continuous stream of a second fluid without, in the regime, breaking up to form droplets of the inner fluid within the outer fluid (although breakup of the same fluid into droplets typically occurs outside of the jetting flow regime). In some embodiments, the fluid in the jetting flow regime (e.g., inner droplet fluid 250 in FIG. 2) can be continuous over a length of at least about 5, at least about 10, or at least about 25 times the cross-sectional diameter of the droplets that are eventually formed from the fluid, wherein the continuous length is measured from the exit opening of the conduit through which the fluid is delivered to the point at which the fluid breaks up to form droplets.

In contrast, a “dripping flow” regime refers to a condition in which a first fluid is broken up into droplets in a second fluid within a distance from the exit of the conduit through which it is delivered (e.g., conduit 240 in FIG. 2) that is less than or equal to about 2 times the average cross-sectional diameter of the first fluid droplets that are formed. As one particular example, in the set of embodiments illustrated in FIG. 2, inner droplet fluid 250 is illustrated as flowing from conduit 240 in a jetting flow regime, while inner droplet fluid 250 and outer droplet fluid 260 are illustrated as flowing from conduit 220 in a dripping flow regime.

In some embodiments, inner droplet fluid 250 and outer droplet fluid 260 do not break to form droplets until the fluids are inside of conduit 230 (i.e., to the right of end 235, which defines the entrance orifice of conduit 230 in FIG. 2). In other embodiments, however, inner droplet fluid 250 and outer droplet fluid 260 break to from droplets prior to entering conduit 230 (i.e., to the left of end 235). Under “dripping” conditions, the droplets are formed closer to the orifice at end 235 of conduit 230, while under “jetting” conditions, the droplets are formed further downstream, i.e., farther to the right as illustrated in FIG. 2. For example, under certain “dripping” conditions, droplets are produced when positioned within a single orifice diameter; this mode of operation can be analogized to a dripping faucet. Under some jetting conditions, a long jet is produced that extends three or more orifice diameters downstream down the length of the collection tube, where the jet breaks into droplets.

Droplet formation and morphology (and/or the corresponding morphology of particles formed from the droplets) can be affected in a number of ways, in various embodiments of the invention. For example, the geometry (physical configuration) of the device 200, including the relationship of the outer conduit and the inner conduits, may be configured to develop multiple emulsions of desired volume, frequency, and/or content. For example, the diameters of the exit openings at exit openings 225 and/or 245 of conduits 220 and 240, respectively, may be selected to help control the relative volumes of the formed droplets. Droplet formation may be affected, in some cases, by the rate of flow of the inner droplet fluid, the rate of flow of the outer droplet fluid, the rate of flow of the carrying fluid, the total amount of flow or a change in the ratios of any two of these, and/or combinations of any of these flow rates.

The formation of microcapsules (e.g., emulsions and multiple emulsions) containing droplets with a uniform size, shape, and/or a uniform number of smaller droplets contained within larger droplets is known in the art. For example, International Patent Publication No. WO 2008/121342 by Weitz, et al., describes the use of microfluidic systems to produce multiple emulsions containing uniformly sized larger droplets each containing smaller droplets. Generally, in these systems, multiple emulsions are formed by nesting multiple immiscible fluids within a microfluidic conduit system. The multiple emulsions can be produced by first producing one or more droplets of a first fluid within a second fluid at the exit of a first conduit. These droplets are then transported to the end of a second conduit, where a multiple emulsion is formed in which the second fluid surrounds the droplets of the first fluid.

In addition, the formation of multiple emulsions in which the first and second droplets are formed simultaneously is known in the art. For example, International Patent Publication Number WO 2006/096571 by Weitz, et al., includes a description of various microfluidic systems in which fluids are transported through two nested conduits contained within another conduit to produce multiple emulsions. However, multiple conduits are typically used in these systems, and in some cases, an inner conduit is nested within a surrounding conduit such that the exit opening of the inner conduit extends past the exit opening of the surrounding conduit. As another example, International Patent Publication Number WO 2011/028764, by Weitz, et al., describes the formation of multiple emulsions, but in various systems that include certain intersections of different conduits.

The present invention is generally directed in some embodiments to surprising new methods of flowing fluids in conduits (and associated articles and systems) to produce microcapsules comprising a poly(acid) (e.g., and not comprising a poly(base) and/or polycation) in aqueous environments. As described in more detail below, it has been discovered that microcapsules formed comprising shells comprising poly(anhydride) may be hydrolyzed such that the shell comprises poly(acid) without the use of sacrificial templates and/or polyelectrolyte multilayers. In some cases, increasing fluid flow rates of the fluids in conduits from a stable operating regime produces an unstable operating regime, but unexpectedly, further increases in flow rates produce a second stable operating regime. In some cases, the microcapsules formed within the second, stable operating regime may comprise relatively thin intermediate fluid shells comprising a poly(acid). Rather than first producing droplets of a first fluid at an exit opening of a first conduit and subsequently passing these droplets through an end of a second conduit to produce a double emulsion (i.e., operating under a “droplet flow” regime), the first and second droplets within the microcapsules of the present invention may be formed simultaneously. Simultaneous formation of the first and second droplets can be achieved, in some embodiments, by transporting a first fluid within a first conduit at a relatively high flow rate such that the first fluid forms a continuous stream of fluid within the second fluid as the first fluid exits the first conduit (i.e., a “jetting flow” regime). As the jet of the first fluid exits a second conduit located downstream of the first conduit, the second fluid can surround the first fluid, thereby forming a double emulsion. When operated under a jetting flow regime, the microcapsules formed at the exit opening of the second conduit may contain, in some embodiments, relatively thin shells of the second fluid. In addition, operation under a jetting flow regime may allow for high speed production of multiple emulsions, relative to the droplet flow regime, at least in some cases.

A microcapsule described herein may contain one or more droplets therein. A “droplet,” as used herein, is an isolated portion of a first fluid that is surrounded by a second fluid and/or shell. It is to be noted that a droplet is not necessarily spherical, but may assume other shapes as well, for example, depending on the external environment. In some embodiments, the droplet has a minimum cross-sectional dimension that is substantially equal to the largest dimension of the channel perpendicular to fluid flow in which the droplet is located.

Using the methods and devices described herein, in certain embodiments, a consistent volume and/or number of microcapsules are produced, and/or a consistent ratio of volume and/or number of outer droplets to inner droplets (or other such ratios) are produced. In addition, as described elsewhere, the relative volumes of the fluidic droplets within the microcapsules are configured in some cases to include a relatively thin layer of fluid, e.g., separating two other fluids. For example, in some cases, a single droplet within an outer droplet is configured/formed such that the inner droplet occupies a relatively large percentage of the volume of the outer droplet, thereby resulting in a thin layer of outer droplet fluid surrounding the inner droplet fluid. The thin layer of outer droplet fluid surrounding the inner droplet fluid, which may contain a polymer, may be subsequently dried to form a solid shell containing a fluid. The ability to precisely control the dimensions of the thin layer of outer droplet fluid can allow one to fabricate particles configured with thin shells, including any of the thicknesses or other dimensions described elsewhere herein.

In some embodiments, a triple emulsion may be produced, i.e., an emulsion containing an inner droplet (or first) fluid, surrounded by an outer droplet (or second) fluid (or shell), which in turn is surrounded by a third or carrying fluid. In some cases, the carrying fluid and the inner droplet fluid may be the same. These fluids are often of varying miscibilities due to differences in hydrophobicity. For example, the inner droplet fluid may be water soluble, the outer droplet fluid (or shell) oil soluble, and the carrying fluid water soluble. This configuration is often referred to as a W/O/W multiple emulsion (“water/oil/water”). Another multiple emulsion may include an inner droplet fluid that is oil soluble, an outer droplet fluid that is water soluble, and a carrying fluid that is oil soluble. This type of multiple emulsion is often referred to as an O/W/O multiple emulsion (“oil/water/oil”). It should be noted that the term “oil” in the above terminology merely refers to a fluid that is generally more hydrophobic and not miscible or soluble in water, as is known in the art. Thus, the oil may be a hydrocarbon in some embodiments, but in other embodiments, the oil may comprise other hydrophobic fluids.

In the descriptions herein, multiple emulsions are generally described with reference to a three phase system, i.e., having an inner droplet fluid, an outer droplet fluid (or shell), and a carrying fluid. However, it should be noted that this is by way of example only, and that in other systems, additional fluids may be present within the multiple emulsion. As examples, an emulsion may contain a first fluid droplet and a second fluid droplet, each surrounded by a third fluid, which is in turn surrounded by a fourth fluid; or an emulsion may contain multiple emulsions with higher degrees of nesting, for example, a first fluid droplet surrounded by a second fluid droplet, which is surrounded by a third fluid droplet, which is contained within a carrying fluid. Accordingly, it should be understood that the descriptions of the inner droplet fluid, outer droplet fluid, and carrying fluid are for ease of presentation, and that the descriptions herein are readily extendable to systems involving additional fluids, e.g., quadruple emulsions, quintuple emulsions, sextuple emulsions, septuple emulsions, etc.

In addition, by controlling the geometry (physical configurations) of the conduits and/or the flow of fluid through the conduits, the average cross-sectional diameters of the droplets that are produced may be controlled in certain embodiments. Those of ordinary skill in the art will be able to determine the average cross-sectional diameter (or other characteristic dimension) of a plurality or series of droplets, for example, using laser light scattering, microscopic examination, or other known techniques. The average cross-sectional diameter of a single droplet, in a non-spherical droplet, is the diameter of a perfect sphere having the same volume as the non-spherical droplet. The average cross-sectional diameter of a droplet (and/or of a plurality or series of droplets) may be, for example, less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about 5 micrometers in some cases. The average cross-sectional diameter may also be at least about 1 micrometer, at least about 2 micrometers, at least about 3 micrometers, at least about 5 micrometers, at least about 10 micrometers, at least about 15 micrometers, or at least about 20 micrometers in certain cases. In some embodiments, at least about 50%, at least about 75%, at least about 90%, at least about 95%, or at least about 99% of the droplets within a plurality of droplets has an average cross-sectional diameter within any of the ranges outlined in this paragraph.

The droplets may be of substantially the same shape and/or size (i.e., “monodisperse”), or of different shapes and/or sizes, depending on the particular application. In some cases, the droplets may have a homogenous distribution of cross-sectional diameters, i.e., the droplets may have a distribution of cross-sectional diameters such that no more than about 10%, about 5%, about 3%, about 1%, about 0.03%, or about 0.01% of the droplets have an average diameter that is more than about 10%, about 5%, about 3%, about 1%, about 0.03%, or about 0.01% different from the average cross-sectional diameter of the droplets. Some techniques for producing homogenous distributions of cross-sectional diameters of droplets are disclosed in International Patent Application No. PCT/US2004/010903, filed Apr. 9, 2004, entitled “Formation and Control of Fluidic Species,” by Link et al., published as WO 2004/091763 on Oct. 28, 2004, incorporated herein by reference, and in other references as described below and/or incorporated herein by reference.

In some cases, such as when the outer droplets (containing outer droplet fluid 260) are formed at the same rate as are inner droplets (containing inner droplet fluid 250), there can be a one-to-one correspondence between the number of inner droplets and the number of outer droplets; for example, in some embodiments, each inner droplet is surrounded by an outer droplet, and each outer droplet contains a single inner droplet of inner fluid. In other embodiments, different ratios of the number of inner droplets and the number of outer droplets may be present. In some embodiments, substantially all of the multiple emulsion droplets that are produced are double emulsion droplets.

In some embodiments of the invention, at least a portion of a multiple emulsion may be solidified to form a microcapsule, for example, an outer fluid and/or an inner fluid. A fluid can be solidified using any suitable method. In some embodiments, the outer fluid (e.g., outer droplet fluid 260) may be polymerized in the presence of electromagnetic radiation such as ultraviolet light by the photoinitiator to form the shell of the microcapsule. In some cases, the shell may be a hydrogel. Thus, an outer droplet may be solidified to form a hydrogel shell that encapsulates one or more fluids and/or cargo(s), for example, for delivery to a target medium, as described elsewhere herein.

It should be noted that FIGS. 1 and 2 and the related descriptions are only exemplary, and other multiple emulsions (e.g., having differing numbers of droplets, nesting levels, etc.), and other systems are also contemplated within various embodiments of the instant invention. For example, the device in FIG. 2 may be configured to include other flow arrangements and/or additional concentric tubes, for example, to produce more highly nested droplets. By supplying fourth, fifth, sixth, etc. fluids, increasingly complex droplets within droplets can be produced in certain embodiments. Some of these fluids may be the same, in certain embodiments of the invention (e.g., the first fluid may have the same composition as the third fluid, the second fluid may have the same composition as the fourth fluid, etc.).

The rate of production of multiple emulsion droplets may be determined by the droplet formation frequency, which under many conditions can vary between approximately 1 Hz and 5000 Hz. In some cases, the rate of droplet production may be at least about 1 Hz, at least about 10 Hz, at least about 100 Hz, at least about 200 Hz, at least about 300 Hz, at least about 500 Hz, at least about 750 Hz, at least about 1,000 Hz, at least about 2,000 Hz, at least about 3,000 Hz, at least about 4,000 Hz, or at least about 5,000 Hz.

Production of large quantities of emulsions may be facilitated by the parallel use of multiple devices such as those described herein, in some instances. In some cases, relatively large numbers of devices may be used in parallel, for example at least about 10 devices, at least about 30 devices, at least about 50 devices, at least about 75 devices, at least about 100 devices, at least about 200 devices, at least about 300 devices, at least about 500 devices, at least about 750 devices, or at least about 1,000 devices or more may be operated in parallel. The devices may comprise different conduits (e.g., concentric conduits), openings, microfluidics, etc. In some cases, an array of such devices may be formed by stacking the devices horizontally and/or vertically. The devices may be commonly controlled, or separately controlled, and can be provided with common or separate sources of various fluids, depending on the application.

The systems and methods described herein can be used in a plurality of applications. For example, fields in which the microcapsules (e.g., containing an agent as discussed herein) and multiple emulsions described herein may be useful include, but are not limited to, food, beverage, health and beauty aids, paints and coatings, chemical separations, and drugs and drug delivery. For instance, a precise quantity of a fluid, drug, pharmaceutical, or other agent can be contained by a shell designed to release its contents under particular conditions. In some instances, cells can be contained within a droplet, and the cells can be stored and/or delivered, e.g., to a target medium, for example, within a subject. Other agents that can be contained within a particle and delivered to a target medium include, for example, biochemical species such as nucleic acids such as siRNA, RNAi and DNA, proteins, peptides, or enzymes. Additional agents that can be contained within an emulsion include, but are not limited to, colloidal particles, magnetic particles, nanoparticles, quantum dots, fragrances, proteins, indicators, dyes, fluorescent species, chemicals, or the like. The target medium may be any suitable medium, for example, water, saline, an aqueous medium, a hydrophobic medium, or the like. Thus, for example, an agent encapsulated within a microcapsule may be released into a target medium. For example, the agent may be relatively hydrophilic or soluble in water, to allow for release into an aqueous target medium.

In one particular set of embodiments, microcapsules comprising relative thin shells can be formed using the multiple emulsion techniques described herein. In some embodiments, as a non-limiting illustrative example, one or more microcapsules can be used to deliver a fluid and/or an agent to a target medium, such as a hydrocarbon, crude oil, petroleum, or other medium. In some cases, at least some of the microcapsules may comprise a solid portion or shell at least partially containing an interior containing a fluid and/or an agent. The shells of the microcapsules can comprise a polymer, and in some cases, substantially all of the polymer within the shells is at least partially soluble in the target medium. The carrying fluid in which the microcapsules are formed may be used as a vehicle used to contact the microcapsules with a target medium, and/or the carrying fluid may be substituted by a suitable vehicle, as discussed elsewhere herein. When the microcapsules contact the target medium, at least a portion of the shells of the microcapsules can be disrupted, for instance, such that at least some of the fluid and/or agent within the particles is expelled or otherwise transported from the microcapsules and into the target medium. Of course, it should be understood that the p microcapsules articles may be used in other applications as well, e.g., as discussed herein.

A variety of surfactants may be used to form the microcapsules. In some embodiments, for example, the microcapsules may be formed from an ionic (e.g., cationic or anionic) surfactant. Exemplary anionic surfactants suitable for use include, but are not limited to, sodium dodecyl sulfate (SDS), ammonium lauryl sulfate, sodium lauryl sulfate, sodium laureth sulfate, dioctyl sodium sulfosuccinate, perfluorooctanesulfonate (PFOS), perfluorobutanesulfonate, alkyl aryl ether phosphate, alkyl ether phosphate, alkyl carboxylates, fatty acid salts (soaps), sodium stearate, sodium lauroyl sarcosinate, carboxylate fluorosurfactants, perfluorononanoate, perfluorooctanoate (PFOA or PFO), or the like. Exemplary cationic surfactants suitable for use include, but are not limited to, cetyl trimethylammonium bromide (CTAB), hexadecyl trimethyl ammonium bromide, cetyl trimethylammonium chloride (CTAC), cetylpyridiniumchloride (CPC), polyethoxylated tallow amine (POEA), benzalkonium chloride (BAC), benzethonium chloride (BZT), or the like. In some embodiments, non-ionic surfactants are used, including, but not limited to: sorbitan monooleate (also referred to as Span 80); Poly(ethylene glycol)-block-poly(propylene glycol)-block-poly(ethylene glycol), Poly(propylene glycol)-block-poly(ethylene glycol)-block-poly(propylene glycol) (also referred to as F 108); polyvinyl alcohol (PVA); cetyl alcohol, stearyl alcohol; cetostearyl alcohol (e.g., consisting predominantly of cetyl and stearyl alcohols); oleyl alcohol; polyoxyethylene glycol alkyl ethers (Brij); octaethylene glycol monododecyl ether; pentaethylene glycol monododecyl ether; polyoxypropylene glycol alkyl ethers; glucoside alkyl ethers; decyl glucoside; lauryl glucoside; octyl glucoside; polyoxyethylene glycol octylphenol ethers; triton X-100; polyoxyethylene glycol alkylphenol ethers; nonoxynol-9; glycerol alkyl esters; glyceryl laurate; polyoxyethylene glycol sorbitan alkyl esters; polysorbates; sorbitan alkyl esters; cocamide MEA; cocamide DEA; dodecyldimethylamine oxide; block copolymers of polyethylene glycol and polypropylene glycol; Poloxamers; or the like.

Examples of suitable carrier fluids include, but are not limited to, water, alcohols (e.g., butanol (e.g., n-butanol), isopropanol (IPA), propanol (e.g., n-propanol), ethanol, methanol, glycerin, or the like), saline solutions, blood, acids (e.g., formic acid, acetic acid, or the like), amines (e.g., dimethyl amine, diethyl amine, or the like), mixtures of these, and/or other similar fluids. In some embodiments, polar protic solvents (e.g., alcohols, acids, bases, etc.) can be used in the carrier fluid. In some embodiments, polar aprotic solvents can be used in the hydrophilic vehicle, including, for example, dimethyl sulfoxide (DMSO), acetonitrile (MeCN), dimethylformamide (DMF), acetone, or the like.

The microcapsules described herein may have any suitable average cross-sectional diameter. Those of ordinary skill in the art will be able to determine the average cross-sectional diameter of a single microcapsules and/or a plurality of microcapsules, for example, using laser light scattering, microscopic examination, or other known techniques. The average cross-sectional diameter of a single microcapsules, in a non-spherical microcapsules, is the diameter of a perfect sphere having the same volume as the non-spherical microcapsules. The average cross-sectional diameter of a microcapsules (and/or of a plurality or series of microcapsules) may be, for example, less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about 5 micrometers, or between about 50 micrometers and about 1 mm, between about 10 micrometers and about 500 micrometers, or between about 50 micrometers and about 100 micrometers in some cases. The average cross-sectional diameter may also be at least about 1 micrometer, at least about 2 micrometers, at least about 3 micrometers, at least about 5 micrometers, at least about 10 micrometers, at least about 15 micrometers, or at least about 20 micrometers in certain cases. In some embodiments, at least about 50%, at least about 75%, at least about 90%, at least about 95%, or at least about 99% of the microcapsules within a plurality of microcapsules has an average cross-sectional diameter within any of the ranges outlined in this paragraph.

In some embodiments, the shell of the microcapsule(s) are relatively thin. In other embodiments, the shell of the microcapsule(s) may be relatively thick.

In some embodiments, the shell of a microcapsule has an average thickness (averaged over the entire microcapsule) of less than about 0.05, less than about 0.01, less than about 0.005, or less than about 0.001 times the average cross-sectional diameter of the microcapsule, or between about 0.0005 and about 0.05, between about 0.0005 and about 0.01, between about 0.0005 and about 0.005, or between about 0.0005 and about 0.001 times the average cross-sectional diameter of the microcapsule. In some embodiments, the shell of a microcapsule has an average thickness of less than about 1 micron, less than about 500 nm, or less than about 100 nm, or between about 50 nm and about 1 micron, between about 50 nm and about 500 nm, or between about 50 nm and about 100 nm. In some embodiments, at least about 50%, at least about 75%, at least about 90%, at least about 95%, or at least about 99% of the microcapsules within a plurality of microcapsules includes a shell having an average thickness within any of the ranges outlined in this paragraph. One of ordinary skill in the art would be capable of determining the average thickness of a shell by, for example, examining scanning electron microscope (SEM) images of the microcapsules.

For many applications, it may be desirable to deliver a plurality of microcapsules, at least some of which contain a fluid and/or an agent such as a surfactant, to a target medium. In order to ensure predictable agent delivery, some embodiments advantageously employ microcapsules with relatively consistent properties. For example, in some embodiments, a plurality of microcapsules are provided wherein the distribution of shell thicknesses among the plurality of microcapsules is relatively uniform. The use of microcapsules with relatively uniform shell thicknesses can ensure, in some cases, consistent shell dissolution times, making agent delivery more predictable. In some embodiments, a plurality of microcapsules are provided having an overall average shell thickness, measured as the average of the average shell thicknesses of each of the plurality of microcapsules. In some cases, the distribution of the average shell thicknesses can be such that no more than about 5%, no more than about 2%, or no more than about 1% of the microcapsules have a shell with an average shell thickness thinner than 90% (or thinner than 95%, or thinner than 99%) of the overall average shell thickness and/or thicker than 110% (or thicker than 105%, or thicker than about 101%) of the overall average shell thickness.

The plurality of microcapsules may have relatively uniform cross-sectional diameters in certain embodiments. The use of microcapsules with relatively uniform cross-sectional diameters can allow one to control the viscosity of the microcapsule suspension, the amount of agent delivered to the target medium, and/or other parameters of the delivery of fluid and/or agent from the microcapsules. In some embodiments, the plurality of microcapsules has an overall average diameter and a distribution of diameters such that no more than about 5%, no more than about 2%, or no more than about 1% of the microcapsules have a diameter less than about 90% (or less than about 95%, or less than about 99%) and/or greater than about 110% (or greater than about 105%, or greater than about 101%) of the overall average diameter of the plurality of microcapsules.

In some embodiments, the plurality of microcapsules has an overall average diameter and a distribution of diameters such that the coefficient of variation of the cross-sectional diameters of the microcapsules is less than about 10%, less than about 5%, less than about 2%, between about 1% and about 10%, between about 1% and about 5%, or between about 1% and about 2%. The coefficient of variation can be determined by those of ordinary skill in the art, and may be defined as:

$${c}_{v} = \frac{σ}{\vert μ \vert} \qquad [ 1 ]$$

wherein σ is the standard deviation and μ is the mean.

As used herein, the term “fluid” generally refers to a substance that tends to flow and to conform to the outline of its container, i.e., a liquid, a gas, a viscoelastic fluid, etc. Typically, fluids are materials that are unable to withstand a static shear stress, and when a shear stress is applied, the fluid experiences a continuing and permanent distortion. The fluid may have any suitable viscosity that permits flow. If two or more fluids are present, each fluid may be independently selected among essentially any fluids (liquids, gases, and the like) by those of ordinary skill in the art, by considering the relationship between the fluids.

In an aspect of the present invention, as discussed, multiple emulsions are formed by flowing fluids through one or more conduits. The system may be a microfluidic system. “Microfluidic,” as used herein, refers to a device, apparatus, or system including at least one fluid channel having a cross-sectional dimension of less than about 1 millimeter (mm), and in some cases, a ratio of length to largest cross-sectional dimension of at least 3:1. One or more conduits of the system may be a capillary tube. In some cases, multiple conduits are provided, and in some embodiments, at least some are nested, as described herein. The conduits may be in the microfluidic size range and may have, for example, average inner diameters, or portions having an inner diameter, of less than about 1 millimeter, less than about 300 micrometers, less than about 100 micrometers, less than about 30 micrometers, less than about 10 micrometers, less than about 3 micrometers, or less than about 1 micrometer, thereby providing droplets having comparable average diameters. One or more of the conduits may (but not necessarily), in cross-section, have a height that is substantially the same as a width at the same point. A conduit may include an opening that may be smaller, larger, or the same size as the average diameter of the conduit. For example, conduit openings may have diameters of less than about 1 mm, less than about 500 micrometers, less than about 300 micrometers, less than about 200 micrometers, less than about 100 micrometers, less than about 50 micrometers, less than about 30 micrometers, less than about 20 micrometers, less than about 10 micrometers, less than about 3 micrometers, etc. In cross-section, the conduits may be rectangular or substantially non-rectangular, such as circular or elliptical. The conduits of the present invention may also be disposed in or nested in another conduit, and multiple nestings are possible in some cases. In some embodiments, one conduit may be concentrically retained in another conduit and the two conduits are considered to be concentric. However, one concentric conduit may be positioned off-center with respect to another, surrounding conduit, i.e., “concentric” does not necessarily refer to tubes that are strictly coaxial. By using a concentric or nesting geometry, two fluids that are miscible may avoid contact.

In some embodiments, fluids, conduits (including conduit walls), and other materials may be referred to as hydrophobic or hydrophilic. A material is “hydrophobic” when a droplet of water forms a contact angle greater than 90° when placed in intimate contact with the material in question in air at 1 atm and 25° C. A material is “hydrophilic” when a droplet of water forms a contact angle of less than 90° when placed in intimate contact with the material in question in air at 1 atm and 25° C. The “contact angle,” in the context of hydrophobicity and hydrophilicity is the angle measured between the surface of the material and a line tangent to the external surface of the water droplet at the point of contact with the material surface, and is measured through the water droplet.

A variety of materials and methods, according to certain aspects of the invention, may be used to form systems (such as those described above) configured to produce the multiple emulsions and/or microcapsules described herein. In some cases, the various materials selected lend themselves to various methods. For example, various components of the invention are configured from solid materials, in which the conduits are configured via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). In one embodiment, at least a portion of the fluidic system is formed of silicon by etching features in a silicon chip. Technologies for precise and efficient fabrication of various fluidic systems and devices of the invention from silicon are known. In another embodiment, various components of the systems and devices of the invention are configured of a polymer, for example, an elastomeric polymer such as polydimethylsiloxane (“PDMS”), polytetrafluoroethylene (“PTFE” or Teflon®), or the like.

Different components can be fabricated of different materials. For example, a base portion including a bottom wall and side walls can be fabricated from an opaque material such as silicon or PDMS, and a top portion can be fabricated from a transparent or at least partially transparent material, such as glass or a transparent polymer, for observation and/or control of the fluidic process. Components can be coated so as to expose a desired chemical functionality to fluids that contact interior conduit walls, where the base supporting material does not have a precise, desired functionality. For example, components can be fabricated as illustrated, with interior conduit walls coated with another material. Material used to fabricate various components of the systems and devices of the invention, e.g., materials used to coat interior walls of fluid conduits, may desirably be selected from among those materials that will not adversely affect or be affected by fluid flowing through the fluidic system, e.g., material(s) that is chemically inert in the presence of fluids to be used within the device. A non-limiting example of such a coating is disclosed below; additional examples are disclosed in Int. Pat. Apl. Ser. No. PCT/US2009/000850, filed Feb. 11, 2009, entitled “Surfaces, Including Microfluidic Channels, With Controlled Wetting Properties,” by Weitz, et al., published as WO 2009/120254 on Oct. 1, 2009, incorporated herein by reference.

In some embodiments, various components of the invention are fabricated from polymeric and/or flexible and/or elastomeric materials, and can be conveniently formed of a hardenable fluid, facilitating fabrication via molding (e.g. replica molding, injection molding, cast molding, etc.). The hardenable fluid may be essentially any fluid that can be induced to solidify, or that spontaneously solidifies, into a solid capable of containing and/or transporting fluids contemplated for use in and with the fluidic network. In some embodiments, the hardenable fluid comprises a polymeric liquid or a liquid polymeric precursor (i.e. a “prepolymer”). Suitable polymeric liquids include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are utilized in some embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric, and thus may be useful for forming very small features with relatively high aspect ratios, necessary in certain embodiments of the invention. Flexible (e.g., elastomeric) molds or masters can be advantageous in this regard.

An advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy et al.), incorporated herein by reference.

In some embodiments, certain microfluidic structures of the invention (or interior, fluid-contacting surfaces) may be formed from certain oxidized silicone polymers. Such surfaces may be more hydrophilic than the surface of an elastomeric polymer. Such hydrophilic conduit surfaces can thus be more easily filled and wetted with aqueous solutions.

In some embodiments, a bottom wall of a microfluidic device of the invention is formed of a material different from one or more side walls or a top wall, or other components. For example, in some embodiments, the interior surface of a bottom wall comprises the surface of a silicon wafer or microchip, or other substrate. Other components may, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques may be used, as would be apparent to those of ordinary skill in the art, including, but not limited to, the use of separate adhesives, bonding, solvent bonding, ultrasonic welding, etc.

The term “polymer” is given its ordinary meaning in the art and generally refers to extended molecular structures comprising polymer backbones and, optionally, pendant side groups (e.g., a polymer backbone comprising an oligomeric or polymeric chain of one monomer unit, or an oligomeric or polymeric chain of two or more different monomer units). The term “backbone” is also given its ordinary meaning in the art and refers to a linear chain of atoms within the polymer molecule by which other chains may be regarded as being side chains.

As used herein, the term “hydrogel” refers to a polymer network capable of absorbing a relatively high amount of water (e.g., a high weight percentage of water as compared to the weight of the polymer network e.g., greater than 70 wt % water).

As used herein, the term “crosslink” refers to a connection between two polymer strands. The crosslink may either be a chemical bond, a single atom, or multiple atoms. The crosslink may be formed by reaction of a pendant group in one polymer strand with the backbone of a different polymer strand, or by reaction of one pendant group with another pendant group. Crosslinks may exist between separate polymer strands, and may also exist between different points of the same polymer strand. As used herein, the term “polymer strand” refers to an oligomeric or polymeric chain of one monomer unit, or an oligomeric or polymeric chain of two or more different monomer units. In some embodiments, the crosslink comprises a chemical bond, such as an ionic bond, a covalent bond, a hydrogen bond, Van der Waals interactions, and the like. The covalent bond may be, for example, carbon-carbon, carbon-oxygen, oxygen-silicon, sulfur-sulfur, phosphorus-nitrogen, carbon-nitrogen, metal-oxygen, or other covalent bonds. The hydrogen bond may be, for example, between hydroxyl, amine, carboxyl, thiol, and/or similar functional groups.

As used herein, the term “polymer network” refers to a three dimensional substance having oligomeric or polymeric strands interconnected to one another by crosslinks. One of ordinary skill will appreciate that many oligomeric and polymeric compounds are composed of a plurality of compounds having differing numbers of monomers. Such mixtures are often designated by the number average molecular weight of the oligomeric or polymeric compounds in the mixture.

The following documents are incorporated herein by reference in their entirety for all purposes: International Patent Publication Number WO 2004/091763, filed Apr. 9, 2004, entitled “Formation and Control of Fluidic Species,” by Link et al.; International Patent Publication Number WO 2004/002627, filed Jun. 3, 2003, entitled “Method and Apparatus for Fluid Dispersion,” by Stone et al.; International Patent Publication Number WO 2006/096571, filed Mar. 3, 2006, entitled “Method and Apparatus for Forming Multiple Emulsions,” by Weitz et al.; International Patent Publication Number WO 2005/021151, filed Aug. 27, 2004, entitled “Electronic Control of Fluidic Species,” by Link et al.; International Patent Publication Number WO 2008/121342, filed Mar. 28, 2008, entitled “Emulsions and Techniques for Formation,” by Chu et al.; International Patent Publication Number WO 2010/104604, filed Mar. 12, 2010, entitled “Method for the Controlled Creation of Emulsions, Including Multiple Emulsions,” by Weitz et al.; International Patent Publication Number WO 2011/028760, filed Sep. 1, 2010, entitled “Multiple Emulsions Created Using Junctions,” by Weitz et al.; International Patent Publication Number WO 2011/028764, filed Sep. 1, 2010, entitled “Multiple Emulsions Created Using Jetting and Other Techniques,” by Weitz et al; and a U.S. Provisional Patent Application, filed on Jul. 6, 2011, entitled “Delivery to Hydrocarbons or Oil, Including Crude Oil,” by Abbaspourrad et al. Also incorporated herein by reference in their entireties are U.S. Provisional Patent Application Ser. No. 61/505,001, filed Jul. 6, 2011, entitled “Delivery to Hydrocarbons or Oil, Including Crude Oil,” by Abbaspourrad, et al., and of U.S. Provisional Patent Application Ser. No. 61/504,990, filed Jul. 6, 2011, entitled “Multiple Emulsions and Techniques for the Formation of Multiple Emulsions,” by Kim, et al.

U.S. Provisional Patent Application Ser. No. 62/547,904, filed Aug. 21, 2017, by Weitz, et al. is also incorporated herein by reference in its entirety.

All other patents, patent applications, and documents cited herein are also hereby incorporated by reference in their entirety for all purposes.

The following examples are intended to illustrate certain embodiments of the present invention, but do not exemplify the full scope of the invention.

### Example 1

The following example describes the use of polymerizable anhydrides such as methacrylic anhydride and pentenoic anhydride with additional multifunctional cross-linkers to fabricate microparticles and microcapsules with polymer networks that contain anhydride motifs. Polymerized anhydrides have been investigated for their tunable degradability or erosion properties for tissue engineering and drug delivery. Many anhydrides are liquid, immiscible with water (hydrophobic), and sufficiently stable against hydrolysis to form emulsion drops. After polymerization of the monomeric oil phase using UV-initiation, the anhydride linkages within the poly(anhydride) networks hydrolyze and form carboxylic acid motifs within the polymeric network, changing its water affinity to hydrophilic. By introducing cross-links in the poly(anhydride) networks, degradation or erosion of the polymer network may be generally avoided during the hydrolysis, and structural integrity of the resulting poly(acid) microcapsules and particles is achieved. The hydrolysis rate is tunable from minutes to at least weeks through the initial monomeric composition and the external condition. Hydrolysis may be relatively faster at higher anhydride content, and in pH environments above the pKa of the corresponding acid, and the fastest under alkaline conditions. Additionally to switching the polymer networks hydrophilicity, hydrolysis of the anhydride linkages also decreases the cross-link density enabling the release of encapsulated cargo molecules with tunable release times depending on the hydrolysis rate. The use of monomers containing hydrophobic anhydrides enables the direct fabrication of hydrogel encapsulants such as microparticles and microcapsules in water-based emulsion systems without any templating liquids and solids, or other additives such as solvents.

The obtained microcapsules with cross-linked poly(acid) shells may swell in aqueous environment with pHs higher than the poly(acid)'s pKa value and deswell under acidic conditions. This is due to the deprotonation of the weak poly(acids) at higher pHs leading to charged hydrogels, and protonation at low pHs leading to a decrease in water content in the polymer network. Multi-valent cations are also able to physically cross-link poly(anionic) networks such as deprotonated poly(acids) and cause deswelling of the hydrogel. This ionic complexation is generally reversible with competitive complexing anions that remove the cations from the anionic polymer network causing a reswelling of the hydrogel. The reversible swelling properties may impact the permeability of the hydrogel encapsulants, allowing relatively larger molecules to diffuse in and out of the hydrogel microcapsules and particles in the swollen state and inhibiting diffusion through the unswollen polymer network. The exact molecular weight cut-off (MWCO) for the permeability of the hydrogel encapsulants may depend on the composition and cross-link density of the polymeric network.

The dynamic change of permeability with pH and ionic species allows complex release functions of the encapsulants. For example, hydrophilic cargo in the aqueous core of the capsule may be retained at low pH and released when the pH goes above the poly(acid)'s pKa. If the pH drops again, the release stops due to the dynamically changed permeability, and starts again with increasing pH. This can allow for self-adjusting or externally controlled “on-off” release profiles of the encapsulation system. These properties may also allow for the selective capture of molecules below the MWCO in the swollen state that are trapped and can be transferred to different environments in the unswollen state, and subsequently be released upon reswelling of the encapsulant, leading to purification or separation of molecules by size. Additionally, the non-destructive, triggered trap and release mechanism allows for the capsules to be recycled and reused.

Bulk emulsification techniques for the fabrication of complex/multiple emulsions such as core-shell double emulsion drops commonly yield heterogeneous and highly disperse drops and low cargo encapsulation efficiencies. Microfluidic drop formation using multiphasic flow was used to achieve low dispersity in size and high encapsulation efficiencies. Microfluidic drop making allows particle and capsule diameters to be tunable, for example, from single to 100s of microns controlled by, for example, the microfluidic device architecture, flow rates, and fluid properties such as viscosity, surface tension, and density. Microfluidic drop makers with spatially defined surface wettability were used for the formation of water-in-oil-in-water double emulsion drops as well as other complex emulsions drops with independent control over the inner and outer aqueous phases and oil-shell thickness with high encapsulation efficiencies. The conversion from these drops to polymeric microcapsules was achieved by polymerization of the hydrophobic monomer mixtures in the oil-shell of the double emulsion drops.

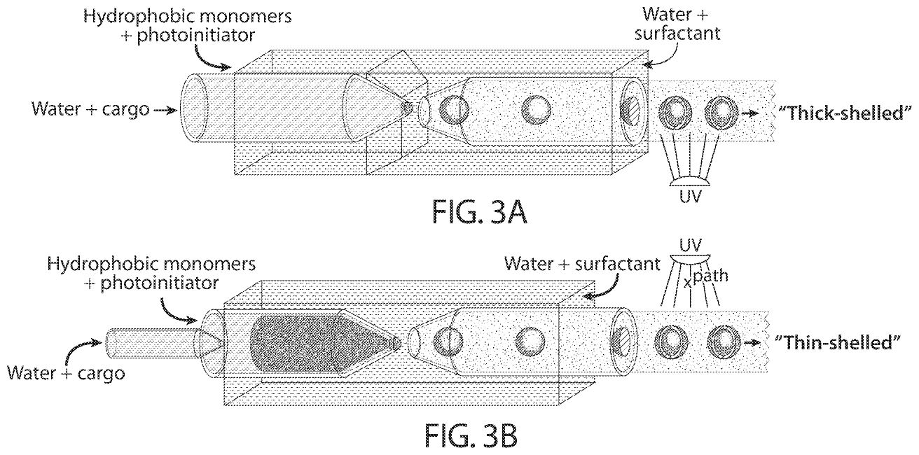

Double emulsion drops were fabricated using nested glass capillary devices (e.g., FIGS. 3A-3B). Two round glass capillaries with outer diameters of 1 mm tapered on one end were inserted from either end of a square capillary with inner edge length of 1.05 mm with the tapered ends facing each other inside the square capillary with a distance of 20-100 micrometers. One of the tapered capillaries with a tip diameter of approximately 40-100 micrometers was used as the injection capillary and treated hydrophobically prior to insertion, the other tapered capillary had a tip diameter of approximately 100-200 micrometers and was used as the outlet and was treated hydrophilically prior to insertion. For so-called thin-shell double emulsions, a third capillary was pulled to an outer diameter well below 1 mm and inserted into the injection capillary. See, e.g., Int. Pat. Apl. Pub. No. WO 2006/096571, incorporated herein by reference in its entirety.

Water-in-oil-in-water thin-shell double emulsion drops were obtained by injecting the inner aqueous phase, 5 wt % polyvinylalcohol (PVA) in water optionally with dissolved cargo molecules, through the innermost, pulled capillary. The water-immiscible anhydride monomers, cross-linkers, and UV-initiator were injected through the injection capillary forming a plug-like flow of the inner aqueous phase in the monomer phase. The outer aqueous phase of 5 wt % PVA in water was injected through the interstitials of the round outlet capillary and the square capillary leading to droplet break up at the tip of the injection capillary. Double emulsion drops with thin hydrophobic monomer shells were formed when a aqueous plug reached the injection capillary tip, while single emulsion drops of the monomers in the outer aqueous phase were formed between plugs.

So-called “thick-shell” double emulsion drops with control over shell thickness were fabricated by flowing the inner aqueous phase through the injection capillary, the hydrophobic monomer phase through the interstitial space of the injection and the square capillary, and the outer aqueous phase through the interstitial space of the round outlet and the square capillary. The inner aqueous phase was engulfed by the hydrophobic monomer phase at the injection capillary tip and broke up into double emulsion drops. The core-to-shell volume ratio could be varied by the relative flows of the inner and monomer phases using this drop-making strategy. Overall drop size could be varied by the flow ratio of the two inner phases to the outer aqueous phase, with smaller drops for smaller ratios when operated in the dripping regime. Schematic representations of the capillary devices are shown in FIGS. 3A-3B.

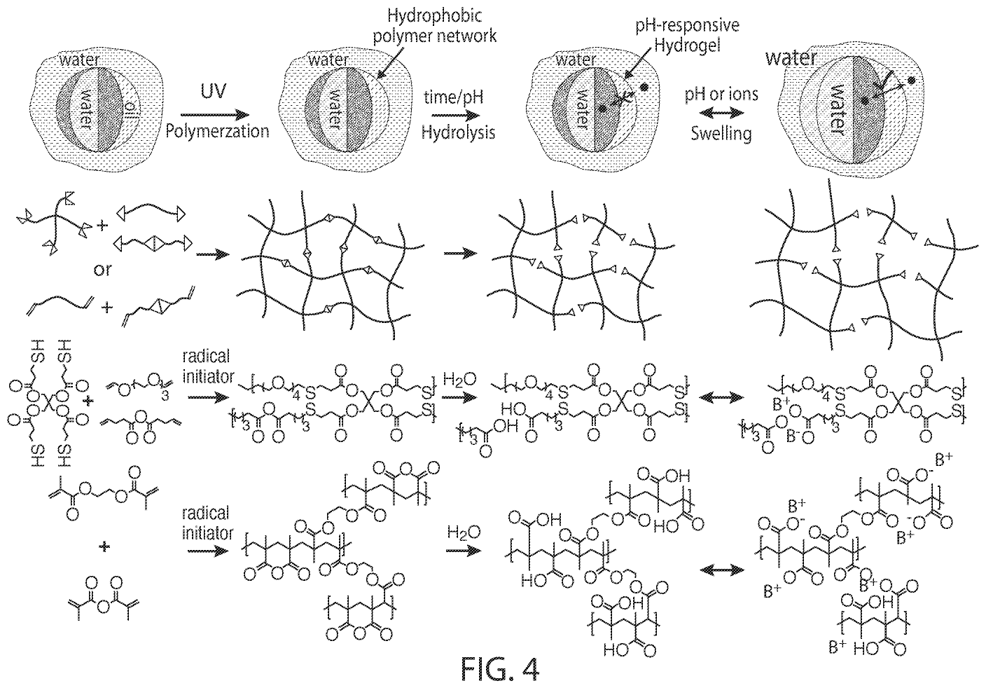

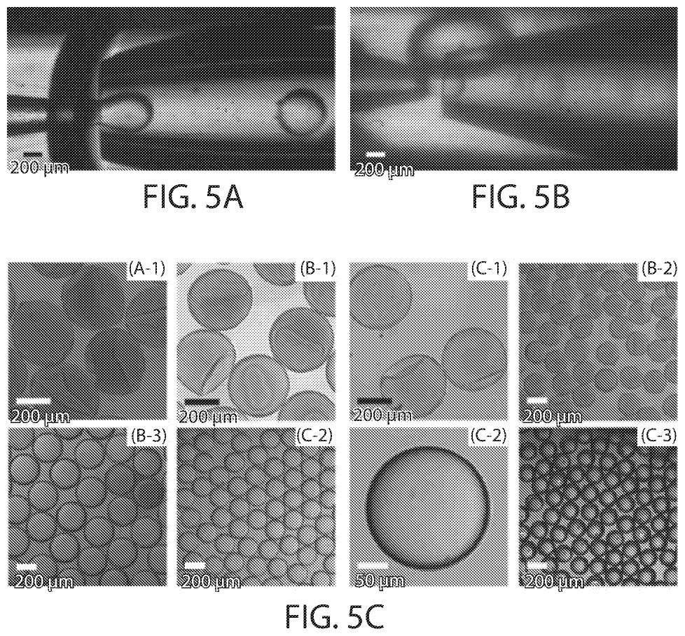

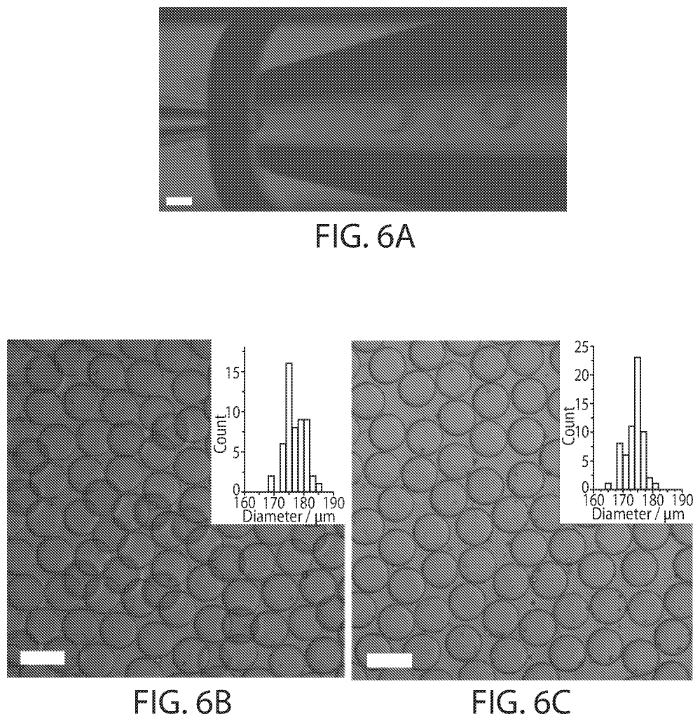

Two different types of monomers and polymerization chemistries were used in this example; multifunctional thiol and vinyl monomers for thiol-ene step-growth polymerization, and methacrylates for free radical polymerization. For the thiol-ene poly(anhydride) materials the tetrafuncitonal thiol pentaerythritol tetra(3-mercaptopropionate) (PETMP) was cross-linked with the difunctional ene-monomers pentenoic anhydride and tri(ethylene glycol) divinyl ether as the permanent cross-linker. Different ratios between the anhydride and the permanent cross-linker were prepared. Methacrylic anhydride was copolymerized with ethylene glycol dimethacrylate as the permanent cross-linker in the methacrylic system, again with various anhydride to cross-linker ratios. Chemical structures of the here used monomers and resulting polymer networks are shown in FIG. 4. Microscopy images of the double emulsion drop formation are shown in FIGS. 5A-5B for thiol-ene-based and in FIG. 6A for the methacrylate-based poly(anhydride) microcapsules.

The monomer shell phase of the double emulsion drops was polymerized at the outlet of the device with UV irradiation and the thus prepared cross-linked poly(anhydride) microcapsules were collected in excess outer aqueous phase.

Interestingly, the thin-shell microcapsules derived from the thiol-ene monomeric mixtures showed buckling upon polymerization, suggesting an increase of shell volume from the monomeric to the polymer state or a decrease of the core volume by water diffusion into the shell. The thick-shell thiol-ene and methacrylate microcapsules did not show this behavior. A variety of cross-linked poly(anhydride) microcapsules with diameters between 150 and 400 micrometers were fabricated with low size dispersity.

Microscopy images of fabricated thiol-ene microcapsules are shown in FIGS. 5A-5C and their fabrication conditions are summarized Table 1. Microscopy images of fabricated methacrylate microcapsules are shown in FIGS. 6A-6C and their fabrication conditions are summarized Table 2.

Acid anhydrides (also referred to as anhydrides) are generally labile towards hydrolysis into the respective acids. The hydrolysis rates of anhydrides depends on environmental conditions such as pH and temperature. In polymeric anhydrides, the hydrolysis additionally depends on factors such as the polymer network composition and hydrophilicity.

Fluorescent confocal laser microscopy was used to assess hydrolysis of the poly(anhydride) microcapsule shells. Sulforhodamine B as a hydrophilic fluorescent probe was added to the inner or outer aqueous phase and its permeation out of or into the capsule was monitored over time. The hydrophobic poly(anhydride) shells are impermeable to sulforhodamine B, while the hydrolyzed poly(acid) shells are permeable.

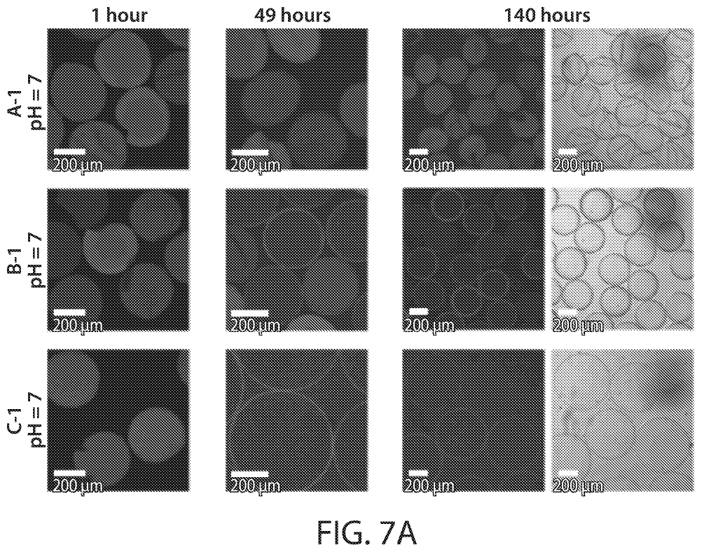

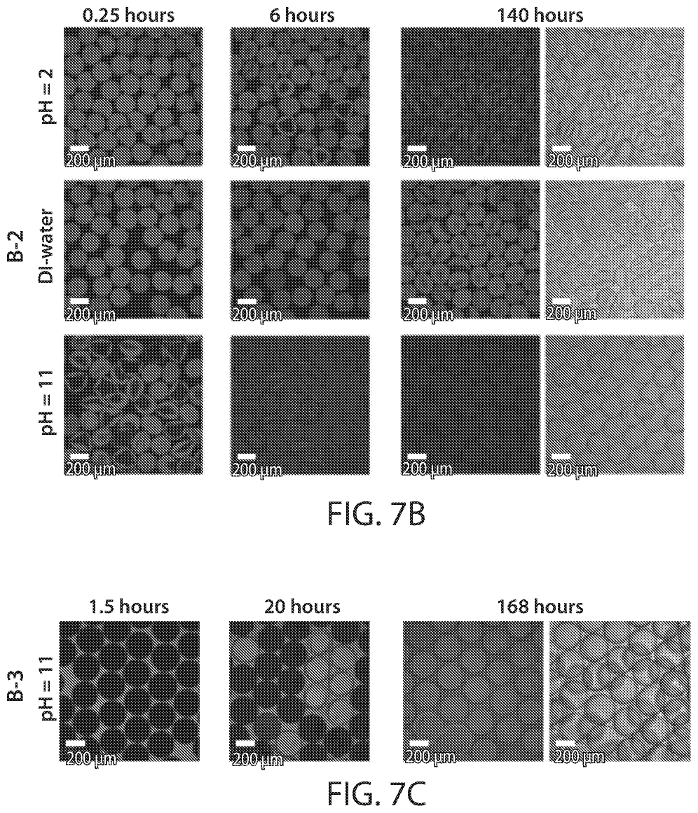

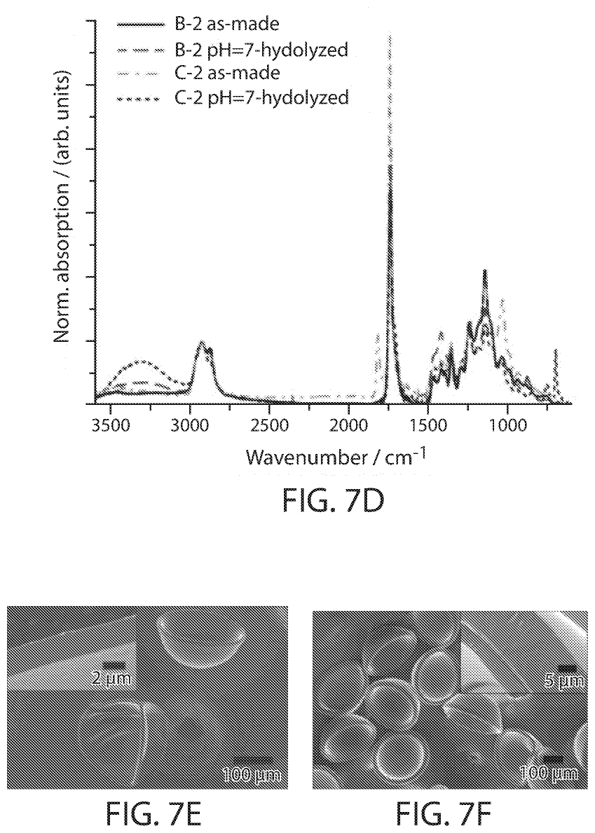

During hydrolysis of the poly(anhydride) shells, the microcapsules with high content of anhydride monomers hydrolyzed the fastest. For thin thiol-ene poly(anhydride) microcapsules in PBS buffer at pH=7, all microcapsules with 60 mol % anhydride released the sulforhodamine B and grew significantly in size within 2 days, while only part of the capsules with 33.3 mol % and none of the capsules with 14.3 mol % anhydride had hydrolyzed at that point. After 6 days, capsules with all compositions had released sulforhodamine B, indicating that the hydrolysis rate is faster with higher contents of anhydride and lower density of the permanent cross-linker. The large concentration of acidic groups and the low cross-link density of the hydrolyzed hydrogels also account for the size increase of the microcapsules due to significant water uptake and swelling of the shell. Fluorescent confocal laser micrographs of the thin-shelled thiol-ene capsules with different compositions in PBS buffer at different times are shown in FIG. 7A together with bright field light microscopy images of the hydrolyzed hydrogel microcapsules.

Another environmental condition that influenced the hydrolysis of the poly(anhydride) microcapsules and the release of cargo molecules was the pH value. Hydrolysis experiments as described above were performed in buffer solutions at pH values of 2, 7, and 11, as well as in DI-water with a pH of around 5, similar to the pKa of the corresponding acid. At a pH of 11, all capsules with 33.3 mol % anhydride monomers were hydrolyzed within 6 hours, compared to over 49 hours for pH=7 and over 5 days for pH=2. The slowest hydrolysis was observed for thiol-ene poly(anhydride) capsules dispersed in DI-water. Fluorescent confocal laser micrographs of the thin-shelled thiol-ene poly(anhydride) capsules with 33.3 mol % anhydride monomers at different pH values and times are shown in FIG. 7B together with bright field light microscopy images of the hydrolyzed hydrogel microcapsules.

The shell thickness of the poly(anhydride) microcapsules influenced the time of release as well, since more material had to hydrolyze before permeation of hydrophilic molecules could take place. After 20 hours only half of the thick-shelled thiol-ene microcapsules with 33.3 mol % anhydride monomers were permeated by sulforhodamine B at a pH of 11, while for thin-shelled capsules with the same shell composition permeation of all capsules was observed after 6, as is shown in FIGS. 7B-7C.

The hydrolysis of the capsules was confirmed using ATR FT-IR spectroscopy. After hydrolysis, a broad band between 3000 and 3500 cm⁻¹ appear, originating from the OH stretching of the carboxylic acid groups introduced through the hydrolysis of the anhydrides. The OH-stretching band was larger for microcapsules with higher acid content, as expected. ATR FT-IR absorption spectra from before and after hydrolysis for selected thiol-ene microcapsules are plotted in FIG. 7D.

The shell thickness of dried thin-shelled hydrogel microcapsules after hydrolysis was around 2-3 micrometers measured by scanning electron microscopy. Thick-shelled microcapsules exhibited slight asymmetry of the aqueous core within the microcapsule, most likely due to the density mismatch between the monomer shell phase and the water core phase in the double emulsion drops before photo-polymerization that lead to a heterogeneous shell thickness. The thick-shelled thiol-ene capsules obtained from 33.3 mol % anhydride monomer, for example, exhibited a shell thickness of around 15 micrometers on the thicker side and 4-5 micrometers on the thinner side. Scanning electron micrographs of hydrolyzed thiol-ene hydrogel microcapsules obtained from thin- and thick-shelled double emulsion drops with 33.3 mol % anhydride monomer are shown in FIGS. 7E and 7F, respectively. Note that the inset of FIG. 7F shows the cross-section of the thinner and thicker side of the thick-shelled hydrogel microcapsule shell sticking together, as the microcapsules deflate and buckle upon drying with the thinner side inverting its curvature.

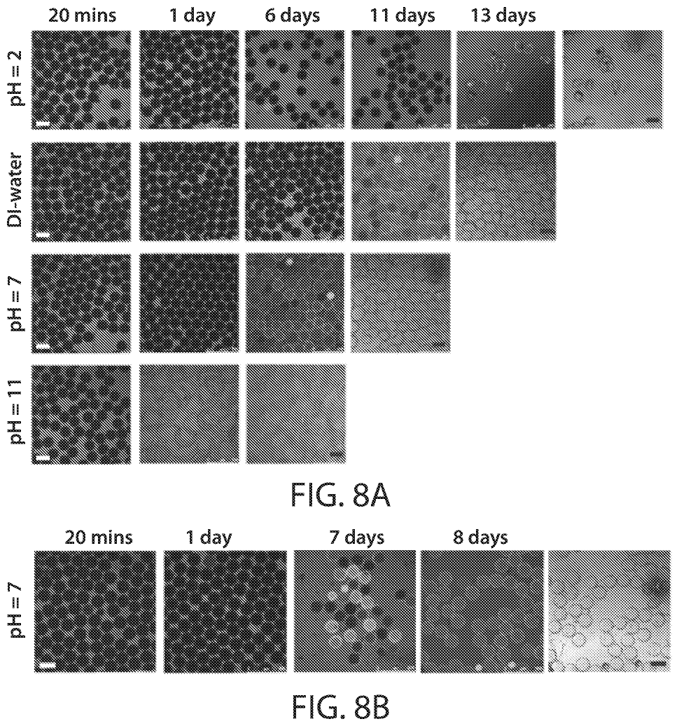

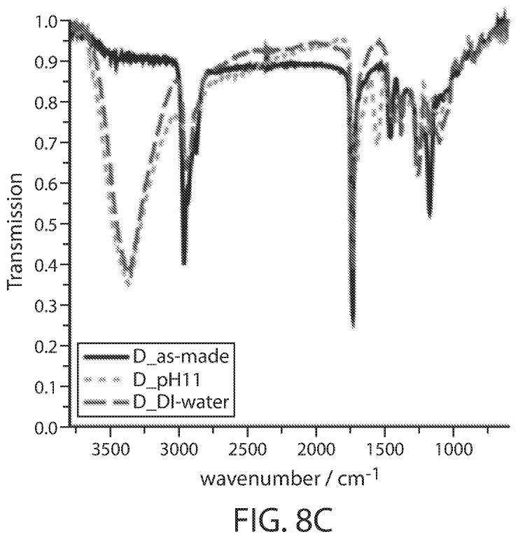

For methacrylic poly(anhydride) capsules, a similar hydrolysis trend was observed. Poly(methacrylic anhydride-co-ethylene glycol dimethacrylate) (P(MAAn-EGMDA)) microcapsules hydrolyzed fastest in pH environments above the pKa of poly(methacrylic acid) with higher rates observed at higher pH values. Capsules with a MAAn-to-EGMDA ratio of 24.5 are fully hydrolyzed after 1 day at a pH of 11, while it took 6 and 11 days for full hydrolysis in PBS buffer (pH=7) and DI-water (pH=5), respectively. Hydrolysis under low pH conditions was the slowest, requiring 13 days at a pH of 2. With lower content of anhydride monomer, at a MAAn-to-EGMDA ratio of 4.5, full hydrolysis took 8 days in PBS buffer. Fluorescent confocal laser micrographs probing the permeation of sulforhodamine B into the capsules as an indicator for hydrolysis at different time points are shown in FIGS. 8A-8B.

The hydrolysis of the P(MAAn-EGDMA) capsules to poly(methacrylic acid-co-ethylene glycol dimethacrylate) (P(MAA-EGDMA)) was confirmed using ATR FT-IR spectroscopy. After hydrolysis a broad band between 3000 and 3500 cm⁻¹ appeared originating from the OH stretching of the carboxylic acid groups introduced through the hydrolysis of the anhydrides. ATR FT-IR absorption spectra from before and after hydrolysis for selected P(MAAn-EGDMA) microcapsules are plotted in FIG. 8C.

Upon hydrolysis the anhydride cross-links of the polymeric networks split and converted to two carboxylic acid units. The structural integrity of the resulting poly(acid) networks was ensured with the use of non-hydrolyzable, relatively permanent cross-linking monomers such as triethylenglycol divinylether in the case of the thiol-ene capsules, and ethylene glycol dimethacrylate in the case of the methacrylate microcapsules. The carboxylic acid units rendered the polymer networks that constituted the shell and their properties responsive to external stimuli such as pH and ionic species. Under alkaline conditions, the carboxylic acids were deprotonated, leading to charged hydrogel networks that swelled with water, increasingly with higher pH. The swelling of the hydrogel shell caused an increase in microcapsule size at high pH. The swelling and associated size increase was larger for capsules with lower cross-link density and higher acid content.

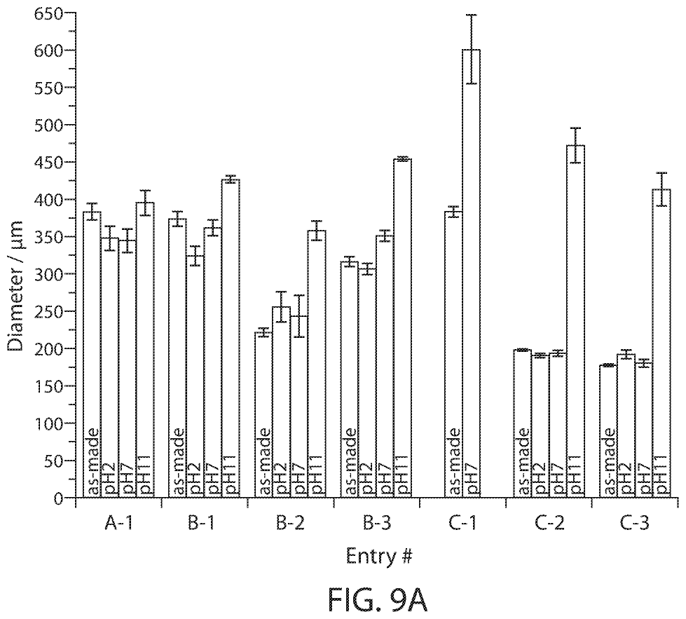

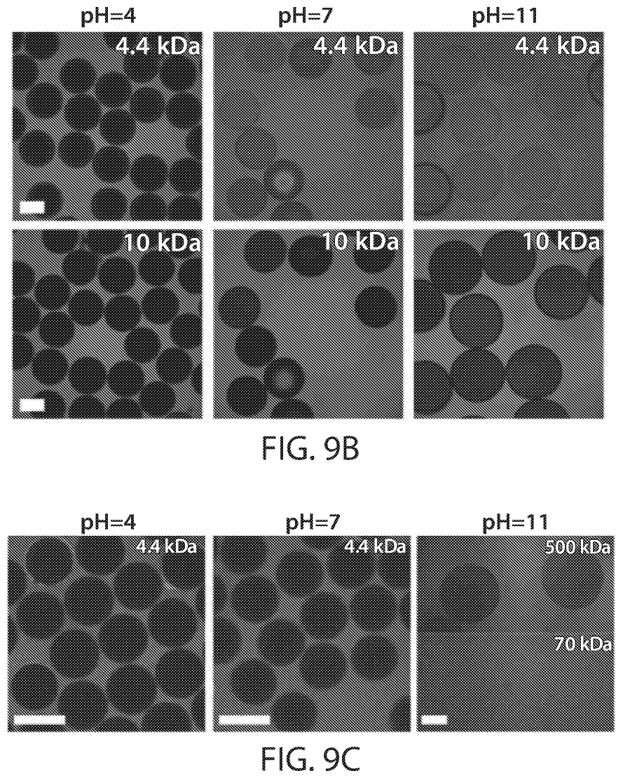

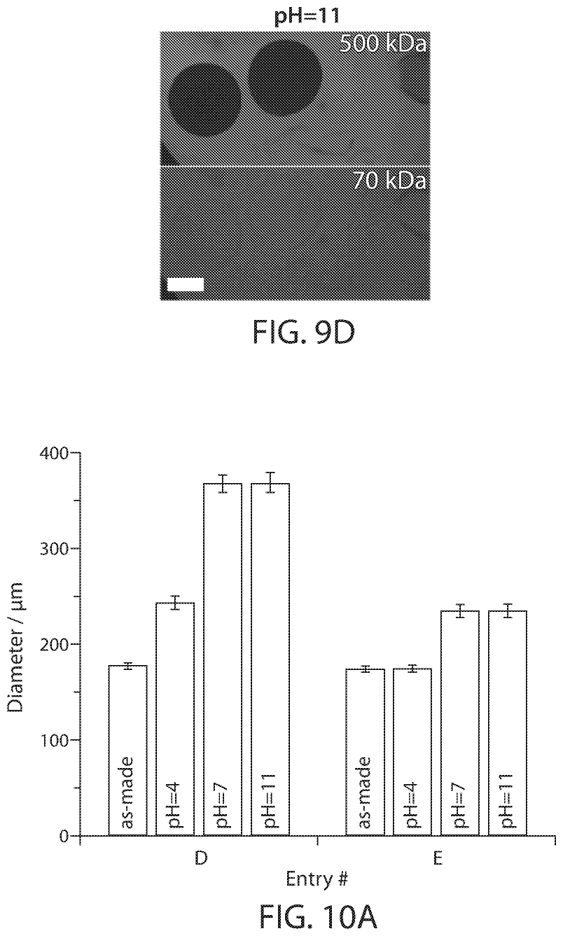

Thick-shelled thiol-ene poly(pentenoic acid) capsules with low cross-link density (entry C-2 in Table 1) exhibited a diameter of 193 micrometers and 472 micrometers at a pH of 7 and 11, respectively, a difference of 130%. Thick-shelled thiol-ene poly(pentenoic acid) capsules with medium cross-link density (entry B-3 in Table 1) exhibited a diameter of 350 micrometers and 453 micrometers at a pH of 7 and 11, respectively, a difference of 29%. The poly(pentenoic acid) microcapsules did not show significant size differences at pHs of 7 and below, indicating a relatively high pKa value of the poly(acid) networks, similar to long chain carboxylic acids such as fatty acids. Diameters of prepared thiol-ene poly(pentenoic anhydride) and poly(pentenoic acid) microcapsules in various pH environments are shown in FIG. 9A.

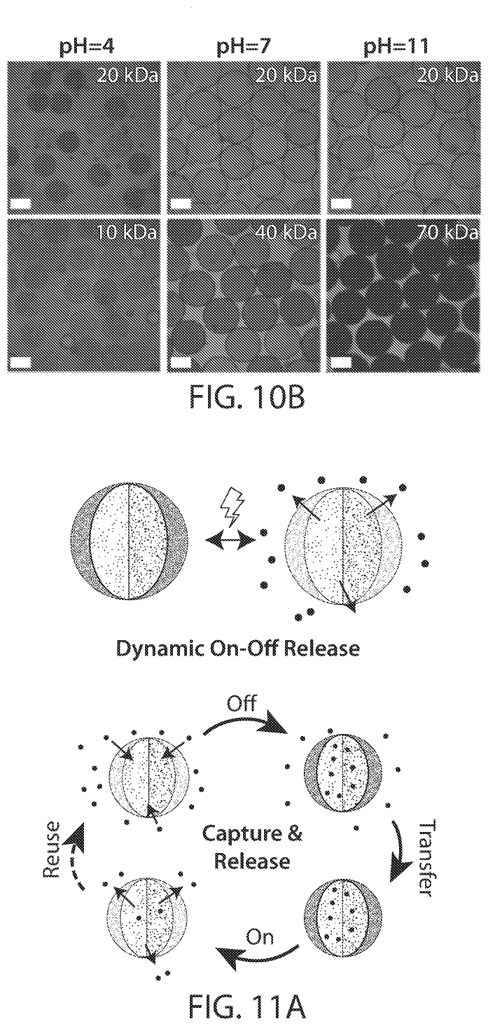

P(MAA-EGDMA) microcapsules containing poly(methacrylic acid) with a pKa of around 5.5 demonstrated full water swelling at a pH of 7 without further swelling at higher pH. P(MAA-EGDMA) hydrogel microcapsules with a MAA-to-EGDMA ratio of 49 (entry D in Table 2) exhibited diameters of 243 micrometers and 367 micrometers at pHs of 4 and 7, respectively, a difference of 51%. At a MAA-to-EGDMA ratio of 9 (entry E in Table 2), the hydrogel microcapsules exhibited diameters of 174 micrometers and 234 micrometers at pHs of 4 and 7, respectively, a difference of 34%. Diameters of prepared poly(methacrylic anhydride) and poly(methacrylic acid) microcapsules in various pH environments are shown in FIG. 10A.

The degrees of swelling depending on the pH of the environment was accompanied with different permeabilities and molecular weight cut-offs of permeates that can diffuse through the hydrogel microcapsule shell. Thiol-ene poly(pentenoic acid) capsules with medium and low cross-link density (entries B and C in Table 1) were not permeable to fluorescently labeled dextran with molecular weights as low as 4.4 kDa at low pH. Under alkaline conditions dextran with molecular weights of 4.4 kDa and 70 kDa were able to permeate into the thiol-ene hydrogel capsules through the water-swollen shells for medium (entries B in Table 1) and for low (entries C in Table 1) cross-link density, respectively. Even at high pH dextran with molecular weight of 10 kDa and 500 kDa did not permeate through the shells with medium (entries B in Table 1) and low (entries C in Table 1) cross-link density, respectively. Fluorescent confocal laser micrographs of selected thiol-ene poly(pentenoic acid) hydrogel capsules challenged with fluorescently labeled dextrans of various molecular weights at pHs of 4, 7, and 11 are shown in FIGS. 9B-9C, demonstrating the composition and pH-dependent permeability of macromolecules with different sizes.

P(MAA-EGDMA) hydrogel capsules with 2% cross-linker (entry D in table 2) showed only partial or no permeability to dextrans with molecular weights of 20 kDa or above in acidic environments (pH=4), full permeability to dextrans with molecular weights of 20 kDa and below at pHs of 7 or higher, and no permeability to dextrans with molecular weights of 70 kDa at any measured pH. Fluorescent confocal laser micrographs of P(MAA-EGDMA) hydrogel capsules with 2% cross-linker challenged with fluorescently labeled dextrans of various molecular weights at pHs of 4, 7, and 11 are shown in FIG. 10B, demonstrating the pH-dependent permeability of macromolecules with different sizes.

The pH-dependent swelling and deswelling of the cross-linked poly(acid) microcapsules was reversible and allowed for the dynamic and successive change of permeability and molecular weight cut-off. Of the fabricated poly(acid) hydrogel microcapsules, only thiol-ene poly(pentenoic acid) hydrogel capsules with low cross-link density (entries C in table 1) were partially unstable when stored under buffered conditions or during fast pH changes. All other capsules can undergo pH-changes and repeated swelling and deswelling without measurable degradation within a window of pH=2 to pH=11. At pH levels of 13 or higher, the thiol-ene hydrogel capsules undergo irreversible shape changes most likely due to the hydrolysis of the thio-ether linkages within the thiol-ene network.

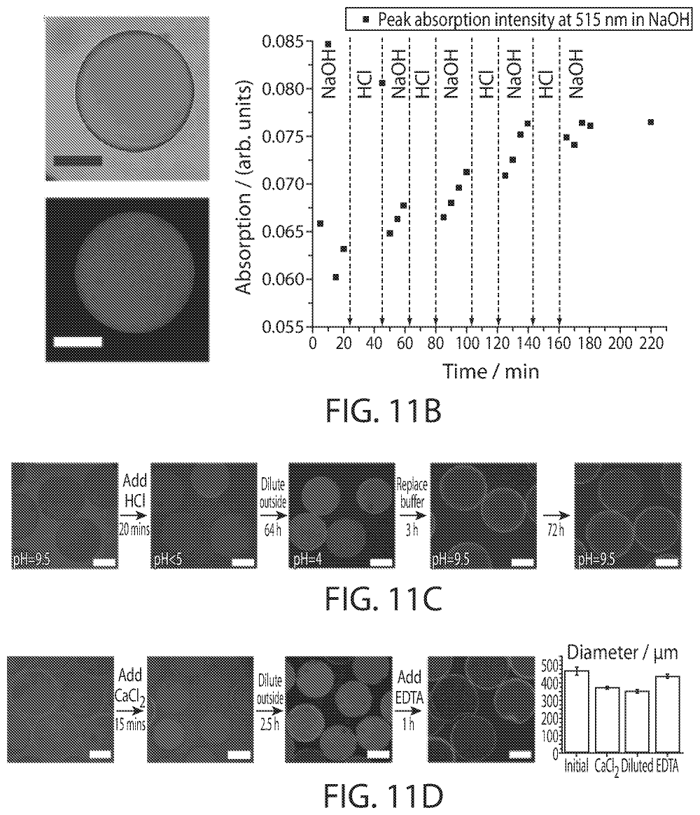

The reversible swelling and permeability changes were utilized for step-wise on-demand cargo release controlled by pH. Thiol-ene poly(pentenoic acid) hydrogel capsules with medium cross-link density (entry B-2 in Table 1) were soaked in TRITC-labeled dextran with a molecular weight of 4.4 kDa (10 mg/mL) in borate buffer (pH=9.5). After acidification of the solution to a pH of below 4, the TRITC-dextran loaded capsules were washed 5 times with DI water to remove excess dye in the outer aqueous phase. The capsules retained the TRITC-dextran-4.4 kDa for multiple days without release. The dye-dextran conjugate was released step-wise by alternating the pH between 9 and 3 every 20 mins using sodium hydroxide (NaOH) and hydrochloric acid (HCl) solutions, respectively. The change in pH leads to a continued on and off switching of the permeability and with that the release of the dye-dextran conjugate. Absorption spectra of the supernatant were taken every 5 mins, showing the continued increase of absorption in the supernatant due to the increase of released TRITC under alkaline conditions, and virtually no increase during acidic periods. Confocal laser microscopy images of a loaded capsule before step-wise pH-triggered release is shown in FIG. 11B, together with the plotted peak absorption of TRITC at 515 nm of the supernatant during alkaline conditions. The repeated and reversible on and off switching of the permeability will allow these capsules to deliver cargo “on-demand” or self-adjusted, only releasing during periods of high pH, and with stoppage of release during low pH conditions.

The dynamic response of the poly(acid) hydrogel microcapsules was not limited to pH changes, but also applicable to multi-valent ions such as calcium and ethylenediamine tetraacetate (EDTA) that enabled reversible deswelling and swelling due to ionic cross-linking and competitive complexing, respectively. These triggers could be used to capture and release cargo under swelling conditions, while trapping it in deswelling environments such as low pH and the presence of multi-valent cations. Capture-trap-release cycles of TRITC-dextran-4.4 kDa using pH- or calcium/EDTA control on thiol-ene poly(pentenoic acid) hydrogel capsules with medium cross-link density (entries B in Table 1) demonstrate this capability. For the pH-controlled cycle, thin-shelled thiol-ene hydrogel microcapsules (B-1 in Table 1) were soaked in borate buffer (pH=9.5) with TRITC-dextran-4.4 kDa. After loading of the capsules, the supernatant was acidified with HCl to trap the dye-dextran conjugate on the inside. After 20 mins in acidic environment, the supernatant was replaced by pH=4 buffer solution twice to remove external dye. The capsules showed no release of the dye-dextran conjugate over 64 hours, but released most of it over 3 hours when the supernatant was again replaced by pH=11 buffer solution. Fluorescent confocal laser micrographs of these steps are shown in FIG. 11C. A similar cycle on thick-shelled thiol-ene hydrogel microcapsules (B-3 in Table 1) was performed using glycine buffered (pH=9.5) calcium chloride (CaCl₂) and sodium-EDTA solutions instead of acidic and basic solutions, respectively. The divalent calcium ions lead to ionic cross-links of the polyanionic polymer network, causing deswelling and lowered permeability even in alkaline conditions. EDTA competitively complexes calcium ions and removes these physical cross-links from the hydrogel network when added to the solution, causing swelling of the hydrogel shells and release of the previously loaded and trapped TRITC-dextran-4.4 kDa. Fluorescent confocal laser micrographs of these steps are shown in FIG. 11D together with an average size of the hydrogel microcapsules at each step of the cycle. The reversibility of the steps discussed above would allow the reuse of the poly(acid) hydrogel microcapsules to perform these tasks over multiple capture-trap-release cycles for purification, separation, or as recyclable delivery vehicles.

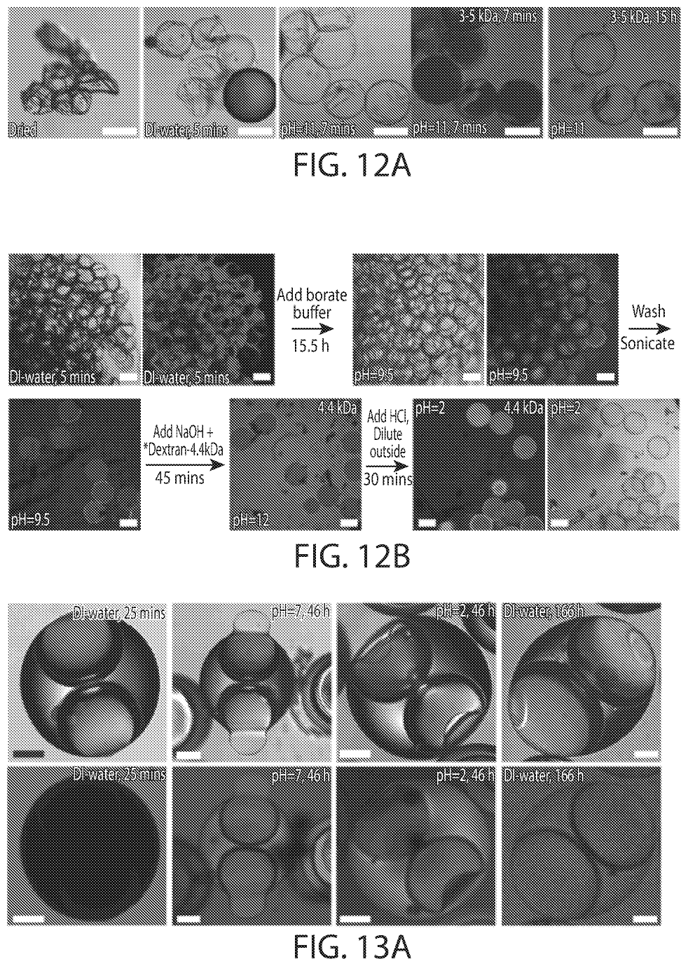

The thiol-ene poly(pentenoic anhydride) and poly(pentenoic acid) capsules were stable enough to be dried in vacuum and redispersed without destruction of the shell integrity. During drying, the capsules deflate and collapse, but reswelled and regained their properties when redispersed in aqueous environments. Already hydrolyzed capsules reswelled in water immediately after redispersing due to the shell's hydrophilicity. The capsules almost fully regained their initial spherical shape when exposed to alkaline conditions. Freshly reswollen hydrolyzed thiol-ene hydrogel microcapsules (B-2 in Table 1) were exposed to FITC-dextran (molecular weight of 3-5 kDa) at a pH of 11. Over the first minutes no permeation of the dye was observed, demonstrating that no larger defects such as tears or holes were caused by the drying and subsequent redispersion. Over 15 h, however, the dye-dextran conjugate permeated into the capsules. Bright-field and fluorescent confocal laser micrographs of these steps are shown in FIG. 12A. The same thiol-ene hydrogel microcapsules dried prior to hydrolysis immediately after fabrication also retained their functionality. The capsules were prepared with sulforhodamine B as a hydrophilic cargo molecule in the capsules core. The dried capsules showed bright fluorescence of the dye that did not disappear in DI-water due to the trapping of the dye on the inside of the hydrophobic poly(pentenoic anhydride capsules). The capsules were hydrolyzed in alkaline conditions (pH=9.5) and after 15 hours the sulforhodamine B cargo was released. The redispersed and hydrolyzed thiol-ene poly(pentenoic acid) hydrogel microcapsules were loaded with TRITC-dextran-4.4 kDa. A pH of 12 was necessary for permeation of the dye-polymer conjugate, which is slightly higher than the same capsules without drying after fabrication. The dye was successfully trapped after acidifying and replacing of the supernatant, demonstrating the same dynamic pH-response even for hydrogel microcapsules that underwent drying and redispersion before hydrolysis. Bright-field and fluorescent confocal laser micrographs of these steps are shown in FIG. 12B.

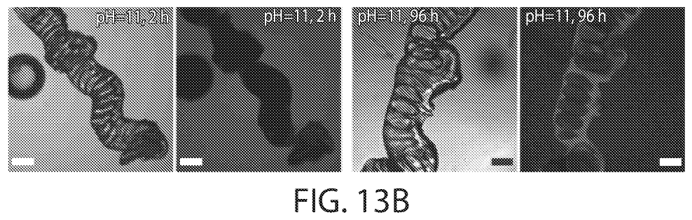

The microfluidic flow preparation of emulsions also enabled the fabrication of more complex microstructures. Double emulsion drops with two aqueous cores yielded thiol-ene poly(anhydride) microcapsules with two separate core compartments. The hydrolysis of these asymmetric structures leads to poly(pentenoic acid) hydrogel capsules with non-uniform architecture, shown in FIG. 13A. The microfluidic drop-making devices were also operated in jetting mode for the middle thiol-ene monomeric oil phase while the inner aqueous phase was dripping. The immediate UV exposure of this drops-in-jet emulsion yielded polymerized thiol-ene cross-linked poly(pentenoic anhydride) microfibers with separated aqueous compartments trapped on the inside. Hydrolysis of these fibers allowed for the permeation of sulforhodamine B into the inner aqueous compartments, as shown in FIG. 13B.

### Experimental Methods and Materials

Materials: The following thiol-ene and methacrylic monomers used for the synthesis of cross-linked poly(anhydride) and poly(acid) hydrogel microcapsules and other encapsulants were purchased from Sigma-Aldrich and used without further purification: Pentaerythritol tetrakis(3-mercaptopropionate) (PETMP, Sigma-Aldrich catalog no. 381462, MW=488.66 g mol⁻¹), tri(ethylene glycol) divinyl ether (TEGDVE, Sigma-Aldrich, MW=202.25 g mol⁻¹), 4-pentenoic anhydride (PA, Sigma-Aldrich catalog no. 471801, MW=182.22 g mol⁻¹), methacrylic anhydride (MAAn, Sigma-Aldrich catalog no. 276685, MW=154.16 g/mol), ethylene glycol dimethacrylate (EGDMA, Sigma-Aldrich catalog no. 335681, MW=198.22 g/mol). The surfactant poly(vinyl alcohol) (PVA, Sigma-Aldrich catalog no. 363170, Mw=13-23,000 g mol⁻¹, 87-89% hydrolyzed), the photoinitiator 2-hydroxy-2-methylpropiophenone (Sigma-Aldrich catalog no. 405655, MW=164.20 g/mol), n-octadecyltrimethoxyl silane (ODTS), fluorescein isothiocyanate-dextran and rhodamine isothiocyanate-dextran (fluorescent dye-polymer conjugates) with various molecular weights, and sulforhodamine B (red fluorescent dye) were purchased from Sigma-Aldrich and used without further purification. 2-[methoxy(polyethyleneoxy)propyl] trimethoxyl silane (PEG-silane) was purchased from Gelest. Distilled water (>18.2 megaohm m, Millipore) (DI water) were used to make all aqueous solutions for all experiments. BDH buffer solutions with pH of 2, 4, and 11 were purchased from VWR. Buffer solution with pH 9.5 was prepared by dissolving sodium tetraborate (Sigma-Aldrich catalog number S9640) in DI-water at 0.1 molar concentration. Phosphate-buffered saline (PBS buffer 1×, VWR catalog no. 45000-446) was used for most experiments with a pH of 7. Non-saline buffer solution with a pH of 7 was prepared dissolving sodium phosphate dibasic and monobasic in a molar ratio of 1.56:1 in DI-water with a total phosphate concentration of 0.02 molar. Sucrose (Sigma-Aldrich catalog no. S7903), gamma-cyclodextrin (γ-CD, TCI catalog number C0869), and potassium chloride (KCl, Sigma-Aldrich catalog no. P9541) were used for osmotic permeation tests. Hydrochloric acid (HCl, BDH catalog no. BDH7203-1) and sodium hydroxide (NaOH, Sigma-Aldrich catalog no. S5881) were used to make acidic and basic solution with concentrations of 0.1 to 1 molar for various tasks.

Fabrication of Microfluidic Glass-Capillary Device:

Round glass capillaries (World Precision Instruments) with inner and outer diameters of 0.58 mm and 1.00 mm, respectively, were tapered to a diameter of 40 micrometers with a micropipette puller (P-97, Sutter Instrument). For each device the tapered ends of two capillaries were hand-ground to final inner diameters of 50-80 micrometers and 100-200 micrometers for the so-called injection and outlet capillary, respectively. The tapered injection capillary's surface was hydrophobically modified by soaking in ODTS for more than 20 min and subsequent drying in compressed air flow. The tapered outlet capillary's surface was hydrophilically modified by soaking in PEG-silane for more than 20 min and subsequent drying in compressed air flow. The treated injection and outlet capillaries were inserted with the tapered end first into the opposite ends of a square capillary with an inner diameter (1.05 mm) slightly larger than that of the outer diameter of the round capillaries (1 mm). The square and round capillaries were fixed in position on a glass slide using epoxy with a distance between the tapered ends of 50-100 micrometers. The non-tapered ends of the injection and outlet capillaries were outside the square capillary. For so-called thin-shell double emulsion drops, a flame-pulled round capillary with a final diameter below 500 micrometers was additionally inserted into the injection capillary without further treatment. The non-tapered ends of the injection capillaries and the square capillaries were capped with blunt needles as tube connectors fixed and sealed with epoxy. The flow through the various capillary inlets was controlled using syringe pumps (Harvard Apparatus) with syringes connected to the blunt needles with medical polyethylene tubing (PE/5 from Scientific Commodities Inc.). The microfluidic capillary drop-making devices were operated on an inverted microscope (Leica) equipped with a high-speed camera (Phantom V9).

Fabrication of Microcapsules from Double Emulsion Drops:

The thiol-ene or methacrylic monomer mixtures with various ratios (as reported in Table 1 and 2) containing 1-2 mol % radical UV-initiator (2-hydroxy-2-methylpropiophenone) were used as the so-called oil-phase without any additional solvents unless stated otherwise in the fabrication of water-in-oil-in-water (W/O/W) double emulsions. For thin-shell double emulsion drops, the monomeric oil phase was injected through the injection capillary, while the inner and outer aqueous phases were injected through the innermost, flame-pulled injection capillary and the interstitial space between the outlet and the square capillary, respectively. For thick-shell double emulsions, the monomeric oil phase was injected through the interstitial space between the injection capillary and the square capillary, while the inner and outer aqueous phases were injected through the injection capillary and the interstitial space between the outlet and the square capillary, respectively. The inner and outer aqueous phases were comprised of 5 wt % PVA solutions in DI-water with optionally added cargo molecules in the inner aqueous phase such as fluorescent dyes. The monomeric oil phase was polymerized by UV exposure (Omnicure S1000) at the exit of the capillary device to produce the cross-linked poly(anhydride) encapsulants such as water-filled microcapsules. The microcapsules were collected in excess outer phase.

Characterization:

The optical and fluorescence confocal laser microscopy images of the microencapsulants were taken with a Leica TCS SP5 confocal laser scanning microscope, using a 10× dry objective with NA=0.3. Fourier Transform-Infrared (FT-IR) spectra were collected on a Bruker Lumos FTIR microscope with a liquid nitrogen cooled MCT detector using 16 scans in ATR mode with a single bounce Ge ATR crystal. The microcapsules were washed extensively (at least 4 times) with DI-water to remove PVA prior to drying and spectra acquisition. Scanning electron microscopy (SEM) images were taken on a Zeiss Ultra Plus Field Emission Scanning Electron Microscope (FE-SEM) using an acceleration voltage of 3 kV and an InLense detector. Microcapsules were dried on a double-sided conductive carbon tape and some were cut open for cross-sectional imaging. Prior to SEM imaging, the samples were sputter-coated with 2 nm Platinum-Palladium (80:20). Absorption spectra were obtained on a Cary 50 UV-Vis spectrophotometer (Aligent Technologies) at room temperature.

TABLE 1
Properties and conditions of fabricated
thiol-ene poly(anhydride) microcapsules.

| | Mol % | Mol % | | | |
|---|---|---|---|---|---|
| | pentenoic | pentanoic | | | |
| | anhydride in | acid in | | Flow rates | |
| | monomer | hydrolyzed | Shell- | (O-M-I)/ | Diameter/ |
| # | mixture | gel^{a} | type | mL/hr | μm |
| A | 14.3% | 25.0% | Thin | 12-0.4-1 | 382 ± 11 ^{b} |
| B-1 | 33.3% | 50.0% | Thin | 12-0.5-0.5 | 374 ± 10 ^{b} |
| B-2 | 33.3% | 50.0% | Thin | 15-0.8-0.6 | 221 ± 6 ^{b} |
| B-3 | 33.3% | 50.0% | Thick | 15-0.4-1.6 | 316 ± 7 ^{c} |
| C-1 | 60.0% | 75.0% | Thin | 12-0.4-1 | 383 ± 7 ^{b} |
| C-2 | 60.0% | 75.0% | Thick | 20-1-3 | 198 ± 2 ^{c} |
| C-3 | 60.0% | 75.0% | Thick | 20-2-1 | 178 ± 2 ^{c} |

^{a}Assuming full conversion.
^{b} Geometrical average +/− standard deviation measured from 2-D projection of at least 3 buckled capsules.
^{c} Geometrical average +/− standard deviation of over 25 capsules.

TABLE 2
Properties and conditions of fabricated polylmethacrylic anhydride-
co-ehhyleneglycol dimethacrylate) microcapsules.

| | Mol % | Mol % | | | |
|---|---|---|---|---|---|
| | methacrylic | methacrylic | | | |
| | anhydride in | acid in | | Flow rates | |
| | monomer | hydrolyzed | Shell- | (O-M-I)/ | Diameter^{b}/ |
| # | mixture | gel^{a} | type | mL/hr | μm |
| D | 96.1% | 98.0% | Thick | 25-0.25-1 | 177 ± 3 |
| E | 81.8% | 90.0% | Thick | 25-0.25-1 | 174 ± 3 |

^{a}Assuming full conversion.
^{b}Geometrical average +/− standard deviation of over 50 capsules.

### Example 2

Dynamic microcapsules are a highly sought-after class of encapsulant for advanced delivery applications with dynamically tunable release profiles, as actively manipulatable microreactors, or as selective microtraps for molecular separation and purification. Such dynamic microcapsules can be realized with a non-destructive trigger-response mechanism that changes the permeability of the shell membrane reversibly, as found in hydrogels. However, the direct synthesis of a trigger-responsive hydrogel membrane around a water drop without the use of sacrificial templates remains elusive, due to the incompatibility of the synthesis chemistry with aqueous emulsion processing. Here, a facile approach to fabricate reversibly responsive hydrogel microcapsules utilizing reactive anhydride chemistry is reported. Cross-linked and hydrophobic poly(methacrylic anhydride) microcapsules are obtained from microfluidic double emulsion drop templating that allows direct encapsulation of hydrophilic, water-suspended cargo within the aqueous core. Hydrolysis in aqueous environment yields microcapsules with a poly(acid) hydrogel shell that exhibit high mechanical and chemical stability for repeated cycling between its swollen and non-swollen states without rupture or fatigue. The permeability of the microcapsules is dependent on the degree of swelling and hence can be actively and dynamically modified, enabling repeated capture, trap, and release of aqueous cargo over numerous cycles.

Microcapsules with reversibly responsive shells that act as a gate-keeper would allow on-off release in which diffusion is turned off when the release trigger is reversed. The aqueous core of such dynamic capsule systems could be loaded numerous times with cargo substances making reuse and recycling of microcapsules over multiple cycles possible. Furthermore, dynamic microcapsules could act as a probe that selectively collects molecular substances from aqueous environments at predetermined conditions and trap them by shutting off its shell's permeability for subsequent examination, processing, or release, allowing new ways of molecular analysis and purification. A trigger-responsive mechanism that alters the shell's permeability reversibly and non-destructively would be useful to shut off diffusion at any time and hence interrupt release or uptake.

Here the synthesis of microcapsules containing a shell with reversibly tunable permeation that acts as a gate-keeper for controlled diffusion in and out of the aqueous core is reported. The membrane is comprised of a pH-responsive hydrogel that significantly and reversibly changes its permeability to macromolecular species upon changes in pH. To be able to synthesize a hydrogel membrane directly around a water core, anhydride chemistry is employed in combination with complex emulsion drop templating. The reversibly responsive hydrogel membrane allows diffusion in and out of the water droplet when swollen in neutral and alkaline conditions, while permeability can be slowed or shut off upon deswelling in acidic conditions. Significantly, the process may be reversible, allowing dynamic on- and off-switching of supply and release of molecular species in response to pH-changes over multiple cycles without sacrificing the structural integrity of the microcapsule.

Hydrophobic monomer mixtures of methacrylic anhydride (MAAn) and ethylene glycol dimethacrylate (EGDMA) containing either 96.1 or 81.8 mole percentage of MAAn are prepared, degassed, and combined with the radical photoinitiator 2-hydroxy-2-methylpropiophenone (Darocure 1173) at 1 mole percent. The monomer mixture is used as the shell phase in water-in-oil-in-water double emulsion drops without any solvent. Microcapsules are produced from double emulsion drops with an aqueous core containing 5 wt % poly(vinyl alcohol) (PVA, M_{w} 13,000-23,000, 98% hydrolyzed) as stabilizer. The drops are dispersed in an aqueous continuous phase also containing 5 wt % PVA. Water-in-oil-in-water double emulsions are fabricated using a glass capillary microfluidic device. See, e.g., FIGS. 1-3 The device uses two tapered cylindrical capillaries aligned inside a square capillary with inner dimensions slightly larger (1.05 mm) than that of the outer diameter of the cylindrical capillaries (1 mm). The injection capillary is rendered hydrophobic by treating it with octadecyltrimethoxysilane. The collection capillary is rendered hydrophilic by treating with 2-(methoxy-(polyethyleneoxy)propyl)trimethoxysilane. The inner aqueous phase is injected through the inside of the hydrophobically treated injection capillary, the middle shell phase is injected from the same direction through the interstitial space between the square capillary and the injection capillary, and the outer aqueous phase is injected from the opposite direction through the interstitial space between the square capillary and collection capillary. Drop formation in the glass capillary device is monitored with a fast camera (Phantom V9.0) equipped onto a Leica inverted optical microscope. Double emulsion drops are formed in the dripping regime at flow rates of 1000, 250, and 25,000 microliters hr⁻¹ for the inner, middle, and outer phases, respectively. The double emulsion drops are immediately irradiated with UV light (OmiCure S1500, 320-500 nm filter) to photopolymerize the shells at the end of the outlet capillary. The microcapsules are collected and washed with deionized water.

The poly(methacrylic anhydride-co-ethylene glycol dimethacrylate) microcapsules are hydrolyzed in various buffer solutions or in DI water. Microcapsule hydrolysis, permeability, and molecular weight cut-off (MWCO) of the poly(methacrylic acid-co-ethylene glycol dimethacrylate) hydrogel shells under various pH conditions are characterized using molecular permeation into the capsule interior of sulforhodamine B (0.1 mg mL⁻¹) or rhodamine- and fluorescein-conjugated dextrans (1 mg mL⁻¹) of known molecular weight (Sigma) in aqueous solution. Osmotic shock response is measured with 200 g L⁻¹ solutions of sucrose and γ-cyclodextrin (γ-CD or gamma-CD) that are added to aliquots of microcapsules in various buffer solutions. Swelling cycles of hydrogel microcapsules are performed by alternating exposure to 0.02 M acetate buffer (pH=4) and 0.02 M sodium phosphate buffer (pH=7), removing the supernatant before every new addition. Capture, trap, and release experiments are performed similarly with fluorescently labeled dextran added to the initial alkaline buffer. All buffers were BDH pH Reference Standard Buffers except for the osmotic shock and pH cycling experiments, which were prepared as 0.02 molar solutions at appropriate ratios of acetic acid and sodium hydroxide for pH 4, and sodium phosphate mono- and dibasic for pH 7.

Hydrolysis, dye-conjugate diffusion, time-resolved swelling cycles, and capture, trap, and release of the fluorescent probe are characterized and monitored with a laser confocal fluorescence microscope (Leica Microsystems TCS SP5) using 488 nm or 543 nm for the excitation and 490-520 nm or 560-620 nm for fluorescence detection of fluorescein- or rhodamine-containing fluorophores, respectively. For hydrolysis and permeability characterization, an aliquot of 30-40 microliters of the microcapsule dispersion containing around 60-100 capsules are transferred into wells of a 96-well plate and combined with 100 microliters of the respective buffer solutions. Subsequently, 20 microliters of the fluorophore solution or sugar solution is added to the well. Small aliquots of capsules for FT-IR characterization are washed four times with DI-water and dried under vacuum. Measurements are performed using a Bruker FT-IR microscope (Lumos) in attenuated total reflectance (ATR) mode. Scanning electron microscopy (SEM) samples are prepared the same way as for FT-IR and imaging is performed on a field emission scanning electron microscope (FESEM, Zeiss Supra55VP) equipped with an in-lens detector at an accelerating voltage of 3 kV.

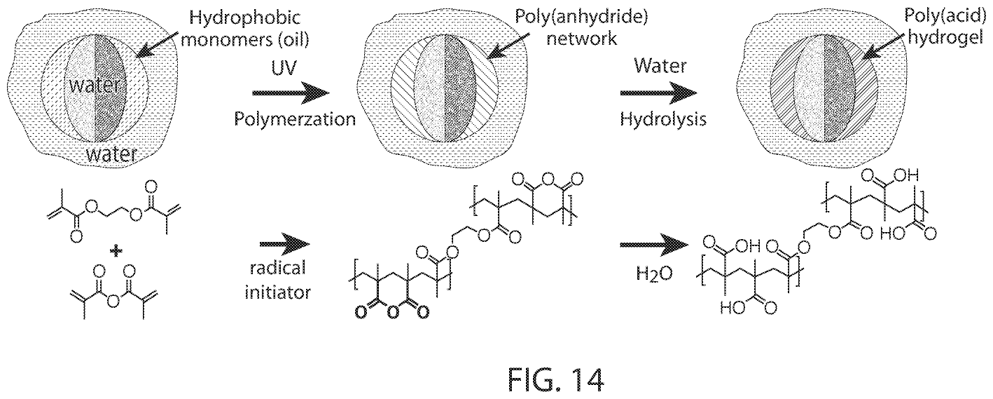

Water-immiscible methacrylic anhydride (MAAn) is employed as the source for the pH-responsive poly(methacrylic acid) hydrogel that is cross-linked with ethylene glycol dimethacrylate (EGDMA), as illustrated in FIG. 14. The copolymerization of MAAn and EGDMA as the shell phase in W/O/W double emulsion drops yields hydrophobic poly(methacrylic anhydride-co-ethylene glycol dimethacrylate) (P(MAAn-EGDMA)) microcapsules filled with and surrounded by water. Upon simple hydrolysis in their aqueous environment, each of the anhydride groups in the polymerized shell is converted into two methacrylic acid groups with a rate depending on pH and cross-link density, yielding an EGDMA-crosslinked poly(methacrylic acid) hydrogel shell. The polymerization of a W/O/W double emulsion drop to a hydrophobic polymer microcapsule and its conversion to a water-cored hydrogel microcapsule is illustrated in FIG. 14. The weak acidity of the cross-linked poly(methacrylic acid) hydrogel shells renders the microcapsules reversibly pH-responsive.

Water-in-oil-in-water double emulsion drops are fabricated using glass capillary microfluidics. See, e.g., Int. Pat. Apl. Pub. No. WO 2006/096571, incorporated herein by reference in its entirety. The microfluidic production of double emulsion drops allows the fabrication of microcapsules with control over structural features such as diameter and shell thickness combined with virtually quantitative encapsulation efficiency of active substances inside the aqueous core. The device uses two tapered cylindrical capillaries aligned inside a square capillary with dimensions slightly larger than that of the outer diameter of the cylindrical capillaries. To form double emulsions, the inner aqueous phase is injected through the hydrophobically treated injection capillary, while the middle shell phase consisting of the hydrophobic monomer mixture and a radical photoinitiator is injected from the same direction through the interstitial space between the square capillary and the injection capillary, as illustrated in FIG. 3. The outer aqueous phase is injected from the opposite direction, through the interstitial space between the square capillary and collection capillary. At the tip of the injection capillary, the inner phase and the surrounding middle monomer phase are hydrodynamically focused by the outer phase; the coaxial stream of fluids breaks up to form double emulsion drops, as shown in FIGS. 3 and 6A. Following formation, the double emulsion drops flow through the cylindrical collection capillary and are immediately irradiated with UV light to photopolymerize the shells. The poly(anhydride) microcapsules exhibit very low size dispersity of less than 2% deviation, as shown by the optical microscopy images in FIGS. 6B and 6C and summarized in Table 3.

Hydrophilic microcapsules with poly(acid) hydrogel shells are obtained through hydrolysis of the poly(anhydride) microcapsules. The poly(methacrylic anhydride-co-ethylene glycol dimethacrylate) shells are hydrolyzed under various pH conditions to study the effect of pH on the hydrolysis rate. During hydrolysis, the anhydride units of the polymerized microcapsule shell are cleaved to yield tethered carboxylic acid groups, increasing the hydrophilicity of the shell. The enhanced hydrophilicity of the shell membrane increases water content and allows the diffusion of hydrophilic dye molecules into the microcapsule core. The completion of hydrolysis of the poly(anhydride) network is indicated by the diffusion of the hydrophilic dye sulforhodamine B into the capsule interior, monitored by fluorescent confocal microscopy. The hydrolysis rate increases with the alkalinity of the aqueous medium, as shown in FIG. 8A. For microcapsules containing 3.9 mol % EGDMA cross-linker, the shells are fully hydrolyzed after 1 day at pH 11. For microcapsules at pH 7, hydrolysis takes longer, and microcapsules show fluorescent interiors only after 6 days. In more acidic environments, the time required for hydrolysis further increases to 11 and 13 days for microcapsules in DI-water and at pH 2, respectively, as shown in FIG. 8A. This trend is expected, given that at pH conditions below the pKₐ of poly(methacrylic acid), the hydrolyzed carboxylic acid groups are protonated, which lowers the hydrophilicity of the converting microcapsule shell, thus requiring longer for the conversion of the poly(anhydride) network to a poly(acid) network. Regardless of environmental pH conditions, microcapsules remain intact without degradation or rupturing of the shell. Hydrolysis of the poly(anhydride) capsules is further confirmed using Fourier transform infrared spectroscopy (FTIR). Hydrolyzed microcapsules show the presence of a broad, prominent absorption band at wavenumbers of 3000-3500 cm⁻¹ corresponding to the introduced hydroxyl groups. This OH-stretching band is absent in the poly(anhydride) microcapsules before hydrolysis, as shown in the ATR-FTIR spectra in FIG. 8C. Interestingly, the commonly observed absorption peak for poly(methacrylic anhydride) at 1800 cm⁻¹ is only present in the FT-IR spectrum of the microcapsules with 81.8% MAAn before hydrolysis. It is assumed that the faster hydrolysis rate of the microcapsules with higher anhydride content and lower cross-link density leads to partial hydrolysis of the surface layer of the polymer shells during the washing and drying before FTIR measurements, causing the disappearance of this peak for those capsules. The shell maintains its homogeneous structure following hydrolysis with a thickness of a few microns both before and after hydrolysis.

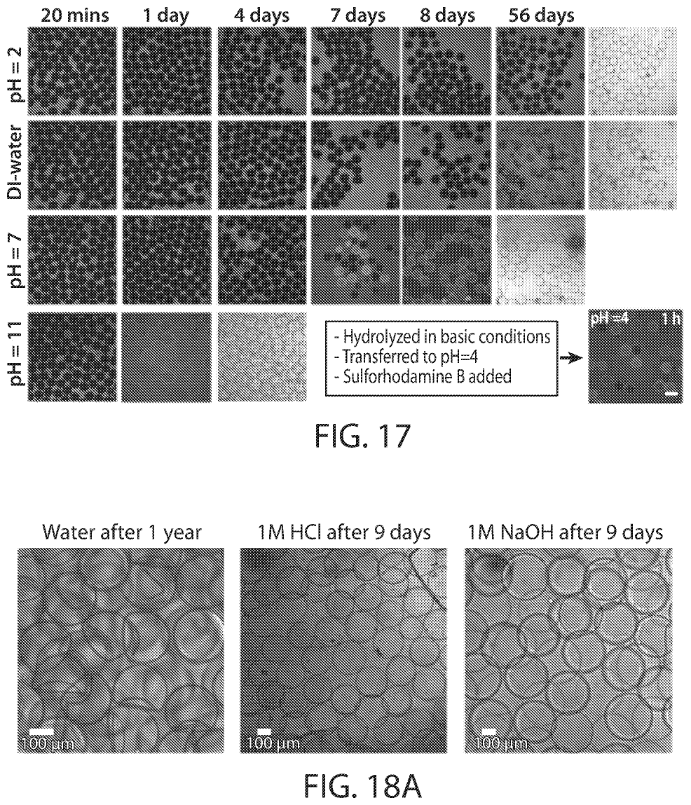

While the polymerized anhydride serves as the precursor to the stimuli-responsive poly(acid), the permanent crosslinker EGDMA ensures the structural integrity of the microcapsules during the hydrolysis process and determines the cross-link density of the dynamic hydrogel shell. Hydrolysis is slower for poly(anhydride) microcapsules with a higher cross-link density of 18.2 mol % EGDMA, but the effect of pH on the hydrolysis rate remains the same, as shown in FIG. 17. The higher concentration of EGDMA crosslinker in the shell leads to lower swelling capacity upon hydrolysis, which decreases the amount of water at the hydrolysis front and thus lowers its rate. While methacrylic anhydride can form a partially cross-linked polymer network by itself and microcapsules are obtained without the addition of the permanent cross-linker EGDMA, they completely dissolve upon hydrolysis, as expected for linear poly(methacrylic acid) macromolecules in aqueous environment. This observation additionally supports the assumption of full hydrolysis of all methacrylic anhydride units over time. The results demonstrate that the hydrolysis rate of the microcapsule shell is strongly dependent on the pH of the microcapsules' environment and the cross-link density of the shell. As such, tuning the molecular composition of the microcapsule shell provides a viable approach for controlling hydrolysis in a given environment, and consequently, release onset time.

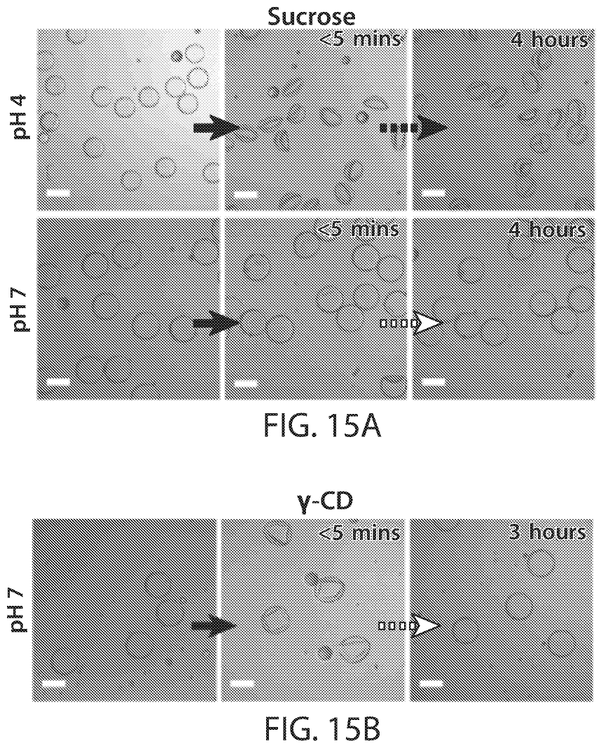

After hydrolysis of the anhydrides, the microcapsule shells are comprised of a cross-linked poly(methacrylic acid) hydrogel. The weak acidity of the methacrylic acid units renders the hydrogel microcapsules reversibly responsive to changes in pH. Above its pKₐ, the poly(acid) network is charged due to the deprotonation of the methacrylic acid, causing the hydrogel shells to swell significantly with water. At pH values below the pKₐ, protonation of the methacrylic acid groups causes hydrogen bonding within the uncharged polymer network, collapsing and deswelling the hydrogel shells. The pKₐ of poly(methacrylic acid) is around 6, with some dependence on the molecular and ionic environment. Hence, the degree of swelling of the hydrogel shell, and thus the size of the microcapsules, depends on the pH of the aqueous environment. Poly(methacrylic acid) microcapsules with 2 mol % cross-links have a diameter of 243+/−7 microns at pH 4, and grow to 367+/−9 and 368+/−11 microns upon pH increase to 7 and 11, respectively, as shown in FIGS. 10A-10B. The size difference between low and high pH corresponds to 51% in diameter and 240% in microcapsule volume. The degree of deprotonation well above the pKₐ of the poly(acid) network is very similar, causing the similarity in size between microcapsules in neutral and alkaline conditions. Despite the significant difference in size between various conditions, the size dispersity remains low, both in the swollen and non-swollen states. The increase in capsule size is not predominantly driven by an increase in shell thickness, but is caused by the in-plane expansion of the hydrogel shell due to the water swelling, significantly increasing the capsule's surface area. For example, in the thin shell limit, if the shell of a microcapsule with a diameter 180 micrometers and a shell thickness of 4 micrometers doubles in volume homogeneously in all directions, the shell thickness only increases by 1 micrometers, but the surface area of the microcapsule increases by 59%, leading to a microcapsule diameter change of 46 micrometers, similarly to what is observed for the microcapsules with 10% cross-link density. Thus, the core volume simply changes to accommodate the difference in capsule surface area imposed by the degree of swelling of the hydrogel shell. This is in stark contrast to microgels that swell homogenously throughout the entire hydrogel microparticle. The degree of swelling of the poly(acid) hydrogel shells impacts the microcapsules' permeability. The molecular weight cut-off (MWCO), the threshold weight of molecules that can diffuse through the shell, increases with higher degree of swelling. At pH 4, microcapsules with 2 mol % cross-linker exhibit permeability to dextran molecules with a molecular weight of 10 kg mol⁻¹, but are impermeable to 40 kg mol⁻¹ dextran. At pH 7, the same microcapsules are permeable to dextran with molecular weights up to 40 kg mol⁻¹, demonstrating the pH-dependent permeability and MWCO of the hydrogel microcapsules, as shown in the fluorescent confocal microscopy images in FIG. 17B. In the swollen state, the capsules are still impermeable to larger dextran of 70 kg mol⁻¹, indicating the structural integrity of the shells without defects or rupture. Higher cross-link density lowers the swelling capacity of hydrogels. Microcapsules with 10 mol % cross-links exhibit a diameter of 174+/−4 microns and 234+/−7 microns at pH 4 and 7, respectively, a 34% difference as summarized in FIG. 17A. The highly cross-linked microcapsules are impermeable to dextran with molecular weights down to 4 kg mol⁻¹ at any pH. Thus, to assess their permeability, these highly cross-linked hydrogel microcapsules are osmotically challenged with sucrose and γ-cyclodextrin (γ-CD) at pHs of 4 and 7. Increasing the concentration of a solute in the continuous phase increases its osmolarity, leading to water diffusion from the microcapsule core to the water phase outside the microcapsules. The egress of water from the microcapsule core causes the shells to buckle. If the solute is able to permeate through the shell into the core, the microcapsules unbuckle over time, as schematically shown in FIG. 15A. The lower the permeability of the shell to the solute, the longer it takes for the microcapsule to return to its spherical shape. The poly(methacrylic acid) microcapsules with 10 mol % cross-linker buckle significantly when sucrose is added to the continuous phase at pH 4 and remain buckled. At pH 7, these capsules only buckle slightly immediately after adding sucrose, but quickly return to the spherical shape, indicating good permeability of the shells to sucrose at pH 7, and low permeability at pH 4, as shown in FIG. 15A. γ-CD causes the capsules to buckle significantly upon its addition to the continuous aqueous phase at pH 7, but the microcapsules regain their spherical shape within hours, indicating permeability of the microcapsules to the larger sugar with a lower diffusion rate. Time-resolved optical microscopy images of the osmotic shock experiments demonstrating the pH-dependent permeability of the small sugar molecules are shown in FIGS. 15A-15B.

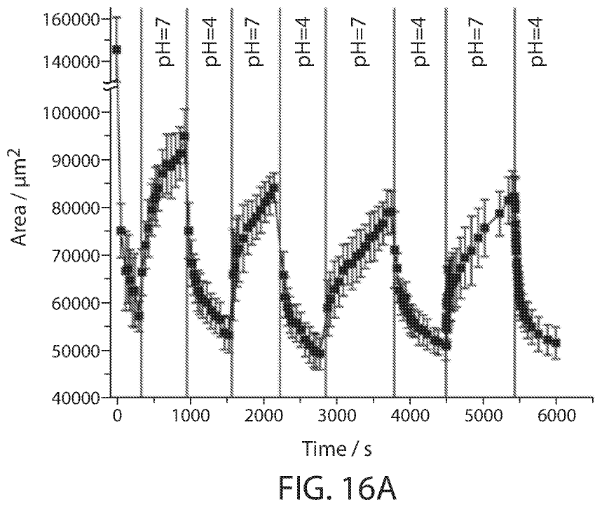

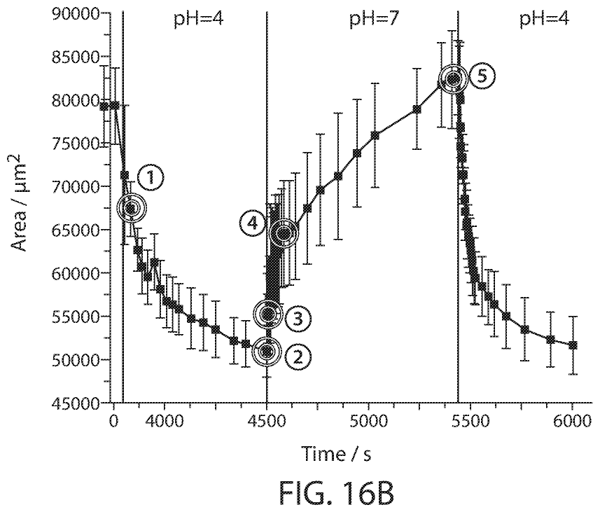

The pH-triggered change in size and permeability of the hydrogel microcapsules is repeatable, enabled by the reversible swelling mechanism through protonation. Thus, the microcapsules can be repeatedly cycled between their swollen and non-swollen states. These dynamic properties are investigated by measuring the size of the microcapsules with 2 mol % cross-linker under alternating pH conditions above and below the pKₐ of the poly(acid) network. The swelling and deswelling of the pH-responsive microcapsules is fast and reversible, with no sign of structural deterioration observed over five cycles, as shown in FIGS. 16A-16B. The capsule size, measured as projected area, changes exponentially after each pH switch over the course of minutes. The projected microcapsule area is not indicative of the shell size after the switch to pH=7 due to a change in shape during the swelling process: upon pH increase from 4 to 7, the shells swell predominantly in plane, leading to a significant increase of the microcapsules surface area. The diffusion of water through the shell into the core is too slow to accommodate this increased surface area immediately; this results in buckling of the microcapsules. Additionally, the capsules are not allowed to fully equilibrate their size after each trigger event in this demonstration. Hence, the response of the microcapsules depends on their swelling history and is not expected to be exactly the same in each cycle. The capsules become fully spherical again after approximately 15 mins when the core is filled with sufficient water volume, as shown in FIG. 16C.

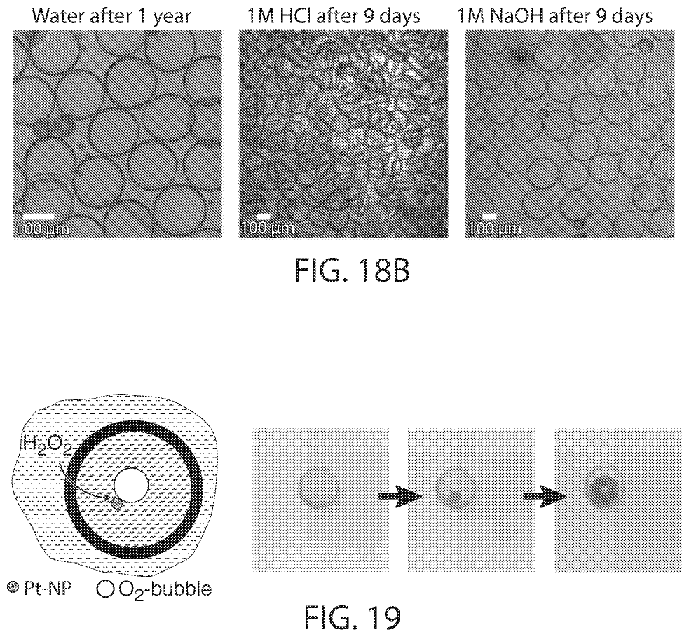

Deswelling of the microcapsules is initiated by a drop in pH to 4, below the pKₐ of the hydrogel shell. During this process, the cross-linked poly(methacrylic acid) hydrogel membrane is protonated yielding lower water-swelling capacity. The expulsion of water from the microcapsule shell causes its shrinking and accordingly a decrease of the microcapsule surface area that is accommodated by a reduction of core volume. The reduction of core volume proceeds by the diffusion of water through the deswollen shell, slowing down the decrease of microcapsule size. Significantly, the microcapsule shells do not rupture during this shrinking process, enabling repeated swelling and deswelling. Overall, no sign of structural failure or fatigue is observed during the cyclic swelling, buckling, and deswelling processes, suggesting suitable mechanical stability of the pH-responsive hydrogel microcapsules for their repeated utilization as dynamic microcarriers of liquid cargo. Furthermore, the dynamically responsive poly(acid) microcapsules exhibit good hydrolytic stability: after one year of storage in water at room temperature no degradation is observed, as shown in FIG. 18. Even in harsh conditions such as 1 molar hydrochloric acid and 1 molar sodium hydroxide the capsules show no sign of degradation over at least 9 days.

The dynamically tunable swelling and permeability of the pH-responsive microcapsules is utilized to capture, trap, and release appropriately sized molecular species. Microcapsules with 2 mol % cross-link density are permeable to dextran with a molecular weight of 20 kDa in the swollen state, but impermeable to the same molecule in acidic environment. When challenged with fluorescently labeled 20 kDa dextran in alkaline conditions, the microcapsules capture the probe molecule, as shown in the leftmost panel of FIG. 16D. Upon transfer to acidic medium with a pH of 4, the decrease of the MWCO causes the 20 kDa dextran to be trapped within the core of the microcapsules without observable leakage of the fluorescent probe into the surrounding continuous medium over 24 hours. Immediately upon pH increase and microcapsule swelling, the 20 kDa dextran is released from the pH-responsive microcapsules. Fluorescent confocal microscopy images at the respective stages of a capture-trap-release cycle of fluorescently labeled 20 kDa dextran are shown in FIG. 16D.

In this example, the successful synthesis of water-cored hydrogel microcapsules with reversible trigger-responsiveness without the use of sacrificial templates is demonstrated. Hydrophobic anhydride-containing monomers are employed as the shell of double emulsion drops for the direct microfluidic production of polymeric microcapsules, which subsequently convert to poly(methacrylic) hydrogel-shelled capsules with tunable conversion time. The template-free synthesis enables the direct encapsulation of large cargo such as catalyst particles in the aqueous core-compartment surrounded by a trigger-responsive hydrogel membrane, as shown in FIG. 19. The hydrogel microcapsules exhibit swelling and permeability dependent on cross-link density and pH conditions. Most importantly, the permeability and size of the microcapsules are dynamically tunable over multiple cycles by changing the pH around the microcapsules with retention of their structural integrity. The dynamically triggerable permeability changes allow the microcapsules to be employed as active delivery vehicles that can stop their release after initiation or that can be recycled, as well as repeatedly loaded. Hence, the dynamic microcapsules could be used as an injectable and self-adapting drug reservoir to release hydrophilic actives only in physiological conditions. Additionally, the reversibly responsive microcapsules can be utilized as collection microtraps to capture molecules selectively in neutral or alkaline conditions for subsequent analysis or processing, but not in acidic environments. Such a collection probe could capture molecules such as enzymes selectively from non-acidic areas within the intestinal tract, and block the uptake of molecules in the acidic stomach while passing through the digestive system.

TABLE 3
Parameters of poly(methacrylic anhydride-co-
ethyleneglycol dimethacrylate) microcapsules.

| | | Mol % | | |
|---|---|---|---|---|
| | Mol % | methacrylic | Flow rates | |
| | methacrylic | acid in | (O-M-I)/ | Diameter^{b}/ |
| # | anhydride | hydrogel^{a} | mL/hr | μm |
| A | 96.1% | 98.0% | 25-0.25-1 | 177 ± 3 |
| B | 81.8% | 90.0% | 25-0.25-1 | 174 ± 3 |

^{a}Assuming full conversion.
^{b}Geometrical average +/− standard deviation of over 50 capsules.

### Experimental Methods and Materials

Materials:

Methacrylic anhydride (94%, MAAn), ethylene glycol dimethacrylate (98%, EGDMA), poly(vinyl alcohol) (M_{w} 13,000-23,000, 98% hydrolyzed, PVA), 2-hydroxy-2-methylpropiophenone (Darocure 1173), acetic acid (glacial), sodium hydroxide (pellets), sodium phosphate monobasic (dihydrate), sodium phosphate dibasic (dodecahydrate), hydrogen peroxide, and octadecyltrimethoxysilane (technical grade, 90%, ODTS) were purchased from Sigma-Aldrich and used as received. The fluorescent probes sulforhodamine B, rhodamine isothiocyanate-dextran (RITC-dextran), and fluorescein isothiocyanate-dextran (FITC-dextran) of different molecular weights were purchased from Sigma-Aldrich and used as received. The hydrophilic silane 2-(methoxy-(polyethyleneoxy)propyl)trimethoxysilane was purchased from Gelest and used as received. All buffers were BDH pH Reference Standard Buffers except for the osmotic shock and pH cycling experiments, which were prepared as 0.02 molar solutions at appropriate ratios of acetic acid and sodium hydroxide for pH 4, and sodium phosphate mono- and dibasic for pH 7. Platinum nanoparticles (70 nm, sodium citrate surface coated in aqueous 4 mM sodium citrate) were purchased from nanoComposix at a concentration of 0.05 mg mL⁻¹.

Methods:

Hydrophobic methacrylic monomer mixtures are used as the shell phase in microfluidic double emulsion drop templating. Two monomer compositions are prepared with methacrylic anhydride (MAAn) and ethylene glycol dimethacrylate (EGDMA) at molecular ratios of either 96.1 or 81.8 mole percentage of MAAn, corresponding to 98 and 90 mole percentage of methacrylic acid in the fully hydrolyzed gel, as shown in Table 3. The monomer mixture for microcapsules with low cross-link density (corresponding to entry A in Table 3) is prepared by adding 0.1550 mL EGDMA to 3 mL of methacrylic anhydride. The monomer mixture for microcapsules with low cross-link density (corresponding to B in Table 3) is prepared by adding 0.5628 mL of EGDMA to 2 mL methacrylic anhydride. The radical photoinitiator 2-hydroxy-2-methylpropiophenone (Darocure 1173) is added at 1 mole percent to both monomer mixtures. The monomers are degassed by bubbling nitrogen through the mixtures for 15 minutes prior to use.

Microcapsules are produced from double emulsion templates with an aqueous core of 5 wt % poly(vinyl alcohol) (PVA, M_{w} 13,000-23,000, 98% hydrolyzed). The continuous phase also used 5 wt % PVA. Water-in-oil-in-water double emulsions are fabricated using a glass capillary microfluidic device, as shown in FIG. 3. The device used two tapered cylindrical capillaries aligned inside a square capillary with dimensions slightly larger than that of the outer diameter of the cylindrical capillaries. The injection capillary is rendered hydrophobic by treating it with octadecyltrimethoxysilane. To prevent the wetting of the shell of the double emulsion drops on the outlet channel walls, the collection capillary is rendered hydrophilic by treating with 2-(methoxy-(polyethyleneoxy)propyl)trimethoxysilane.

To form double emulsions, the inner aqueous phase is injected from the left through the hydrophobically treated injection capillary, while the middle shell phase is injected from the same direction through the interstitial space between the square capillary and the injection capillary. The outer aqueous phase is injected from the opposite direction, also through the interstitial space between the square capillary and collection capillary. Drop formation in the glass capillary device is monitored with a fast camera (Phantom V9.0) equipped onto a Leica inverted optical microscope. Double emulsion drops are formed in the dripping regime at flow rates of 1000, 250, and 25,000 microliters hr⁻¹ for the inner, middle, and outer phase, respectively. Following drop breakup, the double emulsion drops flow through the cylindrical collection capillary and are immediately irradiated with UV light (OmiCure S1500, 320-500 nm filter) to photopolymerize the shells. The microcapsules are collected in a vial containing DI water, and are exposed to the UV light for additional 2 minutes. The solidification of the microcapsule shells is confirmed by crushing a small sample of the microcapsules between two glass slides. The microcapsules are washed with deionized water at least four times to remove surfactants and unreacted material from the continuous phase, and are dispersed in deionized water.

To produce hydrophilic poly(acid) microcapsules from hydrophobic poly(anhydride) microcapsules, the poly(methacrylic anhydride-co-ethylene glycol dimethacrylate) microcapsules are hydrolyzed under various pH conditions. Small aliquots of microcapsules (˜20 microliters) are placed into 200 microliters buffer solutions of pH 2, 7, 11, or in DI water (pH ˜5) containing sulforhodamine B dye at equal concentrations. Hydrolyzed poly(methacrylic acid) hydrogel shells allow the diffusion of sulforhodamine B into the capsules aqueous core, while the unhydrolyzed poly(methacrylic anhydride) is impermeable to this probe molecule. Completion of the hydrolysis of the poly(anhydride) network is confirmed by observing the diffusion of sulforhodamine B dye into the capsule interior using a laser confocal fluorescent microscope (Leica Microsystems) over a period of several days.

Microcapsules for Fourier-transform infrared spectroscopy (FT-IR) and scanning electron microscopy (SEM) analysis are prepared by washing aliquots of microcapsules four times with DI water, and drying prior. FT-IR measurement are performed using a Bruker FT-IR microscope (Lumos) in attenuated total reflectance (ATR) mode. Dried microcapsules for SEM are cross-sectioned with a razor blade after depositing the microcapsules onto double sided adhesive conductive carbon tape. Prior to imaging, the SEM samples are sputter-coated with a thin layer (2 nm) of Platinum/Palladium (Pt/Pd 80:20) using a sputter coater (EMS 300T D Dual Head Sputter Coater). The microcapsules are imaged using a field emission scanning electron microscope (FESEM, Zeiss Supra55VP) equipped with an in-lens detector.

Microcapsule hydrolysis, permeability, and molecular weight cut-off (MWCO) of the hydrogel shells under various pH conditions are characterized using molecular permeation into the capsule interior. Microcapsules with low cross-link density (98 mol. % acid content following hydrolysis, entry A in Table 3) are tested using fluorescent dye-conjugated dextran of various molecular weights at concentrations of 1 mg/ml. To a well containing the microcapsules in 100 microliters of the respective buffer solution of desired pH, 20 microliters of the dye-dextran solution is added and incubated for at least 1 hour. For microcapsules with higher cross-link density (90 mol. % acid content following hydrolysis, entry B in Table 3), pH-dependent permeability changes are gauged using osmotic shock response with sugar molecules. Solutions of sucrose and γ-cyclodextrin (γ-CD) are prepared at concentrations of 200 g L⁻¹ and 20-40 microliters are added to aliquots of microcapsules in 100 microliters buffer solutions of pH 4, pH 7 (0.02 M phosphate buffer), and pH 11. During the hydrolysis and permeability experiments, the capsules are characterized and monitored with a laser confocal fluorescent microscope (Leica Microsystems) using 488 nm or 543 nm for the excitation and 490-520 nm or 560-620 nm for fluorescence detection of fluorescein- or rhodamine-containing fluorophores, respectively.

Cycling of microcapsules containing 98 mol % acid (entry A in Table 3) is performed in 200 microliter wells. Hydrolyzed microcapsules in around 20 microliters DI-water are exposed alternatingly to 200 microliters of 0.02 M acetate buffer (pH=4) and 0.02 M phosphate buffer (pH=7), removing excess supernatant before every new addition. Time-resolved bright field microscopy images are obtained on a laser confocal fluorescent microscope (Leica Microsystems). Size distributions are measured at respective time points shown in FIGS. 16A-16B as the projected area of at least 10 microcapsules.

Capture, trap, and release experiments are performed for microcapsules containing 98 mol % acid (entry A in Table 3). To capture the fluorescent cargo probe, microcapsules are placed into pH 11 buffer containing 20 kDa FITC-dextran. After the microcapsules are filled with the fluorescent probe, the supernatant is removed, and pH 4 buffer added containing 20 kDa FITC-dextran dye in the same concentration, followed by replacing the supernatant with pure pH 4 buffer several times and subsequently stored for 24 hours at room temperature. Release of the trapped cargo probe is achieved by placing the microcapsules in pH 11 buffer solution, whereupon the microcapsules swell and release the encapsulated 20 kDa dextran. The capture, trap, and release of the fluorescent probe is characterized and monitored using a laser confocal fluorescent microscope (Leica Microsystems).

Microcapsules with platinum nanoparticles in their aqueous core were prepared as described above with additional platinum nanopowder added to the inner aqueous PVA solution. The nanoparticle-bearing capsules are hydrolyzed at pH 11 and subsequently washed with DI-water. A few drops of hydrogen peroxide (30%) are added to the dispersion and the microcapsules are observed through an upright microscope.

Encapsulation of catalytic nanoparticles inside the aqueous core of poly(methacrylic acid) hydrogel microcapsules. The microfluidic synthesis of water-cored microcapsules using hydrophobic, shell-forming monomers allowed the direct encapsulation of aqueous cargo that is larger than the mesh size of the hydrogel shell. Poly(methacrylic anhydride) microcapsules loaded with 70 nm diameter platinum nanoparticles (Pt-NP, initial concentration 0.05 mg/mL) in their aqueous cores were prepared. The Pt-NPs are too large to diffuse through the shell even after hydrolysis of the shells to poly(methacrylic acid), but are accessible to reagents from the aqueous continuous phase that can permeate through the hydrophilic shell. When hydrogen peroxide is added to the dispersion of the platinum-loaded microcapsules in a mixture of water and propylene carbonate, the fuel permeates through the hydrogel shell and forms an oxygen bubble in the core of the capsule, as shown in FIG. 19.

### Example 3

Dynamic microcapsules are reported that exhibit shell membranes with fast and reversible changes in permeability in response to external stimuli. A hydrophobic anhydride monomer is employed in the thiol-ene polymerization as a disguised precursor for the acid containing shells; this allows the direct encapsulation of aqueous cargo in the liquid core using microfluidic fabrication of water-in-oil-in-water double emulsion drops. The (poly)anhydride shells hydrolyze in their aqueous environment without further chemical treatment, yielding cross-linked poly(acid) microcapsules that exhibit trigger-responsive and reversible property changes. The microcapsule shell can actively be switched numerous times between impermeable and permeable due to the exceptional mechanical properties of the thiol-ene network that prevent rupture or failure of the membrane, allowing it to withstand the mechanical stresses imposed on the capsule during the dynamic property changes. The permeability and molecular weight cut-off of the microcapsules can dynamically be controlled with triggers such as pH and ionic environment. The reversibly triggered changes in permeability of the shell exhibit a response time of seconds, enabling actively adjustable release profiles, as well as on-demand capture, trapping, and release of cargo molecules with molecular selectivity and fast on-off rates.

Encapsulation in microcapsules for the protection and delivery of active substances is widely employed in agriculture, cosmetics, drug delivery, detergents, and food additives, benefiting from the separation of the liquid cargo and solid encapsulant as well as high cargo content. Stimuli-responsive shell materials provide control over when cargo is released with triggers such as pH, shear, light, and temperature. Most microcapsules are unidirectional and single-use delivery vehicles, because of their irreversible and destructive release mechanisms through shell degradation or rupture; once release is initiated, it cannot be stopped or reversed. In many advanced applications, however, microcapsules would benefit from the ability to transiently release their cargo in response to changes in their environment but remain shut of otherwise, and to repeatedly cycle between these two states. For example, injectable therapeutic reservoirs that release drugs on-demand, such as insulin only under high glucose levels or anti-inflammatories when inflammation symptoms occur in the surrounding tissue, significantly decrease the number of drug injections needed for treatment. One way to achieve such injectable on-demand release systems is the use of dynamically responsive permeability, which is unattainable in common microcapsules due to their inability to reversibly and quickly adjust their shell's permeability to changes in stimuli. The ability to switch between permeable and impermeable states further allows the capture of molecular species from the surrounding medium and trap them inside the capsule core. For example, water treatment and purification could benefit from such passive microtraps for the removal of harmful molecular species. Commonly employed flat membranes require flux of the water through the membrane to remove molecular impurities, which is slow due to the small pore sizes needed. Microencapsulants that trap molecular impurities are easier to remove, since they are orders of magnitude larger than the target molecules. Microcapsules with dynamically tunable permeability dispersed in waste water could capture molecular species in their core when the shell is permeable, trap them by switching permeability off, and subsequently be removed together with the trapped molecular impurities by simple microfiltration. The development of microcapsules that rapidly and distinctly change their permeability requires shell materials that alter their physicochemical properties fast and without rupture under the inevitable resultant mechanical stresses; most microcapsules break when triggered to release or upon reversal of the trigger because of insufficient mechanical and chemical stability and, therefore, cannot be reloaded or used as an on-demand releasing reservoir. Dynamic responsiveness in microcapsules is highly desirable though, as it allows qualitatively new ways for their utilization and employment.

Here, the fabrication of robust microcapsules that exhibit a reversible, triggerable, non-destructive, and rapid transition between permeable and impermeable states is reported. The microfluidic fabrication of double emulsion drops for the direct encapsulation of aqueous drops in anhydride-containing monomer shells is employed. The anhydride serves as the hydrophobic acid precursor for the direct emulsion synthesis of a shell containing functional acid mojeties around a water core. The double emulsion drops are converted to poly(anhydride) microcapsules with a water core through thiol-ene polymerization. The poly(anhydride) shell hydrolyzes in its aqueous environment without additional chemical treatment, yielding cross-linked poly(acid) microcapsules, as illustrated in FIG. 4. The weak acidity of the thiol-ene shells with tethered carboxylic acids renders the microcapsules responsive to pH and ionic environment; they turn highly hydrophilic and permeable when swollen through deprotonation at high pH, and hydrophobic and impermeable when deswollen upon protonation or ionic cross-linking. The trigger-responsive change in hydrophilicity of the shells is rapid, switching between permeable to impermeable within seconds. The trigger-responsive change in hydrophilicity of the shells is also reversible, maintaining the microcapsules' structural integrity for repeated cycling between the two states. The molecular weight cut off and release rate is tunable over a wide range through tuning shell composition and mesh size, while the dynamically triggerable change in permeability enables the active adjustment of release in time with fast response rates; the diffusion in and out of the core can be repeatedly enabled and disabled with changing stimuli. Additionally, the mechanically and chemically robust polymeric thiol-ene network provides sufficient stability for repeated permeability change, enabling the microcapsules to be reloaded and reused numerous times, as demonstrated by repeated capture-trap-release cycles.

Fabrication and Characterization of Poly(anhydride) Microcapsules.

To form the stimuli-responsive polymeric networks in the microcapsule shell, multifunctional thiols and olefins are employed as monomers in a thiol-ene step-growth polymerization. Pentaerythritol tetra(mercaptopropionate) (PETMP) as a tetrafunctional thiol is polymerized with the difunctional co-monomers triethyleneglycol divinylether (TEGDVE) as a permanent cross-linker and pentenoic anhydride (PenAn) as a transient cross-linker and acid source, as depicted in FIG. 4. The thiol-ene monomers are water immiscible liquids and used as the oil phase in water-in-oil-in-water (W/O/W) double emulsion drops to fabricate microcapsules with cross-linked poly(anhydride) shells. Capsules with low, medium, and high anhydride content are fabricated with co-monomer ratios of 6:1, 2:1, and 4:6, respectively, between the permanent cross-linking agent TEGDVE and the hydrolyzable PenAn, to study the influence of composition on the microcapsule properties. Higher anhydride content yields microcapsules with lower cross-link density and higher acid content upon hydrolysis.

Homogenous W/O/W double emulsion drops are fabricated in glass capillary microfluidic devices. Microfluidic drop making allows the production of microcapsules with complete encapsulation and precise control over diameter and shell thickness. See, e.g., Int. Pat. Apl. Pub. No. WO 2006/096571, incorporated herein by reference in its entirety. The devices uses two cylindrical capillaries with hydrophobic and hydrophilic surface treatment for inlet and outlet, respectively, which are inserted into opposite ends of a square capillary, as illustrated and shown in FIG. 3. Double emulsion drops are formed between the tapered tips of the inlet and outlet capillaries and the monomer shell is polymerized by exposure of the double emulsion drops to UV light immediately after formation. The resultant water-dispersed microcapsules with a hydrophobic polymer shell surrounding an aqueous core exhibit homogenous size with low polydispersity and tunable shell thickness that is controlled by the flow rates and device design, as summarized in Table 4. The thin-shelled capsules show buckled morphologies due to an osmotic imbalance between the inner and outer aqueous phase prior to fabrication, causing water to diffuse from the core of the microcapsules to the continuous phase to mitigate the osmotic pressure. The reduction in core volume due to the water egress causes the shells of the capsules to buckle.

Conversion of Poly(Anhydride) to Poly(Acid) Microcapsules.

The transient anhydride cross-linker hydrolyzes with water to form two carboxylic acid groups tethered to the polymeric shell network. Hence, the hydrolysis of the anhydride causes an increase in mesh size of the polymeric network, as illustrated in FIG. 4. The increase in mesh size is accompanied by a change in hydrophilicity of the polymer network due to the formation of polar carboxylic acid functional groups. Before hydrolysis, the poly(anhydride) shells are impermeable to small hydrophilic molecules such as the fluorophore sulforhodamine B. Upon hydrolysis, the resulting poly(acid) network exhibits an increased mesh size and hydrophilicity, causing the shell to swell with water and allowing sulforhodamine B to diffuse through the shell membrane, allowing its use as a fluorescent probe to indicate the completion of the shell's hydrolysis.

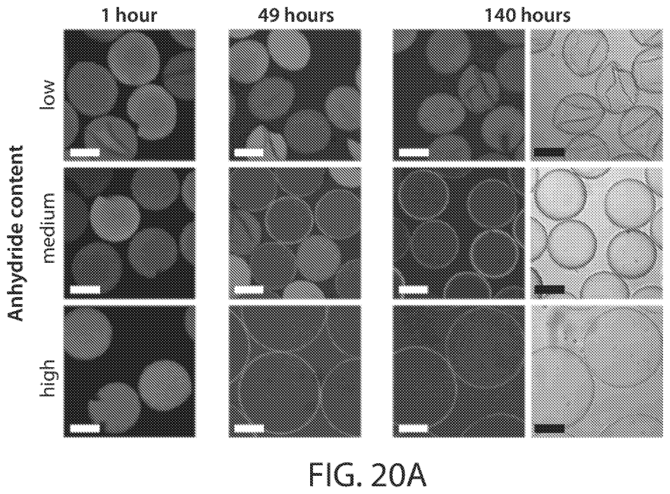

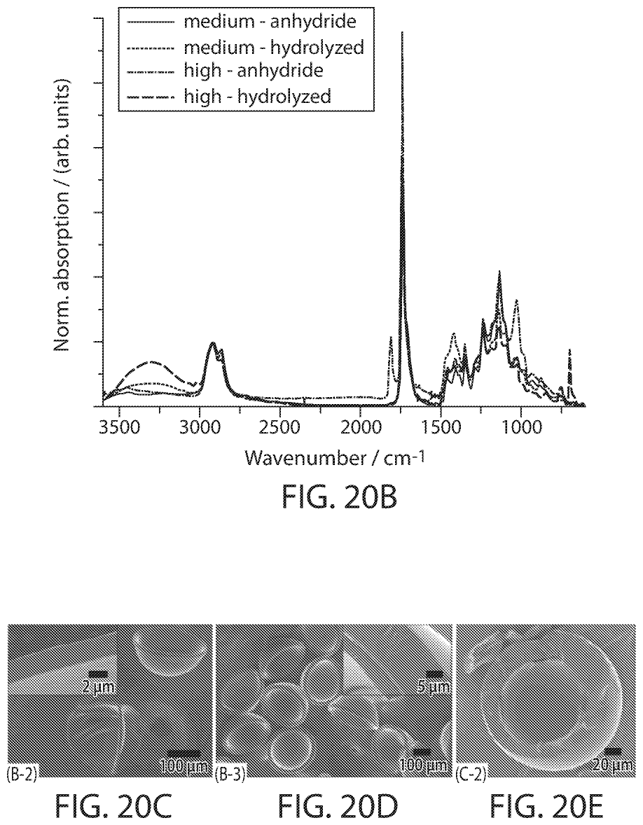

The time it takes to fully hydrolyze the shell is tunable through its chemical composition, thickness, and the pH of the surrounding aqueous medium, enabling precise control over release time from the poly(anhydride) microcapsules. To demonstrate the control over hydrolysis rate through composition, microcapsules of similar size but with different anhydride content were fabricated. They are loaded with sulforhodamine B and exposed to phosphate buffered saline (PBS) with a pH of 7.4. Capsules with high anhydride content are hydrolyzed completely to poly(acid) microcapsules within 2 days as indicated by the release of sulforhodamine B. After the same time, only some of the microcapsules with medium anhydride content are hydrolyzed, while none of the microcapsules with low anhydride content have released their fluorescent cargo. For these microcapsules up to 4 and 6 days, respectively, are required to fully hydrolyze the shells to poly(acid) networks and release the encapsulated sulforhodamine B, as shown in FIG. 20A. The trend of faster hydrolysis rate with higher anhydride content is believed to be due to the networks surface-initiated hydrolysis. The amount of water at the advancing hydrolysis front and hence the hydrolysis rate is higher for materials with higher acid content after conversion. Additionally, the microcapsules with the highest anhydride content increase in size during hydrolysis in PBS buffer at a pH of 7.4, in contrast to the capsules with low and medium anhydride content. It is assumed that the pKa of the poly(acid) network decreases with increasing acid content, causing some of the carboxylic acid units in the microcapsules with high acid content to be deprotonated and the polymer shells to swell.

The hydrolysis of the poly(anhydride) microcapsules is further confirmed using IR-spectroscopy. The conversion of the anhydrides to carboxylic acids introduces hydroxyl groups that yield a broad absorption band in the IR spectrum at wavenumbers above 3100 cm⁻¹. Microcapsules with higher anhydride content exhibit larger absorption in this OH-stretching region of the IR spectrum after hydrolysis, as shown in FIG. 20B. Shell thickness of the poly(acid) microcapsules is tunable between a few microns to tens of microns depending on drop fabrication design and flow rates, as shown in the scanning electron microscopy images in FIGS. 20C-20E. The aqueous core is not centered in the double emulsion drop due to the density mismatch with the monomer shell, leading to asymmetric microcapsules with non-uniform shell thickness that is particularly apparent for thick-shelled capsules (FIGS. 20D-20E). For example, microcapsules with a core-to-shell volume ratio of 4 exhibit a shell thickness of 5 and 15 micrometers on the thin and thick side of the capsule, respectively.

The onset of cargo release from the poly(anhydride) microcapsules is also controllable by the pH of the surrounding aqueous medium, since hydrolysis is accelerated catalytically in acidic and basic conditions. Microcapsules with medium anhydride content hydrolyze within hours at pH 11, but take days at pH 2, and exhibit the slowest hydrolysis rate and release time in non-catalytic DI-water. The hydrolysis and release time is further controlled with the shell thickness; thicker shells take longer to fully hydrolyze and become permeable. Hence, the onset time for the release of aqueous cargo from the poly(anhydride) microcapsules is independently tunable from hours to days through chemical composition, shell thickness, and pH.

pH-Responsive Properties of the Dynamic Microcapsules.

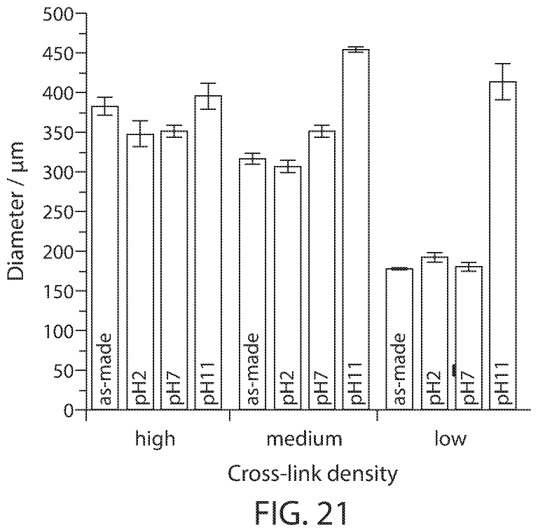

The hydrolyzed microcapsules are reversibly stimuli-responsive, enabling dynamic control over their size and permeability. The shells contain tethered carboxylic acids that render them responsive to external triggers such as pH and ionic environment. At neutral and low pH, the polyacids are protonated and the microcapsule shells are hydrophobic. With increase of the pH in the surrounding aqueous medium, the acid groups are deprotonated yielding charged polyelectrolyte networks that swell significantly with water; the result is an increase in shell volume and microcapsule size. The increase in capsule size is not predominantly driven by an increase in shell thickness but is caused by the in-plane expansion of the poly(acid) shell that significantly increases the capsule surface area. Thus, the microcapsule size increases to accommodate the difference in its surface area imposed by the swelling of the shell. In contrast, common pH-responsive microgels swell homogenously in the entire volume of the microparticle. The poly(acid) microcapsules exhibit a significant difference in size between pH 9 and 7, indicating the threshold pH for the hydrophilicity switch. The difference in size is controlled by the cross-link density, with larger swelling for lower cross-link density, as summarized in FIG. 21. Microcapsules with low cross-link density demonstrate a factor of 2.3 difference in diameter between pH 7 and 11, corresponding to more than one order of magnitude difference in volume. Despite the significant difference in size between low and high pH, the size dispersity of the microcapsules in the swollen and non-swollen states remains low.

The trigger-responsive swelling of the shell occurs rapidly upon deprotonation in alkaline conditions. The surface area of the capsule significantly increases within seconds due to the swelling of the shell predominantly in the spherical plane, while the water core volume is initially unchanged; the result is a buckling of the microcapsules immediately after an increase in pH due to the mismatch of surface area to volume of the capsules. The diffusion of water into the capsule core to accommodate the significantly expanded surface area is slow, taking minutes for the cores to be fully filled with water and restore the spherical shape of the microcapsules after a pH-triggered swelling of the shell. Time-resolved microscopy images of microcapsules during the change from their non-swollen state in DI-water to their swollen state at pH 9.5 showing the initial buckling of the shell and ultimate recovery. Upon a change in pH from basic to acidic conditions the shells turn hydrophobic and deswell, but it takes hours for the capsules to decrease in size. The deswelling of the poly(acid) shells upon protonation of the poly(acid) network drives a decrease in surface area of the microcapsule and, hence, a decrease in volume. However, to decrease the volume of the microcapsules, water has to diffuse from the core through the shell into the continuous medium. Since protonation turns the shells significantly less permeable even to water, the diffusion rate of water is so slow that it takes over 20 hours to shrink to their equilibrium size. The strain imposed on the shell during this slow shrinking process causes some plastic deformation of the capsules after repeated swelling and deswelling cycles, but no ruptured or broken capsules are observed.

The pH-dependent degree of swelling and hydrophilicity allows dynamic control over the permeability of the shell. Deprotonated, swollen microcapsules exhibit higher permeability than in the protonated, non-swollen state. The molecular weight cut-off (MWCO) of substances below which the poly(acid) shells are permeable in the swollen and non-swollen states is precisely tunable through the cross-link density; the MWCO increases with decreasing cross-link density due to a larger mesh size in the polymeric network. For example, microcapsules with medium cross-link density are impermeable to fluorescently labeled dextran with a molecular weight of 4.4 kg mol⁻¹ at pH 4, but the same microcapsules are permeable to molecular weights up to 10 kg mol⁻¹ at pH 9.5, as evidenced using confocal fluorescence microscopy. In comparison, microcapsules with low cross-link density are impermeable to dextran with a molecular weight of 20 kg mol⁻¹ in their non-swollen state in acidic media, but permeable to molecular weights up to 70 kg mol⁻¹ when swollen at high pH, yet remain impermeable to larger molecular weights, confirming that the capsules are free of larger defects or ruptures. Microcapsules with high cross-link density are impermeable to macromolecules such as fluorescently labeled dextran with a molecular weight down to 4.4 kg mol⁻¹ at any pH, but demonstrate pH and solute size dependent diffusion rates of small sugar molecules. To assess their permeability, the highly cross-linked microcapsules are exposed to sugar solutions of high concentration at various pH. The resultant osmotic pressure causes an immediate water diffusion from the capsule core to the surrounding sugar solution; the result is a buckling of the microcapsules due to the decreased core volume but unchanged surface area. The lower the permeability of the shell membrane to the sugar, the longer it takes to equilibrate the osmolarity inside and outside of the capsule, and hence the time until its spherical shape is restored. Osmotic shock experiments in various pH conditions demonstrate the permeability of the highly cross-linked poly(acid) microcapsules to sucrose and cyclodextrin with molecular weights of up to 1297 g mol⁻¹ at neutral and high pH, but significantly lower permeability in acidic conditions with recovery times of weeks.

Reversible Permeability Switching of the Dynamic Microcapsules.

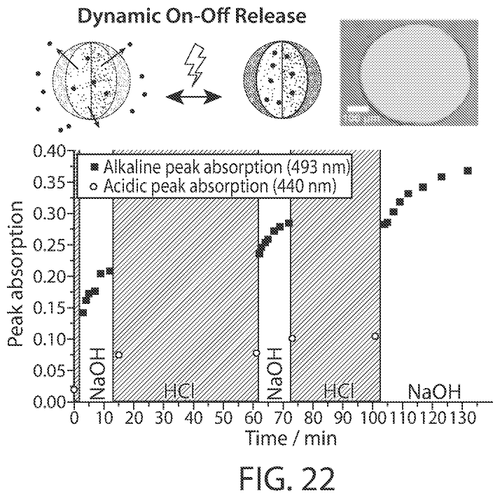

The pH-dependent swelling and associated permeability change is reversible, which enables the use of these capsules for more advanced functions than the common single-use, uni-directional delivery applications. Release profiles that adapt to a changing environment can be obtained with microcapsules that sense their surrounding and modify their permeability in response to changes. Additionally, manipulation of the microcapsule environment allows active on-off switching and release control, as schematically shown in FIG. 22. The dynamic change of the permeability triggered by a change in pH is utilized to temporarily interrupt the release of cargo from the capsules, demonstrating active and repeated on-off release manipulation of the microcapsules by an external trigger. Capsules with medium cross-link density are loaded with fluorescein-labeled dextran with a molecular weight of 10 kg mol⁻¹ and successively exposed to basic and acidic conditions, while the absorbance of the supernatant is measured to assess the release of the encapsulated dextran over time. During exposure of the microcapsules to alkaline conditions, the absorbance of fluorescein in the supernatant increases continuously over 10 mins, demonstrating release of the fluorescent cargo. Upon acidification of the aqueous medium, the absorbance of the supernatant barely changes for over 45 mins, while it significantly increases again over the next 10 mins when the pH is switched back to 9, as shown in FIG. 22. This process can be repeated for another cycle, interrupting and continuing the release of the dextran again with acid and base, respectively. The peak absorbance of the supernatant over time under cycled pH conditions is shown in FIG. 22. Since the fluorescein-labeled dextran exhibits pH-dependent absorption spectra, comparison can only be made between absorption values for the same pH conditions. No increase in absorption is observed in acidic conditions, demonstrating no release during an acidic cycle, while the absorption increases fast and significantly during all basic cycles, demonstrating the repeatedly activated release. The repeated and rapid on-off switching of the release demonstrates the dynamic responsiveness to control the shell permeability without destruction of its structural integrity.

Since the change of the permeability is non-destructive, cargo can be loaded into the capsules while permeable at high pH, trapped in the capsules at low pH, and successively released again at high pH. Capture, trapping, and release of cargo molecules in the dynamically responsive microcapsules is visualized using fluorescently labeled dextran with molecular weight of 10 kg mol⁻¹. The probe diffuses into the capsules in alkaline conditions and stays trapped inside when the capsules are transferred to acidic conditions. After increase of the pH, the dextran is fully released from the capsules over a period of 20 minutes. Time-resolved intensity profiles across a releasing capsule demonstrates the continued and full release of the fluorescent cargo molecule over 20 minutes. The time for capture and release depends on the diffusion rate through the shell membrane; small molecules diffuse faster. The same poly(acid) shells are impermeable to 4.4 kg mol⁻¹ dextran for days at low pH, but diffusion into the capsules is completed within 2 minutes when the pH is changed to 9.5. The shells become impermeable again within seconds after the pH is switched to 4, exhibiting no release of the trapped dextran immediately following acidification of the surrounding liquid. Time resolved fluorescent confocal microscopy images of the blocking, capture, and trapping of 4.4 kg mol⁻¹ dextran show that, while the 10 kDa dextran requires 1200 seconds to reach 80% equilibrium of the fluorescence inside and outside the capsule, it only takes 150 seconds for the 4.4 kDa dextran.

The fast response time and the significant change in permeability of the capsules is due to a substantial difference in hydrophilicity between the protonated, and the deprotonated ionic state of the polymer networks. The permeability of the protonated state is so low that it takes hours for the microcapsules to reach their non-swollen size due to the very slow diffusion of water from the core through the hydrophobic shell. The robust mechanical properties of the capsules, and their ability to withstand the significant stresses that evolve during this deswelling, are associated with the very homogeneous polymeric networks obtained from thiol-ene chemistry.

In addition to pH, the poly(acid) microcapsules are responsive to changes in their ionic environment. Multivalent cations such as calcium(II) physically cross-link deprotonated poly(acids). In alkaline conditions, the addition of calcium chloride leads to deswelling of the shells and associated permeability change, similar to the demonstrated dynamic response to acid. Fluorescently labeled 4.4 kg mol⁻¹ dextran is captured in microcapsules with medium cross-link density at a pH of 9.5, and trapped for hours at the same pH upon addition of 0.1 molar calcium chloride that causes a decrease in capsule size. The calcium is removed from the poly(acid) shells through the addition of a competing chelating agent such as ethylenediaminetetraacetic acid (EDTA), causing a reswelling of the microcapsules with associated MWCO increase. After addition of excess EDTA, the trapped dextran is released, and the capsules size increases again. The calcium-response enables the same capture-trap-release capability of the poly(acid) microcapsules for changes between acidic and alkaline pH conditions, but without pH-change.

The mechanical robustness of the microcapsules is also apparent in their stability upon drying. Poly(anhydride) microcapsules that are dried in vacuum at room temperature aggregate and adhere to each other, but retain non-volatile cargo such as the fluorescent probe sulforhodamine B. Upon redispersing the poly(anhydride) microcapsules in aqueous medium, the cargo stays trapped within the capsules until they are hydrolyzed and allow diffusion of the probe through the shell. The capsules can further be detached from each other with light ultra-sonication and the hydrolyzed microcapsules retain their pH-responsiveness as demonstrated by the trapping of 4.4 kDa dextran upon pH change from basic to acidic medium.

Herein, a new class of microcapsules is demonstrated with dynamic permeability that switches on and off within seconds, enabling the microcapsules to transiently release cargo with actively induced interruptions by controlling the environmental pH or ionic species. The release rate is controllable through molecular composition of the microcapsules, enabling their precise task-specific tunability. Due to their small size, microcapsules can be used as injectable drug reservoirs that release their aqueous cargo only under predetermined conditions with precisely tunable rates. Furthermore, biologics that produce therapeutics on-site such as enzymes, proteins, or even cells could be directly incorporated and hosted as unperturbed cargo in the microcapsule since the core constitutes liquid water physically separated from the encapsulation material. The cargo is protected from certain immune responses by the shell membrane, while the supply of substrate molecules and release of products is controlled by the environmental conditions, enabling on-demand and on-site production of therapeutics. Furthermore, the dynamic microcapsules can repeatedly capture molecular species from their surrounding aqueous medium with size selectivity and trap them without leakage, enabling new methods for passive and active separation and purification with facile removal of molecular impurities by microfiltration or gravitational settling.

### Experimental Methods and Materials

Chemicals:

Pentenoic anhydride (PenAn), triethylene glycol divinylether (TEGDVE), pentaerythritol tetra(mercaptopropionate) (PETMP), poly(vinyl alcohol) (M_{w} 13,000-23,000, 98% hydrolyzed, PVA), 2-hydroxy-2-methylpropiophenone (Darocure 1173), acetic acid (glacial), sodium hydroxide (pellets, NaOH), hydrochloric acid (2N, HCl), sodium phosphate monobasic (dihydrate), sodium borate, sodium phosphate dibasic (dodecahydrate), phosphate buffered saline (1×, PBS), calcium chloride, ethylenediaminetetraacetic acid (EDTA), and octadecyltrimethoxysilane (technical grade, 90%, ODTS) were purchased from Sigma-Aldrich and used as received. The fluorescent probes sulforhodamine B, rhodamine isothiocyanate-dextran (RITC-dextran), and fluorescein isothiocyanate-dextran (FITC-dextran) of various molecular weights were purchased from Sigma-Aldrich and used as received as 1 mg/mL solutions in DI-water. The hydrophilic silane 2-(methoxy-(polyethyleneoxy)propyl) trimethoxysilane was purchased from Gelest and used as received. Hydrolysis and size distribution measurements at pH 2, pH 4, and pH 11 were done with BDH pH Reference Standard Buffers or with PBS buffer for pH 7. Osmotic shock and capture-trap-release experiments were done with 0.02 molar solutions at appropriate ratios of acetic acid and sodium hydroxide for pH 4, and sodium phosphate mono- and dibasic for pH 7, and sodium borate for pH 9.5.

Preparation of Monomer Mixtures:

Hydrophobic thiol-ene monomer mixtures with a stochiometric ratio of double bonds (ene) to thiols are used as the shell phase in microfluidic double emulsion drop templating. Three monomer compositions are prepared with PETMP as the multifunctional thiol and PenAn and TEGDVE as the difunctional enes with 14.3 mol %, 33.3 mol %, and 60 mol % PenAn in the ene-mixture, corresponding to 25 mol %, 50 mol %, and 90 mol % of acid groups in the fully hydrolyzed shells as compared to TEGDVE, as summarized in Table 4. The radical photoinitiator 2-hydroxy-2-methylpropiophenone (Darocure 1173) is added at 1 mole percent to the monomer mixtures. The monomers are prepared and mixed by shaking immediately before use.

Fabrication of Microcapsules in Microfluidic Dropmakers:

Microcapsules are produced from double emulsion templates with an aqueous core of 2-5 wt % PVA, optionally containing sulforhodamine B at 0.1 mg mL⁻¹. The continuous phase contained 5 wt % PVA. Water-in-oil-in-water double emulsions are fabricated using a glass capillary microfluidic device. The device used two tapered cylindrical capillaries aligned inside a square capillary with dimensions slightly larger than that of the outer diameter of the cylindrical capillaries. The injection capillary is rendered hydrophobic by treating it with ODTS. To prevent the wetting of the shell of the double emulsion drops on the outlet channel walls, the collection capillary is rendered hydrophilic by treating with 2-(methoxy-(polyethyleneoxy)propyl)trimethoxysilane. For thin shell capsules, an additional flame-pulled cylindrical capillary is inserted into the hydrophobic injection capillary.

To form thick-shell double emulsion drops, the inner aqueous phase is injected through the hydrophobically treated injection capillary, while the middle shell phase is injected from the same direction through the interstitial space between the square capillary and the injection capillary. The outer aqueous phase is injected from the opposite direction, also through the interstitial space between the square capillary and collection capillary. Thin-shell double emulsion drops are obtained by injecting the inner aqueous phase through the flame-pulled innermost capillary, the monomer middle phase through the injection capillary, and the aqueous outer phase through the interstitial space between the square and the collection capillary. Drop formation in the glass capillary device is monitored with a fast camera (Phantom V9.0) equipped onto a Leica inverted optical microscope. Double emulsion drops are formed in the dripping regime at various flow rates, as summarized in Table 4. Following drop breakup, the double emulsion drops flow through the cylindrical collection capillary and are immediately irradiated with UV light (OmiCure S1500, 320-500 nm filter) to photopolymerize the shells. The microcapsules are collected in a vial containing 5 wt % PVA in water.

Hydrolysis of Microcapsules.

The hydrolysis of the poly(PenAn-TEGDVE-PETMP) microcapsules is performed under various pH conditions. To monitor the hydrolysis, small aliquots of microcapsules (˜20 microliters) are placed into buffer solutions (200 microliters) of pH 2, 7, 11, or in DI water (pH ˜5). For microcapsules that did not contain sulforhodamine B dye in their core, it was added to the buffers in the wells. Hydrolyzed poly(acid) shells allow the diffusion of sulforhodamine B through the shell membrane, while the unhydrolyzed poly(anhydride) shells are impermeable to this probe molecule. Completion of the hydrolysis of the poly(anhydride) network is confirmed by observing the diffusion of sulforhodamine B dye through the shell membrane using a laser confocal fluorescent microscope (Leica Microsystems) over a period of several days.

Characterization of Microcapsules:

Microcapsules for Fourier-transform infrared spectroscopy (FT-IR) and scanning electron microscopy (SEM) analysis are prepared by washing aliquots of microcapsules four times with DI water, and drying under vacuum. FT-IR measurements are performed using a Bruker FT-IR microscope (Lumos) in attenuated total reflectance (ATR) mode. Some dried microcapsules for SEM are cross-sectioned with a razor blade after depositing the microcapsules onto double sided adhesive conductive carbon tape. Prior to imaging, the SEM samples are sputter-coated with a thin layer (5 nm) of Platinum/Palladium (Pt:Pd 80:20) using a sputter coater (EMS 300T D Dual Head Sputter Coater). The microcapsules are imaged using a field emission scanning electron microscope (FESEM, Zeiss UltraPlus) equipped with an in-lens detector.

Permeability Measurements:

Microcapsule permeability and molecular weight cut-off (MWCO) of the poly(acid) shells with medium and low cross-link density (entries B and C in Table 4) under various pH conditions are characterized using molecular permeation into the capsule interior of fluorescent dye-conjugated dextran with various molecular weights at concentrations of 1 mg/ml. To a well containing the microcapsules in the respective buffer solution (100 microliters) of desired pH, the dye-dextran solution is added (20 microliters) and incubated for at least 1 hour. For microcapsules with high cross-link density (entry A in Table 4), pH-dependent permeability changes are gauged using osmotic shock response with sugar molecules. Solutions of sucrose and γ-cyclodextrin (γ-CD) are prepared at concentrations of 200 g L⁻¹ and added to aliquots of the microcapsules in buffer solutions of pH 4, pH 7, and pH 11. During the permeability experiments, the capsules are characterized and monitored using a laser confocal fluorescent microscope (Leica Microsystems).

Dynamic Switching of Microcapsules.

Actively adjustable release is demonstrated with microcapsules of medium cross-link density (entry B-2 in Table 4). To load the capsules with the fluorescent cargo probe, microcapsules are placed into borate buffer solution containing 10 kDa FITC-dextran with a pH of 9.5 for 3 hours. The supernatant is acidified with 1 M HCl (pH=4) and washed 5 times with DI-water. The capsules are transferred to an acidic mixture of 0.02 M glycine and 0.025 M HCl, in which no dye release is observed for 18 hours. The capsule dispersion is transferred into a Quartz glass cuvette and placed in an Aligent Cary 50 UV-Vis spectrophotometer. To enable and disable release from the capsules, 1 M NaOH and HCl (20-30 microliters) are added, respectively, while measuring the absorption spectrum of the supernatant above the settled capsules frequently.

Capture, trap, and release experiments are performed with microcapsules of medium cross-link density (entries B in Table 4) in 200 microliter wells and monitored with laser confocal fluorescence microscopy (Leica Microsystems). Aliquots of the microcapsules are added to buffer-filled wells together with fluorescently labeled dextran of respective molecular weights. Capture, trapping, and release was achieved by either replacing the supernatant with a buffer solution of the desired pH, or desired salt solution (0.1 m calcium chloride or sodium EDTA in borate buffer with a pH of 9.5).

TABLE 4
Composition, fabrication parameters, and sizes of poly(anhydride)
microcapsules.

| | | Mol % | | | | |
|---|---|---|---|---|---|---|
| | | pentenoic | Mol % | | | |
| | | anhydride | pentanoic | | | |
| | Cross- | in | acid in | | Flow rates | |
| Entry | link | monomer | hydrolyzed | Shell- | (O-M-I) | Diameter |
| # | density | mixture | gel | type | [mL/hr] | [μm]^{a)} |
| A-1 | High | 14.3% | 25.0% | Thin | 12-0.4-1 | 382 ± 11 |
| B-1 | Medium | 33.3% | 50.0% | Thin | 12-0.5-0.5 | 374 ± 10 |
| B-2 | Medium | 33.3% | 50.0% | Thin | 15-0.8-0.6 | 221 ± 6 |
| B-3 | Medium | 33.3% | 50.0% | Thick | 15-0.4-1.6 | 316 ± 7 |
| C-1 | Low | 60.0% | 75.0% | Thin | 12-0.4-1 | 383 ± 7 |
| C-2 | Low | 60.0% | 75.0% | Thick | 20-2-1 | 178 ± 2 |

^{a)}Geometrical average +/− standard deviation of the diameter of over 25 capsules for thick-shelled capsules and of 2-D projection from at least 3 thin-shelled, buckled capsules.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
forming a microfluidic droplet comprising a first fluid contained within a carrying fluid, the first fluid comprising an anhydride;
polymerizing some of the anhydride within the microfluidic droplet to form a poly(anhydride) to cause the droplet to form a microcapsule;
cross-linking the poly(anhydride) within the microcapsule; and
hydrolyzing some of the anhydride within the microcapsule to form carboxylic acid.

2. The method of claim 1, wherein the poly(anhydride) comprises methacrylic anhydride.

3. The method of any one of claim 1 or 2, wherein the poly(anhydride) comprises pentenoic anhydride.

4. The method of any one of claims 1-3, wherein polymerizing some of the anhydride comprises exposing the anhydride to UV light.

5. The method of any one of claims 1-4, wherein polymerizing some of the anhydride comprises exposing the anhydride to a photoinitiator.

6. The method of any one of claims 1-5, wherein the microfluidic droplet has an average cross-sectional diameter of greater than or equal to 15 micrometers.

7. The method of any one of claims 1-6, wherein the microfluidic droplet has an average cross-sectional diameter of less than or equal to 1 mm.

8. The method of any one of claims 1-7, wherein the microfluidic droplet is a double emulsion droplet comprising a core comprising an agent, and a shell surrounding the core comprising the anhydride.

9. The method of any one of claims 1-8, wherein hydrolyzing some of the anhydride comprises altering the pH of the anhydride.

10. The method of any one of claims 1-9, wherein cross-linking the poly(anhydride) comprises exposing the poly(anhydride) to a cross-linking agent.

11. The method of claim 10, wherein the cross-linking agent comprises a methacrylate.

12. The method of any one of claim 10 or 11, wherein the cross-linking agent comprises ethylene glycol dimethacrylate.

13. The method of any one of claims 10-12, wherein the cross-linking agent comprises triethyleneglycol divinylether.

14. The method of any one of claims 10-13, wherein the cross-linking agent comprises a multifunctional thiol.

15. The method of any one of claims 10-14, wherein the cross-linking agent comprises pentaerythritol tetrakis(mercapto propionate).

16. A method, comprising:
increasing pH of a microcapsule encapsulating an agent to increase permeability of the agent, wherein the microcapsule comprises a shell comprising a poly(acid) and a poly(anhydride); and
decreasing the pH of the microcapsule to decrease the permeability of the agent.

17. The method of claim 16, wherein the steps occur in the order recited.

18. The method of any one of claim 16 or 17, wherein increasing the pH comprises increasing the pH to greater than the pKa of the poly(acid).

19. The method of any one of claims 16-18, wherein increasing the pH comprises increasing the pH to at least 7.

20. The method of any one of claims 16-19, wherein increasing the pH comprises increasing the pH to at least 11.

21. The method of any one of claims 16-20, wherein decreasing the pH comprises decreasing the pH to less than the pKa of the poly(acid).

22. The method of any one of claims 16-21, wherein decreasing the pH comprises decreasing the pH to less than 7.

23. The method of any one of claims 16-22, wherein decreasing the pH comprises decreasing the pH to less than 2.

24. The method of any one of claims 16-23, wherein the agent is soluble in water.

25. The method of any one of claims 16-24, wherein increasing the pH of the microcapsule causes swelling of the microcapsule.

26. The method of claim 25, wherein increasing the pH of the microcapsule causes swelling of the microcapsule such that the average cross-sectional diameter increases by at least 25%.

27. The method of any one of claim 25 or 26, wherein increasing the pH of the microcapsule causes swelling of the microcapsule such that the average cross-sectional diameter increases by at least 50%.

28. The method of any one of claims 25-27, wherein increasing the pH of the microcapsule causes swelling of the microcapsule such that the average cross-sectional diameter increases by at least 100%.

29. An article, comprising:
a microcapsule comprising a shell comprising a poly(acid) and a poly(anhydride), the microcapsule encapsulating an agent.

30. The article of claim 29, wherein the shell does not comprise a polybase.

31. The article of any one of claim 29 or 30, wherein the microcapsule has an average cross-sectional diameter of greater than or equal to 15 nm.

32. The article of any one of claims 29-31, wherein the microcapsule has an average cross-sectional diameter of less than or equal to 1 mm.

33. The article of any one of claims 29-32, wherein the microcapsule has a permeability allowing release and/or uptake particles having an average cross-sectional diameter of less than 15 nm.

34. The article of any one of claims 29-33, wherein the microcapsule comprises more than one shell.

35. An article, comprising:
a microcapsule comprising a shell comprising a poly(acid) and encapsulating an agent, the microcapsule exhibiting a first permeability to the agent at a first pH and a second permeability to the agent at a second pH.

36. An article, comprising:
a microcapsule comprising a shell comprising a poly(acid) and encapsulating an agent, the microcapsule exhibiting a first permeability to the agent at a first temperature and a second permeability to the agent at a second temperature.

37. The article of any one of claim 35 or 36, wherein the shell does not comprise a polybase.

38. A method of forming microcapsules, the method comprising:
expelling a first fluid from an exit opening of a first conduit into a second fluid in a second conduit, the first fluid comprising an aqueous solution and the second fluid comprising a monomer comprising an anhydride;
expelling the first fluid and the second fluid from an exit opening of the second conduit into a third fluid to form the microcapsule comprising a shell of the second fluid surrounding droplets of the first fluid; and
polymerizing the monomer.

39. The method of claim 38, comprising hydrolyzing the shell.

40. The method of claim 39, wherein hydrolyzing the shell comprises exposing the microcapsule to an aqueous solution.

41. The method of any one of claims 38-40, wherein hydrolyzing the shell forms a poly(acid) in the shell.

42. The method of any one of claims 38-41, wherein the shell does not comprise a polybase.

43. The method of any one of claims 38-42, wherein the first fluid comprises a particle having a average cross-sectional diameter of greater than or equal to 15 nm.

44. The method of any one of claims 38-43, wherein the second fluid comprises a photoinitiator.

45. The method of any one of claims 38-44, wherein polymerizing the monomer comprises exposing the microcapsule to electromagnetic radiation.

46. An article, comprising:
a microcapsule having a shell comprising a poly(acid), the shell at least partially containing an aqueous solution, wherein the shell does not comprise a polybase.

47. The article of claim 46, wherein the aqueous solution comprises a particle having an average cross-sectional diameter of greater than or equal to 15 nm.

48. The article of any one of claim 46 or 47, wherein the poly(acid) is at least partially crosslinked.

49. The article of any one of claims 46-48, wherein the poly(acid) is formed by the hydrolysis of a polyanhydride in the shell.

50. The article of any one of claims 46-49, wherein the microcapsule is configured to reversibly release and/or uptake particles having an average cross-sectional diameter of less than 15 nm under a particular set of pH and/or ionic conditions.

51. The article of any one of claims 46-50, wherein the article comprises a second shell at least partially encapsulating the microcapsule.

52. The article of claim 51, wherein the second shell at least partially encapsulates two or more microcapsule each having a shell comprising a poly(acid).
